(19) United States
(12) Patent Application Publication
(10) Pub. No.: US 2025/0389627 A1
(43) Pub. Date: Dec. 25, 2025

(54) COMPOSITIONS AND METHODS FOR NANOHISTOLOGY

(71) Applicant: BioCubic LLC, Darien, CT (US)

(72) Inventor: Christopher Buser, Darien, CT (US)

(21) Appl. No.: 19/072,577

(22) Filed: Mar. 6, 2025

Related U.S. Application Data
(63) Continuation of application No. PCT/US23/32343, filed on Sep. 8, 2023.
(60) Provisional application No. 63/405,039, filed on Sep. 9, 2022.

(51) Int. Cl. G01N 1/36; G01N 1/30; G01N 1/32; G01N 1/44; G01Q 60/24

(52) U.S. Cl. CPC G01N 1/36; G01N 1/30; G01N 1/32; G01N 1/44; G01Q 60/24

(57) ABSTRACT

Atomic force microscopy (AFM) can be used to image biological samples with low nanomolar resolution. Compared to other imaging modalities with nanoscale resolution, AFM does not require the use of complex, costly instrumentation or toxic heavy metals to image samples. The ability of AFM to access interior structures of a sample cross-section in nanohistology applications in a controlled and automated manner is limited with conventional AFM sample preparation methodology. The present disclosure provides methods and compositions for preparing a sample for nanohistology. The methods and compositions disclosed herein can prepare a sample for nanohistology that preserve the structure of biological molecules in a sample, allowing for serial cross-sectional imaging of the sample.

### CROSS REFERENCE

This application is a continuation of International Patent Application PCT/US2023/032343 filed Sep. 8, 2023, which claims the benefit of U.S. Provisional Application No. 63/405,039 filed on Sep. 9, 2022, which are each entirely incorporated by reference herein.

### BACKGROUND

Atomic force microscopy (AFM) is extensively used in biological applications to image the surface of biological materials, including cells, tissues, and viruses with resolution below 10 nm. Compared to other microscopy methods capable of reaching nanoscale resolution, such as transmission electron microscopy, AFM does not require the use of complex, costly instrumentation or toxic heavy metals to image samples. However, the ability to access interior structures of a sample cross-section is limited in conventional AFM sample preparation methodology.

### INCORPORATION BY REFERENCE

Each patent, publication, and non-patent literature cited in the application is hereby incorporated by reference in its entirety as if each was incorporated by reference individually.

### SUMMARY

Disclosed here in is a method for preparing a sample for nanohistology, the method comprising: i) combining a biological material with a monomer-containing material, thereby obtaining a combination; ii) treating the combination with an agent that polymerizes monomers of the monomer-containing material to provide a polymeric material, thereby obtaining a polymerized combination; and iii) removing the polymeric material from a surface of the biological material, thereby obtaining a biological sample embedded in the polymeric material, wherein the biological sample has an exposed surface, wherein the exposed surface retains a shape and outline of the biological material.

Disclosed herein is a method for preparing a sample for nanohistology, the method comprising method comprising: i) fixing a biological material, thereby obtaining a fixed sample; ii) dehydrating the fixed sample, thereby obtaining a fixed and dehydrated sample; iii) contacting the fixed and dehydrated sample with a monomer-containing material, thereby obtaining a combination; iv) treating the combination with an agent that polymerizes monomers of the monomer-containing material to provide a polymeric material, thereby obtaining a polymerized combination; and v) contacting the polymerized combination with a contacting agent with agitation to remove polymeric material from a surface of the biological material, thereby obtaining a biological sample embedded in the polymeric material, wherein the biological sample has an exposed surface, wherein the exposed surface retains a shape and outline of the biological material.

Disclosed herein is a method for preparing a sample for nanohistology, the method comprising: i) deparaffinizing a paraffin-embedded histological sample, thereby obtaining a deparaffinized sample; ii) contacting the deparaffinized sample with a monomer-containing material, thereby obtaining a combination; iii) treating the combination with an agent that polymerizes monomers of the monomer-containing material to provide a polymeric material, thereby obtaining a polymerized combination; and iv) contacting the polymerized sample with a contacting agent with agitation to remove polymeric material from a surface of the biological material, thereby obtaining a biological sample embedded in the polymer material, wherein the biological sample has an exposed surface, wherein the exposed surface retains a shape and outline of the biological material.

Disclosed herein is a composition for nanohistology, the composition comprising a sample of a mixture of monomers comprising about 90% w/w ethyl methacrylate and about 10% w/w ethylene glycol dimethacrylate.

Disclosed herein is a composition for nanohistology, the composition comprising a sample of a mixture of monomers comprising about 20% w/w methyl methacrylate, about 20% w/w ethyl methacrylate, about 20% w/w butyl methacrylate, about 20% w/w ethylene glycol dimethacrylate, and about 20% w/w trimethylolpropane trimethyacrylate.

Disclosed herein is a composition for nanohistology, the composition comprising a sample of a mixture of monomers comprising about 40% w/w methyl methacrylate, about 40% w/w ethyl methacrylate, and about 20% w/w ethylene glycol dimethacrylate.

Disclosed herein is a composition for nanohistology, the composition comprising A sample of a mixture of monomers comprising about 100% w/w methyl methacrylate.

Disclosed herein is a composition for nanohistology, the composition comprising A sample of a mixture of monomers comprising about 50% w/w methyl methacrylate and about 50% w/w n-butyl methacrylate.

Disclosed herein is a composition for nanohistology, the composition comprising A sample of a mixture of monomers comprising about 80% w/w methyl methacrylate, about 10% w/w n-butyl methacrylate, and about 10% w/w diallyl phathalate.

Disclosed herein is a composition for nanohistology, the composition comprising The sample of embodiment 231 further comprising about 0.5% w/w benzoin methyl ether.

Disclosed herein is a composition for nanohistology, the composition comprising A sample of a mixture of monomers comprising about 80% w/w methyl methacrylate, about 10% w/w n-butyl methacrylate, and about 10% w/w trimethylolpropane trimethacrylate.

Disclosed herein is a composition for nanohistology, the composition comprising A sample of a mixture of monomers comprising about 100% w/w ethyl methacrylate.

Disclosed herein is a composition for nanohistology, the composition comprising A sample of a mixture of monomers comprising about 90% w/w methyl methacrylate and about 10% w/w ethylene glycol dimethacrylate.

Disclosed herein is a composition for nanohistology, the composition comprising A sample of a mixture of monomers comprising about 50% w/w methyl methacrylate and about 50% w/w ethylene glycol dimethacrylate.

Disclosed herein is a composition for nanohistology, the composition comprising A sample of a mixture of monomers comprising about 80% w/w methyl methacrylate and about 20% w/w ethylene glycol dimethacrylate.

Disclosed herein is a composition for nanohistology, the composition comprising A sample of a mixture of monomers comprising about 25% w/w methyl methacrylate, about 25% w/w ethyl methacrylate, and about 50% w/w ethylene glycol dimethacrylate.

Disclosed herein is a composition for nanohistology, the composition comprising A sample of a mixture of monomers comprising about 40% w/w methyl methacrylate, about 40% w/w n-butyl methacrylate, and about 20% w/w ethylene glycol dimethacrylate.

Disclosed herein is a composition for nanohistology, the composition comprising A sample of a mixture of monomers comprising about 40% w/w methyl methacrylate, about 40% w/w n-butyl methacrylate, and about 20% w/w trimethylolpropane trimethacrylate.

Disclosed herein is an article of manufacture prepared by a process, wherein the process comprises: mixing a material comprising a plurality of monomers and a polymerization catalyst with a polymerization agent, wherein the plurality of monomers comprises about 90% w/w ethyl methacrylate and about 10% w/w ethylene glycol dimethacrylate, the polymerization catalyst comprises about 0.5% w/w benzoin methyl ether, and the agent for polymerization of monomers comprises ultraviolet radiation.

Disclosed herein is an article of manufacture prepared by a process, wherein the process comprises: mixing a material comprising a plurality of monomers and a polymerization catalyst with a polymerization agent, wherein the plurality of monomers comprises about 20% w/w methyl methacrylate, about 20% w/w ethyl methacrylate, about 20% w/w butyl methacrylate, about 20% w/w ethylene glycol dimethacrylate, and about 20% w/w trimethylolpropane trimethyacrylate; the polymerization catalyst comprises about 0.5% w/w benzoin methyl ether; and the agent for polymerization of monomers comprises ultraviolet radiation.

Disclosed herein is an article of manufacture prepared by a process, wherein the process comprises: mixing a material comprising a plurality of monomers and a polymerization catalyst with a polymerization agent, wherein the plurality of monomers comprises monomers about 40% w/w methyl methacrylate, about 40% w/w ethyl methacrylate, and about 20% w/w ethylene glycol dimethacrylate; the polymerization catalyst comprises about 0.5% w/w benzoin methyl ether; and the agent for polymerization of monomers comprises ultraviolet radiation.

Disclosed herein is an article of manufacture prepared by a process, wherein the process comprises: mixing a material comprising a plurality of monomers and a polymerization catalyst with a polymerization agent, wherein the plurality of monomers comprises monomers about 100% w/w methyl methacrylate, the polymerization catalyst comprises about 0.5% w/w benzoin methyl ether, and the agent for polymerization of monomers comprises ultraviolet radiation.

Disclosed herein is an article of manufacture prepared by a process, wherein the process comprises: mixing a material comprising a plurality of monomers and a polymerization catalyst with a polymerization agent, wherein the plurality of monomers comprises monomers about 50% w/w methyl methacrylate and about 50% n-butyl methacrylate, the polymerization catalyst comprises about 0.5% w/w benzoin methyl ether, and the agent for polymerization of monomers comprises ultraviolet radiation.

Disclosed herein is an article of manufacture prepared by a process, wherein the process comprises: mixing a material comprising a plurality of monomers and a polymerization catalyst with a polymerization agent, wherein the plurality of monomers comprises monomers about 50% w/w methyl methacrylate and about 50% w/w n-butyl methacrylate, the polymerization catalyst comprises about 2% w/w benzoin methyl ether, and the agent for polymerization of monomers comprises ultraviolet radiation.

Disclosed herein is an article of manufacture prepared by a process, wherein the process comprises: mixing a material comprising a plurality of monomers and a polymerization catalyst with a polymerization agent, wherein the plurality of monomers comprises monomers about 80% w/w methyl methacrylate, about 10% w/w n-butyl methacrylate and about 10% w/w diallyl phthalate; the polymerization catalyst comprises about 0.5% w/w benzoin methyl ether; and the agent for polymerization of monomers comprises ultraviolet radiation.

Disclosed herein is an article of manufacture prepared by a process, wherein the process comprises: mixing a material comprising a plurality of monomers and a polymerization catalyst with a polymerization agent, wherein the plurality of monomers comprises monomers about 80% w/w methyl methacrylate, about 10% w/w n-butyl methacrylate and about 10% w/w trimethylolpropane trimethacrylate; the polymerization catalyst comprises about 0.5% w/w benzoin methyl ether; and the agent for polymerization of monomers comprises ultraviolet radiation.

Disclosed herein is an article of manufacture prepared by a process, wherein the process comprises: mixing a material comprising a plurality of monomers and a polymerization catalyst with a polymerization agent, wherein the plurality of monomers comprises monomers about 100% w/w ethyl methacrylate, the polymerization catalyst comprises about 0.5% w/w benzoin methyl ether, and the agent for polymerization of monomers comprises ultraviolet radiation.

Disclosed herein is an article of manufacture prepared by a process, wherein the process comprises: mixing a material comprising a plurality of monomers and a polymerization catalyst with a polymerization agent, wherein the plurality of monomers comprises monomers about 90% w/w methyl methacrylate and about 10% ethylene glycol dimethacrylate, the polymerization catalyst comprises about 0.5% w/w benzoin methyl ether, and the agent for polymerization of monomers comprises ultraviolet radiation.

Disclosed herein is an article of manufacture prepared by a process, wherein the process comprises: mixing a material comprising a plurality of monomers and a polymerization catalyst with a polymerization agent, wherein the plurality of monomers comprises monomers about 50% w/w methyl methacrylate and about 50% ethylene glycol dimethacrylate, the polymerization catalyst comprises about 0.5% w/w benzoin methyl ether, and the agent for polymerization of monomers comprises ultraviolet radiation.

Disclosed herein is an article of manufacture prepared by a process, wherein the process comprises: mixing a material comprising a plurality of monomers and a polymerization catalyst with a polymerization agent, wherein the plurality of monomers comprises monomers about 50% w/w methyl methacrylate and about 50% ethylene glycol dimethacrylate, the polymerization catalyst comprises about 2% w/w benzoin methyl ether, and the agent for polymerization of monomers comprises ultraviolet radiation.

Disclosed herein is an article of manufacture prepared by a process, wherein the process comprises: mixing a material comprising a plurality of monomers and a polymerization catalyst with a polymerization agent, wherein the plurality of monomers comprises monomers about 80% w/w methyl methacrylate and about 20% ethylene glycol dimethacrylate, the polymerization catalyst comprises about 0.5% w/w benzoin methyl ether, and the agent for polymerization of monomers comprises ultraviolet radiation.

Disclosed herein is an article of manufacture prepared by a process, wherein the process comprises: mixing a material comprising a plurality of monomers and a polymerization catalyst with a polymerization agent, wherein the plurality of monomers comprises monomers about 80% w/w methyl methacrylate and about 20% ethylene glycol dimethacrylate, the polymerization catalyst comprises about 2% w/w benzoin methyl ether, and the agent for polymerization of monomers comprises ultraviolet radiation.

Disclosed herein is an article of manufacture prepared by a process, wherein the process comprises: mixing a material comprising a plurality of monomers and a polymerization catalyst with a polymerization agent, wherein the plurality of monomers comprises monomers about 25% w/w methyl methacrylate, about 25% w/w ethyl methacrylate, and about 50% w/w ethylene glycol dimethacrylate; the polymerization catalyst comprises about 0.5% w/w benzoin methyl ether; and the agent for polymerization of monomers comprises ultraviolet radiation.

Disclosed herein is an article of manufacture prepared by a process, wherein the process comprises: mixing a material comprising a plurality of monomers and a polymerization catalyst with a polymerization agent, wherein the plurality of monomers comprises monomers about 40% w/w methyl methacrylate, about 40% w/w n-butyl methacrylate, and about 20% w/w ethylene glycol dimethacrylate; the polymerization catalyst comprises about 0.5% w/w benzoin methyl ether; and the agent for polymerization of monomers comprises ultraviolet radiation.

Disclosed herein is an article of manufacture prepared by a process, wherein the process comprises: mixing a material comprising a plurality of monomers and a polymerization catalyst with a polymerization agent, wherein the plurality of monomers comprises monomers about 40% w/w methyl methacrylate, about 40% w/w ethyl methacrylate, and about 20% w/w trimethylolpropane trimethacrylate; the polymerization catalyst comprises about 0.5% w/w benzoin methyl ether; and the agent for polymerization of monomers comprises ultraviolet radiation.

### BRIEF DESCRIPTION OF THE FIGURES

FIG. 1A illustrates a three-dimensional schematic in the x,y,z planes of a biological specimen representing a cell with internal nanoscale and microscale structures, including a cell nucleus (N), tubular structures (T), macronuclear structures (M), filamentous structures (F), and vesicular structures (V).

FIG. 1B illustrates a top view (x,y) of the biological specimen representing a cell with the internal nanoscale and microscale structures surrounded by a plasma membrane (PM).

FIG. 1C illustrates a side view (x,z) of the biological specimen representing a cell.

FIG. 1D illustrates a side view (x,z) of the biological specimen representing a cell embedded in a polymer block.

FIG. 1E illustrates a side view (x,z) of the biological specimen representing a cell embedded in a polymer block with exposed surface (S), revealing a cross-section of internal nano- and microscale structures at the surface of the block.

FIG. 1F illustrates a side view (x,z) of the cell embedded in a polymer block with the surface scanned with an atomic force microscopy probe (P) across the x,y plane.

FIG. 2A illustrates an overview atomic force microscopy image of a mouse kidney medulla papillary ducts sample prepared for nanohistology with a grayscale representation of topography with papillary duct lumen (PL), capillaries (C), cell nuclei (N) and cytoplasm (Cyt) visible.

FIG. 2B illustrates a high magnification atomic force microscopy image of papillary ducts in a mouse kidney sample prepared for nanohistology with grayscale representation of topography with chromatin structures and nuclear envelope (Ne), nucleus (N) cytoplasm (Cyt), mitochondria (m), and vesicular structures (v) visible.

FIG. 2C illustrates a high magnification atomic force microscopy image of the cytoplasm of a papillary duct cell in a mouse kidney sample with grayscale representation of topography with mitochondria (m), endoplasmic reticulum (ER), vesicular structures (v), other organelles (arrows), and uncleaned polymer fragments (arrowheads) visible.

FIG. 3A illustrates an overview atomic force microscopy image of the medulla of a mouse kidney sample with grayscale representation of topography with cell nuclei (N) and cytoplasm (Cyt) visible.

FIG. 3B illustrates a high magnification atomic force microscopy image of the cytoplasm of a papillary duct cell in a mouse kidney sample with grayscale representation of topography with mitochondria (m), vesicular structures (v), and plasma membrane (pm) visible.

FIG. 4A illustrates an overview atomic force microscopy image of a mouse kidney medulla papillary duct sample with grayscale representation of topography with papillary duct lumen (PL), cell nuclei (N) and cytoplasm (Cyt) visible.

FIG. 4B illustrates a high magnification atomic force microscopy image of the cytoplasm of a papillary duct cell in a mouse kidney sample with grayscale representation of topography with mitochondria (m), vesicular structures (v), and endoplasmic reticulum (ER) visible.

FIG. 5A illustrates an overview atomic force microscopy image of a mouse kidney sample with grayscale representation of topography with cell nuclei (N) and cytoplasm (Cyt) visible.

FIG. 5B illustrates an overview atomic force microscopy image of a mouse kidney sample with grayscale representation of topography with cell nuclei (N) and cytoplasm (Cyt) visible.

### DETAILED DESCRIPTION

Imaging of biological materials at the ultrastructural level allows for the elucidation of cellular processes in physiological and pathological states. Diseases that manifest on the macromolecular scale can be diagnosed with molecular biology or microscopic imaging techniques, with histological analysis of tissue samples forming a routine and often automated part of many diagnostic regimens. Imaging of biological materials at the nanoscale or molecular level requires the use of specialized microscopy instrumentation and sample preparation procedures that limit the ability to automate and process samples in parallel. Atomic force microscopy (AFM) allows for imaging of the surfaces of biological materials, including for example, cells, tissues or viruses, without the need of electron optics, high vacuum systems, and toxic heavy metals used as contrast agents in electron microscopy.

Many sample preparation procedures for atomic force microscopy prevent cross-sectional imaging of the interior structures of a biological sample in a controlled and automated manner. Many atomic force microscopy imaging applications are limited to sectioning and imaging of individual samples in succession, with the final resolution of the biological structures determined by the preservation of biological structures during the sample preparation procedure and not by the resolving power of the atomic force microscope. To address this problem, methods and compositions for nanohistology sample preparation that preserve the structure of biological molecules while allowing for serial cross-sectional imaging of the sample can allow automated parallel processing and automated imaging of biological samples with atomic force microscopy.

Compositions and methods as disclosed herein can, for example, generate atomic force microscopy samples with preserved ultrastructural details. Compositions and methods herein can, for example, generate biological samples embedded in a polymer suitable for cross-sectional imaging via atomic force microscopy. Compositions and methods herein can, for example, generate a polymer that reproducibly fractures at the interface of biological structures, allowing for topographic and phase imaging of biological structures at nanoscale resolution. Compositions and methods herein can, for example, generate a methodology for nanohistology that can be performed in high-throughput. Compositions and methods herein can, for example, generate a methodology for nanohistology that can be automated in high-throughput. Compositions and methods herein can, for example, generate a methodology for nanohistology that can be integrated with machine learning models. Compositions and methods herein can, for example, generate a methodology for nanohistology that can be integrated with artificial intelligence programs. Compositions and methods herein can, for example, generate a methodology for nanohistology that can be integrated with machine learning and artificial intelligence models for automated identification and analysis of diagnostically relevant ultrastructural features in histological and pathological applications. Compositions and methods herein can, for example, generate a methodology for nanohistology that can be integrated with machine learning and artificial intelligence models for the acquisition of imaging datasets, for example, terabytes in size.

Methods disclosed herein can comprise nanohistology sample procedures comprising a plurality of steps that generate a polymerized, embedded biological sample wherein the polymer reproducibly fractures at the interface of biological structures in the sample. Methods disclosed herein can comprise nanohistology sample preparation procedures comprising a plurality of steps that generate a polymerized, embedded biological sample with an exposed surface that retains the contour and surface of a biological sample on the exposed surface. Methods disclosed herein can comprise nanohistology sample preparation procedures comprising a plurality of steps to generate polymerized embedded biological sample for atomic force microscopy imaging. Methods disclosed herein can comprise nanohistology sample procedures comprising a plurality of steps to generate polymerized embedded biological sample for serial atomic force microscopy imaging. Methods disclosed herein can comprise nanohistology sample procedures comprising a plurality of steps to generate polymerized embedded biological sample for three-dimensional atomic force microscopy imaging. Methods disclosed herein can comprise nanohistology sample preparation procedures comprising a plurality of steps that can be automated to generate a polymerized embedded biological sample. Methods disclosed herein can comprise nanohistology sample procedures comprising a plurality of steps that can be automated to generate polymerized embedded biological sample for atomic force microscopy. Methods disclosed herein can comprise nanohistology sample procedures comprising a plurality of steps that can be automated to generate and image a polymerized embedded biological sample with atomic force microscopy. Methods disclosed herein can comprise nanohistology sample procedures comprising a plurality of steps that can be automated to generate and serially image a polymerized embedded biological sample with atomic force microscopy. Methods disclosed herein can comprise nanohistology sample procedures comprising a plurality of steps that can be automated to generate and three-dimensionally image a polymerized embedded biological sample with atomic force microscopy. Methods disclosed herein can comprise nanohistology sample procedures comprising a plurality of steps that can be automated to generate and image a polymerized embedded biological sample with atomic force microscopy in high-throughput.

Compositions disclosed herein can comprise a mixture of monomers that can be polymerized to form a polymer for embedding biological samples. Compositions disclosed herein can comprise a mixture of monomers and a polymerization catalyst that can be polymerized to form a polymer for embedding biological samples. Compositions disclosed herein can comprise a mixture of monomers and polymerization catalyst that can be polymerized to form a polymer for embedding biological structures, wherein the polymer reproducibly fractures at the interface of biological structures in the sample. Compositions disclosed herein can comprise a mixture of monomers and a polymerization catalyst that can be polymerized to form a polymer for embedding biological structures, wherein the embedded biological sample retains the contour and surface of the biological sample. Compositions disclosed herein can comprise a mixture of monomers and a polymerization catalyst that can be polymerized to form a polymer for embedding biological samples for atomic force microscopy imaging. Compositions disclosed herein can comprise a mixture of monomers and a polymerization catalyst that can be polymerized to form a polymer for embedding biological samples for serial atomic force microscopy imaging. Compositions disclosed herein can comprise a mixture of monomers and a polymerization catalyst that can be polymerized to form a polymer for embedding biological samples for automated serial atomic force microscopy imaging. Compositions disclosed herein can comprise a mixture of monomers and a polymerization catalyst that can be polymerized to form a polymer for embedding biological samples for automated, serial atomic force microscopy imaging in high-throughput. Compositions disclosed herein can comprise a mixture of monomers and a polymerization catalyst that can be polymerized to form a polymer for embedding a biological samples for three-dimensional atomic force microscopy imaging.

### Biological Samples

In some embodiments, methods and compositions disclosed herein can be used to prepare a sample for nanohistology. In some embodiments, methods and compositions disclosed herein can be used to prepare a biological sample for nanohistology. In some embodiments, methods and compositions disclosed herein can be used to prepare a sample for nanohistology, wherein the size of the sample is in millimeters. In some embodiments, methods and compositions disclosed herein can be used to prepare a sample for nanohistology wherein the size of the sample is about 1 millimeter (mm) to about 10 millimeters, about 1 mm to about 20 millimeters, about 1 mm to about 50 millimeters, about 10 mm to about 50 millimeters, about 50 mm to about 100 millimeters, about 100 mm to about 200 millimeters, about 100 mm to about 500 millimeters, about 500 millimeters to about 700 millimeters, or about 500 millimeters to about 1000 millimeters. In some embodiments, methods and compositions disclosed herein can be used to prepare a sample for nanohistology, wherein the size of the sample is in centimeters. In some embodiments, methods and compositions disclosed herein can be used to prepare a sample for nanohistology, wherein the size of the sample is about 1 micrometer (μm) to about 10 μm, about 10 μm to about 50 μm, 50 μm to about 100 μm, 100 μm to about 200 μm, about 200 μm to about 500 μm, about 500 μm to about 1000 μm, about 1 millimeter (mm) to about 3 mm, about 1 mm to about 5 mm, about 1 mm to about 10 mm, about 1 mm to about 20 mm, about 1 mm to about 50 mm, about 10 mm to about 20 mm, about 20 mm to about 50 mm, about 50 mm to about 100 mm, about 100 mm to about 200 mm, about 200 mm to about 300 mm, about 300 mm to about 400 mm, or about 400 mm to about 500 mm.

In some embodiments, methods and compositions disclosed herein can be used to prepare a sample for nanohistology. In some embodiments, methods and compositions disclosed herein can be used to prepare a biological sample for nanohistology. In some embodiments, the biological sample comprises a tissue sample. In some embodiments, the biological sample comprises a human tissue sample. In some embodiments, the biological sample comprises an animal tissue sample. In some embodiments, the biological sample can be obtained from a tissue biopsy. In some embodiments, the tissue sample can be obtained from surgery. In some embodiments, the tissue sample is obtained from an autopsy. In some embodiments, the tissue sample is obtained from a necropsy. In some embodiments, the biological sample comprises a histology specimen. In some embodiments, the biological sample comprises a histology specimen, wherein the histology specimen comprises a paraffin-embedded histological specimen. In some embodiments, the biological sample comprises a plant tissue sample. In some embodiments, the biological sample comprises a cell sample. In some embodiments, the biological sample comprises a human cell sample. In some embodiments, the biological sample comprises an animal cell sample. In some embodiments, the biological sample comprises a plant cell sample. In some embodiments, the cell sample can be obtained from cells grown in culture. In some embodiments, the cell sample can be obtained from a biopsy. In some embodiments, the cell sample can be obtained from a swab, for example a cheek swab. In some embodiments, the biological sample comprises a bacterial sample. In some embodiments, the biological sample comprises a bacterial sample obtained from a bacterial culture. In some embodiments, the biological sample comprises a fungal sample. In some embodiments, the biological sample comprises a virus sample. In some embodiments, the biological sample can be obtained from a commercial source, for example a cell and tissue repository. In some embodiments, the biological sample comprises purified biological macromolecules, for example DNA, RNA, or protein.

In some embodiments, methods and compositions disclosed herein can be used to prepare a sample for nanohistology. In some embodiments, methods and compositions disclosed herein can be used to prepare a biological sample for nanohistology. In some embodiments, methods and compositions disclosed herein can be used to prepare a biological sample for nanohistology, wherein the biological sample is a disease sample. In some embodiments, the biological sample can comprise a human disease sample. In some embodiments, the biological sample can comprise an animal disease sample. Non-limiting disease samples can include cancer; kidney disease; liver disease including nonalcoholic fatty liver disease, nonalcoholic steatohepatitis, viral infection of the liver, or bacterial infection of the liver; infectious disease; a blood disease; a blood disorder; skin disease; skin lesions; and neurological disease. In some embodiments, the disease sample can be obtained from a biopsy sample. In some embodiments, the disease sample can be obtained from a surgical sample. In some embodiments, the disease sample can be obtained from an autopsy sample. In some embodiments, the disease sample can be obtained from a necropsy sample. In some embodiments, the disease sample can be obtained from a commercial source. In some embodiments, the disease sample can be obtained from a non-commercial source, for example a tissue bank or biorepository. In some embodiments, the disease sample can comprise a histology sample. In some embodiments, the disease sample can comprise a paraffin-embedded histology sample. In some embodiments, the disease sample can comprise a plant disease sample.

### Fixation

In some embodiments, methods and compositions disclosed herein can be used to prepare a sample for nanohistology. In some embodiments, methods and compositions disclosed herein can be used to prepare a sample for nanohistology, wherein the sample comprises a fixed biological sample. In some embodiments, methods and compositions disclosed herein can be used to prepare a sample for nanohistology, wherein the sample comprises a fixed biological sample, wherein fixation does not result in cross-linking of biological molecules in the sample. In some embodiments, methods and compositions disclosed herein can be used to prepare a sample for nanohistology, wherein the sample comprises a chemically-fixed biological sample. In some embodiments, the chemical fixation procedure can comprise treating the biological sample with a cross-linking agent. In some embodiments, the cross-linking agent comprises a weak cross-linking agent. In some embodiments, the cross-linking agent comprises a weak cross-linking agent, wherein the degree of cross-linking is empirically determined based on the degree of structural preservation as assessed in a microscopic image of the fixed tissue. In some embodiments, the weak cross-linking agent comprises formaldehyde. In some embodiments, the cross-linking agent comprises a reversible cross-linking agent. In some embodiments, the cross-linking agent comprises a reversible cross-linking agent, wherein the cross-linking reversal procedure comprises buffer washes. In some embodiments, the cross-linking agent comprises a reversible cross-linking agent, wherein the cross-linking reversal procedure comprises heating of the cross-linked sample. In some embodiments, the cross-linking agent comprises a reversible cross-linking agent, wherein the cross-linking reversal procedure comprises chemical treatment of the cross-linked sample. In some embodiments, the cross-linking agent comprises a reversible cross-linking agent, wherein the cross-linking reversal procedure comprises chemical treatment of the cross-linked sample with citraconic anhydride. In some embodiments, the cross-linking agent comprises a monoaldehyde. In some embodiments, the monoaldehyde comprises acrolein. In some embodiments, the cross-linking agent comprises a polyaldehyde. In some embodiments, the polyaldehyde comprises glyoxal. In some embodiments, the polyaldehyde does not comprise glutaraldehyde. In some embodiments, the cross-linking agent does not comprise an epoxide moiety. In some embodiments, the chemical fixation procedure can comprise treating the biological sample with a cross-linking agent and an additive. In some embodiments, the chemical fixation procedure can comprise treating the biological sample with a cross-linking agent an additive, wherein the additive comprises albumin. In some embodiments, the chemical fixation procedure can comprise treating the biological sample with an agent that does not cross-link the sample. In some embodiments, the chemical fixation procedure can further comprise fixation of sugars in the sample with periodate lysine. In some embodiments, the chemical fixation procedure can further comprise fixation of lipids in the sample with osmium tetroxide. In some embodiments, the chemical fixation procedure can further comprise fixation of lipids in the sample with permanganate.

In some embodiments, methods and compositions disclosed herein can be used to prepare a sample for nanohistology. In some embodiments, methods and compositions disclosed herein can be used to prepare a sample for nanohistology, wherein the sample comprises a fixed biological sample. In some embodiments, methods and compositions disclosed herein can be used to prepare a sample for nanohistology, wherein the sample comprises a fixed biological sample, wherein fixation does not result in cross-linking of biological molecules in the sample. In some embodiments, methods and compositions disclosed herein can be used to prepare a sample for nanohistology, wherein the sample comprises a cryofixed sample. In some embodiments, methods and compositions disclosed herein can be used to prepare a sample for nanohistology, wherein the sample comprises a cryofixed sample, wherein cryofixation of the sample results in vitrification of liquids in the sample. In some embodiments, the cryofixation procedure comprises plunge-freezing of the sample. In some embodiments, the cryofixation procedure comprises plunge-freezing of the sample in a cryogen. In some embodiments the cryogen comprises organic solvent cooled in liquid nitrogen. In some embodiments, the cryogen comprises ethane cooled in liquid nitrogen. In some embodiments, the cryogen comprises ethane and propane cooled in liquid nitrogen. In some embodiments, the cryogen comprises liquid nitrogen. In some embodiments, the cryofixation procedure comprises jet-freezing. In some embodiments, the cryofixation procedure comprises jet-freezing with cold ethane. In some embodiment, the cryofixation procedure comprises jet-freezing with cold propane. In some embodiments, the cryofixation procedure comprises high-pressure freezing of the sample. In some embodiments, the high-pressure freezing procedure comprises freezing the sample at a pressure of about 2100 bar and a temperature of at least −196° C. In some embodiments, the high-pressure freezing procedure comprises freezing of the sample in a cryogen at a pressure of 2100 bar. In some embodiments, the cryogen comprises organic solvent cooled in liquid nitrogen. In some embodiments, the cryogen comprises ethane cooled in liquid nitrogen. In some embodiments, the cryogen comprises ethane and propane cooled in liquid nitrogen. In some embodiments, the cryogen comprises liquid nitrogen.

In some embodiments, the cryofixation procedure can further comprise cryoprotection of the biological sample prior to cryofixation. In some embodiments, the cryofixation procedure can further comprise cryoprotection of the biological sample prior to cryofixation, wherein cryoprotection of the sample suppresses the formation of extracellular and intracellular ice crystals and increases the overall rate of cooling of the sample. In some embodiments, the cryoprotection procedure comprises immersion of the biological sample in a cryoprotectant for about 1 second, about 5 seconds, about 10 seconds, about 30 seconds, about 60 seconds, about 5 minutes, about 10 minutes, about 30 minutes, about 60 minutes, about 90 minutes, about 2 hours, about 4 hours, about 6 hours, about 8 hours, about 12 hours, about 16 hours, about 24 hours, about 36 hours, about 2 days, about 3 days, about 4 days, about 5 days, about 6 days, or about 1 week, wherein the cryoprotectant does not cross-link biological molecules in the sample. In some embodiments, the cryoprotectant comprises a sugar molecule. In some embodiments, the cryoprotectant comprises a monosaccharide molecule. In some embodiments, the cryoprotectant comprises glucose. In some embodiments, the cryoprotectant comprises a disaccharide molecule. In some embodiments, the cryoprotectant comprises sucrose. In some embodiments, the cryoprotectant comprises trehalose. In some embodiments, the cryoprotectant comprises lactose. In some embodiments, the cryoprotectant comprises a trisaccharide molecule. In some embodiments, the cryoprotectant comprises a polysaccharide molecule. In some embodiments, the cryoprotectant comprises agarose. In some embodiments, the cryoprotectant comprises a dextran molecule. In some embodiments, the cryoprotectant comprises Ficoll. In some embodiments, the cryoprotectant comprises a sugar alcohol molecule. In some embodiments, the cryoprotectant comprises mannitol. In some embodiments, the cryoprotectant comprises a polyvinyl alcohol molecule. In some embodiments, the cryoprotectant comprises polyethylene glycol. In some embodiments, the cryoprotectant comprises a protein. In some embodiments, the cryoprotectant comprises bovine serum albumin. In some embodiments, the cryoprotectant comprises gelatin. In some embodiments, the cryoprotectant comprises polyvinylpyrrolidone. In some embodiments, the cryoprotectant comprises a hydrocarbon molecule. In some embodiments, the cryoprotectant comprises heptane. In some embodiments, the cryoprotectant comprises 1-hexadecene. In some embodiments, the cryoprotectant further comprises a filler molecule. In some embodiments, the cryoprotectant further comprises a filler molecule, wherein the filler molecule displaces water.

In some embodiments, methods and compositions disclosed here can be used to prepare a sample for nanohistology. In some embodiments, methods and compositions disclosed herein can be used to prepare a sample for nanohistology, wherein the sample comprises a fixed biological sample. In some embodiments, methods and compositions disclosed herein can be used to prepare a sample for nanohistology, wherein the sample comprises a fixed biological sample, wherein fixation does not result in cross-linking of biological molecules in the sample. In some embodiments, methods and compositions disclosed herein can be used to prepare a sample for nanohistology, wherein the sample comprises a physically-fixed biological sample. In some embodiments, the physical fixation procedure comprises drying the sample. In some embodiments, the physical fixation procedure comprises freeze-drying the sample. In some embodiments, the physical fixation procedure comprises air-drying the sample.

In some embodiments, methods and compositions disclosed herein can be used to prepare a sample for nanohistology. In some embodiments, methods and compositions disclosed herein can be used to prepare a sample for nanohistology, wherein the sample comprises a fixed biological sample. In some embodiments, methods and compositions disclosed herein can be used to prepare a sample for nanohistology, wherein the sample comprises a fixed biological sample, wherein fixation does not result in cross-linking of biological molecules in the sample. In some embodiments, methods and compositions disclosed herein can be used to prepare a sample for nanohistology, wherein the biological sample is fixed with one or more fixation procedures. In some embodiments, methods and compositions disclosed herein can be used to prepare a sample for nanohistology, wherein the biological sample is fixed with at least one fixation procedure. In some embodiments, methods and compositions disclosed herein can be used to prepare a sample for nanohistology, wherein the biological sample is fixed with at least two fixation procedures. In some embodiments, methods and compositions disclosed herein can be used to prepare a sample for nanohistology, wherein the sample is fixed with chemical fixation and cryofixation. In some embodiments, the sample is fixed with a reversible cross-linking agent and cryofixation. In some embodiments, the sample is fixed with a weak cross-linking agent and cryofixation. In some embodiments, the sample is fixed with an agent that does not cross-link and cryofixation. In some embodiments, methods and compositions disclosed herein can be used to prepare a sample for nanohistology, wherein the sample is fixed with chemical fixation and cryoprotected with a cryoprotectant prior to cryofixation. In some embodiments, methods and compositions disclosed herein can be used to prepare a sample for nanohistology, wherein the sample is fixed with chemical fixation and cryoprotected with a cryoprotectant and filler prior to cryofixation. In some embodiments, methods and compositions disclosed herein can be used to prepare a sample for nanohistology, wherein the biological sample is fixed with at least three fixation procedures.

### Dehydration

In some embodiments, methods and compositions disclosed herein can be used to prepare a sample for nanohistology. In some embodiments, methods and compositions disclosed herein can be used to prepare a sample for nanohistology, wherein the sample comprises a fixed and dehydrated sample. In some embodiments, methods and compositions disclosed herein can be used to prepare a sample for nanohistology, wherein the sample is dehydrated following fixation. In some embodiments, methods and compositions disclosed herein can be used to prepare a sample for nanohistology, wherein the sample is dehydrated following fixation, wherein the dehydration procedure replaces water in the fixed sample with organic solvent. In some embodiments, methods and compositions disclosed herein can be used to prepare a sample for nanohistology, wherein the sample is dehydrated following fixation, wherein the dehydration procedure maintains the integrity of structures in the sample. In some embodiments, methods and compositions disclosed herein can be used to prepare a sample for nanohistology, wherein the sample is dehydrated following fixation, wherein the dehydration procedure maintains the integrity of structures in the sample. In some embodiments, the integrity of structures in the sample can be assessed through empirical observation of the structures and compared to a standard, wherein the comparison assesses deviation from a standard quality. In some embodiments, methods and compositions disclosed herein can be used to prepare a sample for nanohistology, wherein the sample is dehydrated following fixation, wherein the dehydration procedure reduces the extraction of structures in the sample. In some embodiments, the extraction of structures in the sample can be assessed by comparing the presence of known structures in the sample to a standard. In some embodiments, methods and compositions disclosed herein can be used to prepare a sample for nanohistology, wherein the sample is dehydrated following fixation, wherein the dehydration procedure prevents disruption of hydration shells around biomolecules and structures in the sample. In some embodiments, the fixed sample can comprise a cryofixed sampled. In some embodiments, the fixed sample can comprise a chemically fixed sample. In some embodiments, the fixed sample can comprise a physically-fixed sample. In some embodiments, the fixed sample can comprise a fixed sample at room temperature.

In some embodiments, methods and compositions disclosed herein can be used to prepare a sample for nanohistology, wherein the sample is dehydrated following fixation. In some embodiments, methods and compositions disclosed herein can be used to prepare a sample for nanohistology, wherein the sample is dehydrated by freeze substitution in organic solvent. In some embodiments, the freeze substitution procedure can comprise immersion of the fixed sample in organic solvent cooled to about −70° C., about −75° C., about −80° C., about −85° C., about −90° C., about −95° C., or about −100° C. followed by gradual increasing of the temperature of the organic solvent to a final temperature of about −50° C., about −40° C., about −30° C., about −20° C., about −10° C., about −5° C., about 0° C., about 1° C., about 4° C., about 10° C., about 15° C., about 20° C., about 23° C., about 25° C., or about 27° C. In some embodiments, the freeze substitution procedure can comprise immersion of the fixed sample in organic solvent cooled to about −70° C. followed by gradual increasing of the temperature of the organic solvent to a final temperature of about −50° C. In some embodiments, the freeze substitution procedure can comprise immersion of the fixed sample in organic solvent cooled to about −90° C. followed by gradual increasing of the temperature of the organic solvent to a final temperature of about −50° C. In some embodiments, the freeze substitution procedure can comprise immersion of the fixed sample in organic solvent cooled to about −70° C. followed by gradual increasing of the temperature of the organic solvent to a final temperature of about −20° C. In some embodiments, the freeze substitution procedure can comprise immersion of the fixed sample in organic solvent cooled to about −90° C. followed by gradual increasing of the temperature of the organic solvent to a final temperature of about −20° C. In some embodiments, the freeze substitution procedure can comprise immersion of the fixed sample in organic solvent cooled to about −70° C. followed by gradual increasing of the temperature of the organic solvent to a final temperature of about 4° C. In some embodiments, the freeze substitution procedure can comprise immersion of the fixed sample in organic solvent cooled to about −90° C. followed by gradual increasing of the temperature of the organic solvent to a final temperature of about 4° C. In some embodiments, the freeze substitution procedure can comprise immersion of the fixed sample in organic solvent cooled to about −70° C. followed by gradual increasing of the temperature of the organic solvent to a final temperature of about 20° C. In some embodiments, the freeze substitution procedure can comprise immersion of the fixed sample in organic solvent cooled to about −90° C. followed by gradual increasing of the temperature of the organic solvent to a final temperature of about 20° C. In some embodiments, the freeze substitution procedure can comprise immersion of the fixed sample in organic solvent cooled to about −70° C. followed by gradual increasing of the temperature of the organic solvent to a final temperature of about 23° C. In some embodiments, the freeze substitution procedure can comprise immersion of the fixed sample in organic solvent cooled to about −90° C. followed by gradual increasing of the temperature of the organic solvent to a final temperature of about 23° C. In some embodiments, the freeze substitution procedure can comprise immersion of the fixed sample in organic solvent cooled to about −70° C. followed by gradual increasing of the temperature of the organic solvent to a final temperature of about 25° C. In some embodiments, the freeze substitution procedure can comprise immersion of the fixed sample in organic solvent cooled to about −90° C. followed by gradual increasing of the temperature of the organic solvent to a final temperature of about 25° C.

In some embodiments, methods and compositions disclosed herein can be used to prepare a sample for nanohistology, wherein the sample is dehydrated following fixation. In some embodiments, methods and compositions disclosed herein can be used to prepare a sample for nanohistology, wherein the sample is dehydrated by freeze substitution in organic solvent. In some embodiments, methods and compositions disclosed herein can be used to prepare a sample for nanohistology, wherein the sample is dehydrated by freeze substitution in organic solvent, wherein the organic solvent is liquid at temperatures of about −70° C., about −75° C., about −80° C., about −85° C., about −90° C., about −95 or about −100° C., and the solvent is miscible with water. In some embodiments, methods and compositions disclosed herein can be used to prepare a sample for nanohistology, wherein the sample is dehydrated by freeze substitution in organic solvent, wherein the organic solvent is liquid at temperatures of about −70° C., and the solvent is miscible with water. In some embodiments, methods and compositions disclosed herein can be used to prepare a sample for nanohistology, wherein the sample is dehydrated by freeze substitution in organic solvent, wherein the organic solvent is liquid at temperatures of about −90° C., and the solvent is miscible with water. In some embodiments, the freeze substitution organic solvent can comprise a hydrocarbon solvent. In some embodiments, the freeze substitution organic solvent can comprise an aliphatic alcohol solvent. In some embodiments, the freeze substitution organic solvent can comprise methanol. In some embodiments, the freeze substitution organic solvent can comprise ethanol. In some embodiments, the freeze substitution organic solvent can comprise an ether solvent. In some embodiments, the freeze substitution organic solvent can comprise an ester solvent. In some embodiments, the freeze substitution organic solvent can comprise a ketone solvent. In some embodiments, the freeze substitution organic solvent can comprise acetone. In some embodiments, the freeze substitution organic solvent can comprise a nitrile solvent. In some embodiments, the freeze substitution can comprise acetonitrile. In some embodiments, the freeze substitution organic solvent can further comprise a stabilizer, wherein the stabilizer prevents the collapse of biological structures during freeze substitution. In some embodiments, the stabilizer comprises water at concentration of about 1% v/v, about 2% v/v, about 3% v/v, about 4% v/v, about 5% v/v, about 6% v/v, about 7% v/v, about 8% v/v, about 9% v/v, about 10% v/v, about 15% v/v, or about 20% v/v. In some embodiments, the stabilizer comprises water at concentration of about 5% v/v. In some embodiments, the stabilizer comprises water at concentration of about 10% v/v. In some embodiments, the freeze substitution organic solvent can further comprise a fixative, wherein the fixative cross-links biological samples. In some embodiments, the freeze substitution organic solvent can further comprise a fixative, wherein the fixative comprises an aldehyde moiety. In some embodiments, the freeze substitution organic solvent can further comprise a fixative, wherein the fixative comprises osmium tetroxide. In some embodiments, the freeze substitution organic solvent can further comprise a fixative, wherein the fixative comprises permanganate. In some embodiments, the freeze substitution organic solvent can further comprise a stain, wherein the stain increases contrast in the sample. In some embodiments, the freeze substitution organic solvent can further comprise a stain, wherein the stain adds color to the sample. In some embodiments, the freeze substitution organic solvent can further comprise a dye, wherein the dye increases contrast in the sample. In some embodiments, the freeze substitution organic solvent can further comprise a dye, wherein the dye adds color to the sample.

In some embodiments, methods and compositions disclosed herein can be used to prepare a sample for nanohistology, wherein the sample is dehydrated following fixation. In some embodiments, methods and compositions disclosed herein can be used to prepare a sample for nanohistology, wherein the sample is dehydrated with a progressive lowering of temperature protocol. In some embodiments, methods and compositions disclosed herein can be used to prepare a sample for nanohistology, wherein the sample is dehydrated with a progressive lowering of temperature protocol, wherein the sample is immersed in a series of solvents with increasing organic content while the temperature of the sample and solvent is lowered to about the freezing point of the organic solvent. In some embodiments, the sample is dehydrated with a progressive lowering of temperature protocol, wherein the sample is immersed in increasing concentrations of organic solvent, wherein the concentration of organic solvent is progressively increased from about 10% v/v to about 20% v/v, from about 10% v/v to about 30% v/v, from about 10% v/v to about 40% v/v, from about 10% v/v to about 50% v/v, from about 10% v/v to about 60% v/v, from about 10% v/v to about 70% v/v, from about 10% v/v to about 80% v/v, from about 10% v/v to about 90% v/v, from about 10% v/v to about 100% v/v organic solvent. In some embodiments, the sample is dehydrated with a progressive lowering of temperature protocol, wherein the sample is immersed in increasing concentrations of organic solvent, wherein the concentration of organic solvent is progressively increased from about 10% v/v to about 100% v/v organic solvent. In some embodiments, the sample is dehydrated with a progressive lowering of temperature protocol, wherein the sample is immersed in increasing concentrations of organic solvent while the temperature of the sample and solvent is lowered from about 23° C. to about 0° C., from about 23° C. to about −10° C., from about 23° C. to about −20° C., from about 23° C. to about −30° C., from about 23° C. to about −40° C., from about 23° C. to about −50° C., from about 23° C. to about −60° C., from about 23° C. to about −70° C., from about 23° C. to about −80° C., or from about 23° C. to about −90° C. In some embodiments, the sample is dehydrated with a progressive lowering of temperature protocol, wherein the sample is immersed in increasing concentrations of organic solvent while the temperature of the sample and solvent is lowered from about 23° C. to about −50° C. In some embodiments, the sample is dehydrated with a progressive lowering of temperature protocol, wherein the sample is immersed in increasing concentrations of organic solvent while the temperature of the sample and solvent is lowered from about 23° C. to about −60° C. In some embodiments, the sample is dehydrated with a progressive lowering of temperature protocol, wherein the sample is immersed in increasing concentrations of organic solvent while the temperature of the sample and solvent is lowered from about 23° C. to about −70° C. In some embodiments, the sample is dehydrated with a progressive lowering of temperature protocol, wherein the sample is immersed in increasing concentrations of organic solvent while the temperature of the sample and solvent is lowered from about 23° C. to about −80° C. In some embodiments, the sample is dehydrated with a progressive lowering of temperature protocol, wherein the sample is immersed in increasing concentrations of organic solvent while the temperature of the sample and solvent is lowered from about 23° C. to about −90° C. In some embodiments, the progressive lowering of temperature protocol comprises a plurality of steps, wherein at each step of the protocol, the sample is immersed in organic solvent at a specific concentration of organic solvent and temperature, for example in about 50% v/v organic solvent at about −20° C. In some embodiments, the progressive lowering of temperature comprises a plurality of steps, wherein at each step of the protocol, the sample is immersed in organic solvent at a specific concentration of organic solvent and temperature for about 1 minute, about 5 minutes, about 10 minutes, about 15 minutes, about 20 minutes, about 25 minutes, about 30 minutes, about 35 minutes, about 40 minutes, about 45 minutes, about 50 minutes, about 55 minutes, about 60 minutes, about 75 minutes, about 90 minutes, about 105 minutes, or about 120 minutes. In some embodiments, the organic solvent of the progressive lowering of temperature protocol can comprise acetone.

In some embodiments, methods and compositions disclosed herein can be used to prepare a sample for nanohistology, wherein the sample is dehydrated following fixation. In some embodiments, methods and compositions disclosed herein can be used to prepare a sample for nanohistology, wherein the sample is dehydrated at room temperature. In some embodiments, methods and compositions disclosed herein can be used to prepare a sample for nanohistology, wherein the sample is dehydrated with a standard dehydration protocol at room temperature. In some embodiments, methods and compositions disclosed herein can be used to prepare a sample for nanohistology, wherein the sample is dehydrated by freeze-drying at room temperature. In some embodiments, methods and compositions disclosed herein can be used to prepare a sample for nanohistology, wherein the sample is dehydrated by drying under vacuum. In some embodiments, methods and compositions disclosed herein can be used to prepare a sample for nanohistology, wherein the sample is dehydrated at a temperature above room temperature, wherein the temperature of dehydration does not affect sample quality. In some embodiments, methods and compositions disclosed herein can be used to prepare a sample for nanohistology, wherein the sample is dehydrated at an elevated temperature, wherein the elevated temperature does not affect sample quality. In some embodiments, methods and compositions disclosed herein can be used to prepare a sample for nanohistology, where the sample is dehydrated with a standard dehydration protocol at elevated temperature. In some embodiments, methods and compositions disclosed herein can be used to prepare a sample for nanohistology, wherein the sample is dehydrated by freeze-drying at an elevated temperature. In some embodiments, methods and compositions disclosed herein can be used to prepare a sample for nanohistology, wherein the sample is dehydrated at an elevated temperature of about 25° C., about 30° C., about 35° C., about 40° C., about 45° C., or about 45° C.

Combining with Monomer-Containing Material

In some embodiments, methods and compositions disclosed herein can be used to prepare a sample for nanohistology. In some embodiments, methods and compositions disclosed herein can be used to prepare a sample for nanohistology, wherein the sample comprises a fixed and dehydrated sample. In some embodiments, methods and compositions disclosed herein can be used to prepare a sample for nanohistology, wherein the sample comprises a paraffin-embedded histology sample. In some embodiments, methods and compositions disclosed herein can be used to prepare a sample for nanohistology, wherein the sample comprises a deparaffinized histology sample. In some embodiments, methods and compositions disclosed herein can be used to prepare a sample for nanohistology, wherein the sample comprises a deparaffinized histology sample, wherein the sample is deparaffinized following immersion in xylene. In some embodiments, disclosed herein are methods and compositions for combining a fixed and dehydrated sample with an agent comprising a monomer-containing material. In some embodiments, disclosed herein are methods and compositions for combining a deparaffinized histology sample with an agent comprising a monomer-containing material. In some embodiments, the combining with an agent comprising a monomer-containing material results in complete replacement of a solvent in the sample with the monomer-containing material. In some embodiments, the combining with an agent comprising a monomer-containing material results in complete replacement of a solvent in the sample with the monomer-containing material, wherein the solvent comprises the organic solvent of the dehydration procedure.

In some embodiments, the combining with the agent comprising a monomer-containing material comprises immersion of the sample in the monomer-containing material. In some embodiments, the combining further comprises agitation. In some embodiments, the combining can occur at ambient pressure. In some embodiments, the combining can occur at ambient pressure, wherein the pressure of the combining is about 760 Torr. In some embodiments, the combining can occur at low vacuum. In some embodiments, the combining can occur at low vacuum, wherein the pressure of the combining is at less than about 760 Torr. In some embodiments, the combining can occur at low vacuum, wherein the pressure of the combining is about 750 torr, is about 700 torr, about 650 torr, about 600 torr, about 550 torr, about 500 torr, about 450 torr, about 400 torr, about 350 torr, about 300 torr, about 250 torr, about 200 torr, about 150 torr, about 100 torr, about 75 torr, about 50 torr, or about 25 torr. In some embodiments, the combining can occur at low vacuum, wherein the pressure of the combining is about 750 torr. In some embodiments, the combining can occur at low vacuum, wherein the pressure of the combining is about 740 torr. In some embodiments, the combining can occur at low vacuum, wherein the pressure of the combining is about 730 torr. In some embodiments, the combining can occur at low vacuum, wherein the pressure of the combining is about 720 torr. In some embodiments, the combining can occur at low vacuum, wherein the pressure of the combining is about 710 torr. In some embodiments, the combining can occur at low vacuum, wherein the pressure of the combining is about 700 torr. In some embodiments, the combining can occur at a temperature range of about −100° C. to about 100° C. In some embodiments, the combining can occur at a temperature range of about −90° C. to about −75° C., of about −90° C. to about −60° C., of about −90° C. to about −45° C., of about −90° C. to about −30° C., of about −90° C. to about −15° C., of about −90° C. to about 0° C., of about −90° C. to about 15° C., of about −90° C. to about 30° C., of about −90° C. to about 45° C., or of about −90° C. to about 60° C. In some embodiments, the combining can occur at about −90° C., about −80° C., about −70° C., about −60° C., about −50° C., about −40° C., about −30° C., about −20° C., about −10° C., about 0° C., about 10° C., about 20° C., about 30° C., about 40° C., about 50° C., or about 60° C. In some embodiments, the combining can comprise a time period of about 1 minute, about 2 minutes, about 3 minutes, about 4 minutes, about 5 minutes, about 6 minutes, about 7 minutes, about 8 minutes, about 9 minutes, about 10 minutes, about 15 minutes, about 20 minutes, about 25 minutes, about 30 minutes, about 35 minutes, about 40 minutes, about 45 minutes, about 50 minutes, about 55 minutes, about 60 minutes, about 90 minutes, about 2 hours, about 3 hours, about 4 hours, about 5 hours, about 6 hours, about 7 hours, about 8 hours, about 9 hours, about 10 hours, about 11 hours, about 12 hours, about 16 hours, about 18 hours, about 24 hours, about 2 days, about 3 days, about 4 days, about 5 days, about 6 days, or about 7 days.

In some embodiments, the combining with the agent comprises a monomer-containing material comprises immersion of the sample in the monomer-containing material. In some embodiments, the monomer-containing material comprises a mixture of monomers. In some embodiments, the monomer-containing material comprises a mixture of monomers, wherein upon polymerization, the resulting polymer does not crosslink with biological molecules in the sample. In some embodiments, the monomer-containing material comprises a mixture of monomers, wherein the mixture has low viscosity. In some embodiments, the monomer-containing material comprises a mixture of monomers, wherein the mixture has low viscosity, wherein the viscosity is as measured by a viscometer. In some embodiments, the monomer-containing material comprises a mixture of monomers and a polymerization catalyst. In some embodiments, the monomer-containing material comprises a mixture of monomers, wherein the mixture is in the liquid state at cold temperatures. In some embodiments, the monomer-containing material comprises a mixture of monomers, wherein the mixture is in the liquid state a temperature of about −90° C., of about −80° C. of about −70° C., of about −60° C., of about −50° C., about −40° C., about −30° C., about −20° C., about −10° C., about 0° C., about 10° C., about 20° C., about 30° C., about 40° C., about 50° C., about 60° C., about 70° C., about 80° C., or about 90° C. In some embodiments, the monomer-containing material comprises a mixture of monomers, wherein the mixture is in the liquid state at a temperature of about −50° C. In some embodiments, the monomer-containing material comprises a mixture of monomers, wherein the mixture is in the liquid state at a temperature of about −40° C. In some embodiments, the monomer-containing material comprises a mixture of monomers, wherein the mixture is in the liquid state at a temperature of about −30° C. In some embodiments, the monomer-containing material comprises a mixture of monomers, wherein the mixture is in the liquid state at a temperature of about −20° C. In some embodiments, the monomer-containing material comprises a mixture of monomers, wherein the mixture is in the liquid state at a temperature of about −10° C. In some embodiments, the monomer-containing material comprises a mixture of monomers, wherein the mixture is in the liquid state at a temperature of about 0° C. In some embodiments, the monomer-containing material comprises a mixture of monomers, wherein the mixture is in the liquid state in the temperature range of about −50° C. to about 0° C.

In some embodiments, the monomer-containing material comprises a mixture of monomers. In some embodiments, the monomer-containing material comprises one monomer. In some embodiments, the monomer-containing material comprises a mixture of monomers, wherein the mixture comprises a plurality of monomers. In some embodiments, the monomer-containing material comprises a plurality of monomers, wherein the monomer-containing material comprises at least 1, at least 2, at least 3, at least 4, at least 5, at least 6, at least 7, at least 8, at least 9, or at least 10 distinct monomers. In some embodiments, the monomer-containing material comprises at least 1 distinct monomers. In some embodiments, the monomer-containing material comprises at least 2 distinct monomers. In some embodiments, the monomer-containing material comprises at least 3 distinct monomers. In some embodiments, the monomer-containing material comprises at least 4 distinct monomers. In some embodiments, the monomer-containing material comprises at least 5 distinct monomers. In some embodiments, the monomer-containing material comprises at least 6 distinct monomers. In some embodiments, the monomer-containing material comprises at least 7 distinct monomers. In some embodiments, the monomer-containing material comprises at least 8 distinct monomers. In some embodiments, the monomer-containing material comprises at least 9 distinct monomers. In some embodiments, the monomer-containing material comprises at least 10 distinct monomers. In some embodiments, the monomer-containing material comprises a plurality of monomers in a defined ratio. In some embodiments, the monomer-containing material comprises a plurality of monomers in a defined ratio, wherein the ratio of monomers in the mixture is defined as the amount of the monomer in the mixture over the total amount of monomers. In some embodiments, the amount of a monomer in the monomer mixture can be defined by the percent weight per volume (% w/v) of the monomer in the total mixture. In some embodiments, the monomer-containing material can comprise about 1% w/v, about 5% w/v, about 10% w/v, about 15% w/v, about 20% w/v, about 25% w/v, about 30% w/v, about 35% w/v, about 40% w/v, about 45% w/v, about 50% w/v, about 55% w/v, about 60% w/v, about 65% w/v, about 70% w/v, about 75% w/v, about 80% w/v, about 85% w/v, about 90% w/v, about 95% w/v, about 99% w/v, or about 100% w/v of a distinct monomer. In some embodiments, the monomer-containing material can comprise about 1% w/v of a distinct monomer. In some embodiments, the monomer-containing material can comprise about 5% w/v of a distinct monomer. In some embodiments, the monomer-containing material can comprise about 10% w/v of a distinct monomer. In some embodiments, the monomer-containing material can comprise about 20% w/v of a distinct monomer. In some embodiments, the monomer-containing material can comprise about 30% w/v of a distinct monomer. In some embodiments, the monomer-containing material can comprise about 40% w/v of a distinct monomer. In some embodiments, the monomer-containing material can comprise about 50% w/v of a distinct monomer. In some embodiments, the monomer-containing material can comprise about 60% w/v of a distinct monomer. In some embodiments, the monomer-containing material can comprise about 70% w/v of a distinct monomer. In some embodiments, the monomer-containing material can comprise about 80% w/v of a distinct monomer. In some embodiments, the monomer-containing material can comprise about 90% w/v of a distinct monomer. In some embodiments, the monomer-containing material can comprise about 95% w/v of a distinct monomer. In some embodiments, the monomer-containing material can comprise about 99% w/v of a distinct monomer. In some embodiments, the monomer-containing material can comprise about 100% w/v of a distinct monomer. In some embodiments, the amount of a monomer in the monomer mixture can be defined by the percent volume per volume (% v/v) of the monomer in the total mixture. In some embodiments, the monomer-containing material can comprise about 1% v/v, about 5% v/v, about 10% v/v, about 15% v/v, about 20% v/v, about 25% v/v, about 30% v/v, about 35% v/v, about 40% v/v, about 45% v/v, about 50% v/v, about 55% v/v, about 60% v/v, about 65% v/v, about 70% v/v, about 75% v/v, about 80% v/v, about 85% v/v, about 90% v/v, about 95% v/v, about 99% v/v, or about 100% v/v of a distinct monomer. In some embodiments, the monomer-containing material can comprise about 1% v/v of a distinct monomer. In some embodiments, the monomer-containing material can comprise about 5% v/v of a distinct monomer. In some embodiments, the monomer-containing material can comprise about 10% v/v of a distinct monomer. In some embodiments, the monomer-containing material can comprise about 20% v/v of a distinct monomer. In some embodiments, the monomer-containing material can comprise about 30% v/v of a distinct monomer. In some embodiments, the monomer-containing material can comprise about 40% v/v of a distinct monomer. In some embodiments, the monomer-containing material can comprise about 50% v/v of a distinct monomer. In some embodiments, the monomer-containing material can comprise about 60% v/v of a distinct monomer. In some embodiments, the monomer-containing material can comprise about 70% v/v of a distinct monomer. In some embodiments, the monomer-containing material can comprise about 80% v/v of a distinct monomer. In some embodiments, the monomer-containing material can comprise about 90% v/v of a distinct monomer. In some embodiments, the monomer-containing material can comprise about 95% v/v of a distinct monomer. In some embodiments, the monomer-containing material can comprise about 99% v/v of a distinct monomer. In some embodiments, the monomer-containing material can comprise about 100% v/v of a distinct monomer. In some embodiments, the amount of a monomer in the monomer mixture can be defined by the percent weight per weight (% w/w) of the monomer in the total mixture. In some embodiments, the monomer-containing material can comprise about 1% w/w, about 5% w/w, about 10% w/w, about 15% w/w, about 20% w/w, about 25% w/w, about 30% w/w, about 35% w/w, about 40% w/w, about 45% w/w, about 50% w/w, about 55% w/w, about 60% w/w, about 65% w/w, about 70% w/w, about 75% w/w, about 80% w/w, about 85% w/w, about 90% w/w, about 95% w/w, about 99% w/w, or about 100% w/w of a distinct monomer. In some embodiments, the monomer-containing material can comprise about 1% w/w of a distinct monomer. In some embodiments, the monomer-containing material can comprise about 5% w/w of a distinct monomer. In some embodiments, the monomer-containing material can comprise about 10% w/w of a distinct monomer. In some embodiments, the monomer-containing material can comprise about 20% w/w of a distinct monomer. In some embodiments, the monomer-containing material can comprise about 30% w/w of a distinct monomer. In some embodiments, the monomer-containing material can comprise about 40% w/w of a distinct monomer. In some embodiments, the monomer-containing material can comprise about 50% w/w of a distinct monomer. In some embodiments, the monomer-containing material can comprise about 60% w/w of a distinct monomer. In some embodiments, the monomer-containing material can comprise about 70% w/w of a distinct monomer. In some embodiments, the monomer-containing material can comprise about 80% w/w of a distinct monomer. In some embodiments, the monomer-containing material can comprise about 90% w/w of a distinct monomer. In some embodiments, the monomer-containing material can comprise about 95% w/w of a distinct monomer. In some embodiments, the monomer-containing material can comprise about 99% w/w of a distinct monomer. In some embodiments, the monomer-containing material can comprise about 100% w/w of a distinct monomer.

In some embodiments, the combining with the agent comprises a monomer-containing material comprises immersion of the sample in the monomer-containing material. In some embodiments, the monomer-containing material comprises a mixture of monomers. In some embodiments, the monomer-containing material comprises a mixture of monomers, wherein the monomers comprise thermosetting or thermoplastic monomers. In some embodiments, the monomer comprises a mixture of monomers, wherein the monomers comprise an ester moiety. In some embodiments, the monomer-containing material comprises diallyl phthalate. In some embodiments, the monomer-containing material comprises a mixture of monomers, wherein the monomers comprise an acrylic moiety. In some embodiments, the monomer-containing material comprises a mixture of monomers, wherein the monomers comprise a methacrylate moiety. In some embodiments, the embodiments, the monomer-containing material comprises a mixture of monomers, wherein the monomers comprise at least 1, at least 2, at least 3, at least 4, or at least 5 distinct methacrylate moieties. In some embodiments, the monomer-containing material comprises a mixture of monomers, wherein the monomers comprise 1 methacrylate moiety. In some embodiments, the monomer-containing material comprises methyl methacrylate. In some embodiments, the monomer-containing material comprises ethyl methacrylate. In some embodiments, the monomer-containing material comprises propyl methacrylate. In some embodiments, the monomer-containing material comprises n-butyl methacrylate. In some embodiments, the monomer-containing material comprises pentyl methacrylate. In some embodiments, the monomer-containing material comprises hexyl methacrylate. In some embodiments, the monomer-containing material comprises a mixture of monomers, wherein the monomers comprise 2 methacrylate moieties. In some embodiments, the monomer-containing material comprises ethylene glycol dimethacrylate. In some embodiments, the monomer-containing material comprises a mixture of monomers, wherein the monomers comprise 3 methacrylate moieties. In some embodiments, the monomer-containing material comprises trimethylolpropane trimethacrylate.

In some embodiments, the monomer-containing material comprises about 100% w/v diallyl phthalate. In some embodiments, the monomer-containing material comprises about 99% w/v diallyl phthalate. In some embodiments, the monomer-containing material comprises about 95% w/v diallyl phthalate. In some embodiments, the monomer-containing material comprises about 90% w/v diallyl phthalate. In some embodiments, the monomer-containing material comprises about 80% w/v diallyl phthalate. In some embodiments, the monomer-containing material comprises about 70% w/v diallyl phthalate. In some embodiments, the monomer-containing material comprises about 75% w/v diallyl phthalate. In some embodiments, the monomer-containing material comprises about 60% w/v diallyl phthalate. In some embodiments, the monomer-containing material comprises about 50% w/v diallyl phthalate. In some embodiments, the monomer-containing material comprises about 40% w/v diallyl phthalate. In some embodiments, the monomer-containing material comprises about 30% w/v diallyl phthalate. In some embodiments, the monomer-containing material comprises about 25% w/v diallyl phthalate. In some embodiments, the monomer-containing material comprises about 20% w/v diallyl phthalate. In some embodiments, the monomer-containing material comprises about 10% w/v diallyl phthalate. In some embodiments, the monomer-containing material comprises about 5% w/v diallyl phthalate. In some embodiments, the monomer-containing material comprises about 1% w/v diallyl phthalate.

In some embodiments, the monomer-containing material comprises about 100% w/v methyl methacrylate. In some embodiments, the monomer-containing material comprises about 99% w/v methyl methacrylate. In some embodiments, the monomer-containing material comprises about 95% w/v methyl methacrylate. In some embodiments, the monomer-containing material comprises about 90% w/v methyl methacrylate. In some embodiments, the monomer-containing material comprises about 80% w/v methyl methacrylate. In some embodiments, the monomer-containing material comprises about 75% w/v methyl methacrylate. In some embodiments, the monomer-containing material comprises about 70% w/v methyl methacrylate. In some embodiments, the monomer-containing material comprises about 60% w/v methyl methacrylate. In some embodiments, the monomer-containing material comprises about 50% w/v methyl methacrylate. In some embodiments, the monomer-containing material comprises about 40% w/v methyl methacrylate. In some embodiments, the monomer-containing material comprises about 30% w/v methyl methacrylate. In some embodiments, the monomer-containing material comprises about 25% w/v methyl methacrylate. In some embodiments, the monomer-containing material comprises about 20% w/v methyl methacrylate. In some embodiments, the monomer-containing material comprises about 10% w/v methyl methacrylate. In some embodiments, the monomer-containing material comprises about 5% w/v methyl methacrylate. In some embodiments, the monomer-containing material comprises about 1% w/v methyl methacrylate.

In some embodiments, the monomer-containing material comprises about 100% w/v ethyl methacrylate. In some embodiments, the monomer-containing material comprises about 99% w/v ethyl methacrylate. In some embodiments, the monomer-containing material comprises about 95% w/v ethyl methacrylate. In some embodiments, the monomer-containing material comprises about 90% w/v ethyl methacrylate. In some embodiments, the monomer-containing material comprises about 80% w/v ethyl methacrylate. In some embodiments, the monomer-containing material comprises about 75% w/v ethyl methacrylate. In some embodiments, the monomer-containing material comprises about 70% w/v ethyl methacrylate. In some embodiments, the monomer-containing material comprises about 60% w/v ethyl methacrylate. In some embodiments, the monomer-containing material comprises about 50% w/v ethyl methacrylate. In some embodiments, the monomer-containing material comprises about 40% w/v ethyl methacrylate. In some embodiments, the monomer-containing material comprises about 30% w/v ethyl methacrylate. In some embodiments, the monomer-containing material comprises about 25% w/v ethyl methacrylate. In some embodiments, the monomer-containing material comprises about 20% w/v ethyl methacrylate. In some embodiments, the monomer-containing material comprises about 10% w/v ethyl methacrylate. In some embodiments, the monomer-containing material comprises about 5% w/v ethyl methacrylate. In some embodiments, the monomer-containing material comprises about 1% w/v ethyl methacrylate.

In some embodiments, the monomer-containing material comprises about 100% w/v propyl methacrylate. In some embodiments, the monomer-containing material comprises about 99% w/v propyl methacrylate. In some embodiments, the monomer-containing material comprises about 95% w/v propyl methacrylate. In some embodiments, the monomer-containing material comprises about 90% w/v propyl methacrylate. In some embodiments, the monomer-containing material comprises about 80% w/v propyl methacrylate. In some embodiments, the monomer-containing material comprises about 75% w/v propyl methacrylate. In some embodiments, the monomer-containing material comprises about 70% w/v propyl methacrylate. In some embodiments, the monomer-containing material comprises about 60% w/v propyl methacrylate. In some embodiments, the monomer-containing material comprises about 50% w/v propyl methacrylate. In some embodiments, the monomer-containing material comprises about 40% w/v propyl methacrylate. In some embodiments, the monomer-containing material comprises about 30% w/v propyl methacrylate. In some embodiments, the monomer-containing material comprises about 25% w/v propyl methacrylate. In some embodiments, the monomer-containing material comprises about 20% w/v propyl methacrylate. In some embodiments, the monomer-containing material comprises about 10% w/v propyl methacrylate. In some embodiments, the monomer-containing material comprises about 5% w/v propyl methacrylate. In some embodiments, the monomer-containing material comprises about 1% w/v propyl methacrylate.

In some embodiments, the monomer-containing material comprises about 100% w/v n-butyl methacrylate. In some embodiments, the monomer-containing material comprises about 99% w/v n-butyl methacrylate. In some embodiments, the monomer-containing material comprises about 95% w/v n-butyl methacrylate. In some embodiments, the monomer-containing material comprises about 90% w/v n-butyl methacrylate. In some embodiments, the monomer-containing material comprises about 80% w/v n-butyl methacrylate. In some embodiments, the monomer-containing material comprises about 70% w/v n-butyl methacrylate. In some embodiments, the monomer-containing material comprises about 75% w/v n-butyl methacrylate. In some embodiments, the monomer-containing material comprises about 60% w/v n-butyl methacrylate. In some embodiments, the monomer-containing material comprises about 50% w/v n-butyl methacrylate. In some embodiments, the monomer-containing material comprises about 40% w/v n-butyl methacrylate. In some embodiments, the monomer-containing material comprises about 30% w/v n-butyl methacrylate. In some embodiments, the monomer-containing material comprises about 25% w/v n-butyl methacrylate. In some embodiments, the monomer-containing material comprises about 20% w/v n-butyl methacrylate. In some embodiments, the monomer-containing material comprises about 10% w/v n-butyl methacrylate. In some embodiments, the monomer-containing material comprises about 5% w/v n-butyl methacrylate. In some embodiments, the monomer-containing material comprises about 1% w/v n-butyl methacrylate.

In some embodiments, the monomer-containing material comprises about 100% w/v pentyl methacrylate. In some embodiments, the monomer-containing material comprises about 99% w/v pentyl methacrylate. In some embodiments, the monomer-containing material comprises about 95% w/v pentyl methacrylate. In some embodiments, the monomer-containing material comprises about 90% w/v pentyl methacrylate. In some embodiments, the monomer-containing material comprises about 80% w/v pentyl methacrylate. In some embodiments, the monomer-containing material comprises about 75% w/v pentyl methacrylate. In some embodiments, the monomer-containing material comprises about 70% w/v pentyl methacrylate. In some embodiments, the monomer-containing material comprises about 60% w/v pentyl methacrylate. In some embodiments, the monomer-containing material comprises about 50% w/v pentyl methacrylate. In some embodiments, the monomer-containing material comprises about 40% w/v pentyl methacrylate. In some embodiments, the monomer-containing material comprises about 30% w/v pentyl methacrylate. In some embodiments, the monomer-containing material comprises about 25% w/v pentyl methacrylate. In some embodiments, the monomer-containing material comprises about 20% w/v pentyl methacrylate. In some embodiments, the monomer-containing material comprises about 10% w/v pentyl methacrylate. In some embodiments, the monomer-containing material comprises about 5% w/v pentyl methacrylate. In some embodiments, the monomer-containing material comprises about 1% w/v pentyl methacrylate.

In some embodiments, the monomer-containing material comprises about 100% w/v hexyl methacrylate. In some embodiments, the monomer-containing material comprises about 99% w/v hexyl methacrylate. In some embodiments, the monomer-containing material comprises about 95% w/v hexyl methacrylate. In some embodiments, the monomer-containing material comprises about 90% w/v hexyl methacrylate. In some embodiments, the monomer-containing material comprises about 80% w/v hexyl methacrylate. In some embodiments, the monomer-containing material comprises about 75% w/v hexyl methacrylate. In some embodiments, the monomer-containing material comprises about 70% w/v hexyl methacrylate. In some embodiments, the monomer-containing material comprises about 60% w/v hexyl methacrylate. In some embodiments, the monomer-containing material comprises about 50% w/v hexyl methacrylate. In some embodiments, the monomer-containing material comprises about 40% w/v hexyl methacrylate. In some embodiments, the monomer-containing material comprises about 30% w/v hexyl methacrylate. In some embodiments, the monomer-containing material comprises about 25% w/v hexyl methacrylate. In some embodiments, the monomer-containing material comprises about 20% w/v hexyl methacrylate. In some embodiments, the monomer-containing material comprises about 10% w/v hexyl methacrylate. In some embodiments, the monomer-containing material comprises about 5% w/v hexyl methacrylate. In some embodiments, the monomer-containing material comprises about 1% w/v hexyl methacrylate.

In some embodiments, the monomer-containing material comprises about 100% w/v ethylene glycol dimethacrylate. In some embodiments, the monomer-containing material comprises about 99% w/v ethylene glycol dimethacrylate. In some embodiments, the monomer-containing material comprises about 95% w/v ethylene glycol dimethacrylate. In some embodiments, the monomer-containing material comprises about 90% w/v ethylene glycol dimethacrylate. In some embodiments, the monomer-containing material comprises about 80% w/v ethylene glycol dimethacrylate. In some embodiments, the monomer-containing material comprises about 75% w/v ethylene glycol dimethacrylate. In some embodiments, the monomer-containing material comprises about 70% w/v ethylene glycol dimethacrylate. In some embodiments, the monomer-containing material comprises about 60% w/v ethylene glycol dimethacrylate. In some embodiments, the monomer-containing material comprises about 50% w/v ethylene glycol dimethacrylate. In some embodiments, the monomer-containing material comprises about 40% w/v ethylene glycol dimethacrylate. In some embodiments, the monomer-containing material comprises about 30% w/v ethylene glycol dimethacrylate. In some embodiments, the monomer-containing material comprises about 25% w/v ethylene glycol dimethacrylate. In some embodiments, the monomer-containing material comprises about 20% w/v ethylene glycol dimethacrylate. In some embodiments, the monomer-containing material comprises about 10% w/v ethylene glycol dimethacrylate. In some embodiments, the monomer-containing material comprises about 5% w/v ethylene glycol dimethacrylate. In some embodiments, the monomer-containing material comprises about 1% w/v ethylene glycol dimethacrylate.

In some embodiments, the monomer-containing material comprises about 100% w/v trimethylolpropane trimethacrylate. In some embodiments, the monomer-containing material comprises about 99% w/v trimethylolpropane trimethacrylate. In some embodiments, the monomer-containing material comprises about 95% w/v trimethylolpropane trimethacrylate. In some embodiments, the monomer-containing material comprises about 90% w/v trimethylolpropane trimethacrylate. In some embodiments, the monomer-containing material comprises about 80% w/v trimethylolpropane trimethacrylate. In some embodiments, the monomer-containing material comprises about 75% w/v trimethylolpropane trimethacrylate. In some embodiments, the monomer-containing material comprises about 70% w/v trimethylolpropane trimethacrylate. In some embodiments, the monomer-containing material comprises about 60% w/v trimethylolpropane trimethacrylate. In some embodiments, the monomer-containing material comprises about 50% w/v trimethylolpropane trimethacrylate. In some embodiments, the monomer-containing material comprises about 40% w/v trimethylolpropane trimethacrylate. In some embodiments, the monomer-containing material comprises about 30% w/v trimethylolpropane trimethacrylate. In some embodiments, the monomer-containing material comprises about 25% w/v trimethylolpropane trimethacrylate. In some embodiments, the monomer-containing material comprises about 20% w/v trimethylolpropane trimethacrylate. In some embodiments, the monomer-containing material comprises about 10% w/v trimethylolpropane trimethacrylate. In some embodiments, the monomer-containing material comprises about 5% w/v trimethylolpropane trimethacrylate. In some embodiments, the monomer-containing material comprises about 1% w/v trimethylolpropane trimethacrylate.

In some embodiments, the monomer-containing material comprises about 100% v/v diallyl phthalate. In some embodiments, the monomer-containing material comprises about 99% v/v diallyl phthalate. In some embodiments, the monomer-containing material comprises about 95% v/v diallyl phthalate. In some embodiments, the monomer-containing material comprises about 90% v/v diallyl phthalate. In some embodiments, the monomer-containing material comprises about 80% v/v diallyl phthalate. In some embodiments, the monomer-containing material comprises about 70% v/v diallyl phthalate. In some embodiments, the monomer-containing material comprises about 75% v/v diallyl phthalate. In some embodiments, the monomer-containing material comprises about 60% v/v diallyl phthalate. In some embodiments, the monomer-containing material comprises about 50% v/v diallyl phthalate. In some embodiments, the monomer-containing material comprises about 40% v/v diallyl phthalate. In some embodiments, the monomer-containing material comprises about 30% v/v diallyl phthalate. In some embodiments, the monomer-containing material comprises about 25% v/v diallyl phthalate. In some embodiments, the monomer-containing material comprises about 20% v/v diallyl phthalate. In some embodiments, the monomer-containing material comprises about 10% v/v diallyl phthalate. In some embodiments, the monomer-containing material comprises about 5% v/v diallyl phthalate. In some embodiments, the monomer-containing material comprises about 1% v/v diallyl phthalate.

In some embodiments, the monomer-containing material comprises about 100% v/v methyl methacrylate. In some embodiments, the monomer-containing material comprises about 99% v/v methyl methacrylate. In some embodiments, the monomer-containing material comprises about 95% v/v methyl methacrylate. In some embodiments, the monomer-containing material comprises about 90% v/v methyl methacrylate. In some embodiments, the monomer-containing material comprises about 80% v/v methyl methacrylate. In some embodiments, the monomer-containing material comprises about 75% v/v methyl methacrylate. In some embodiments, the monomer-containing material comprises about 70% v/v methyl methacrylate. In some embodiments, the monomer-containing material comprises about 60% v/v methyl methacrylate. In some embodiments, the monomer-containing material comprises about 50% v/v methyl methacrylate. In some embodiments, the monomer-containing material comprises about 40% v/v methyl methacrylate. In some embodiments, the monomer-containing material comprises about 30% v/v methyl methacrylate. In some embodiments, the monomer-containing material comprises about 25% v/v methyl methacrylate. In some embodiments, the monomer-containing material comprises about 20% v/v methyl methacrylate. In some embodiments, the monomer-containing material comprises about 10% v/v methyl methacrylate. In some embodiments, the monomer-containing material comprises about 5% v/v methyl methacrylate. In some embodiments, the monomer-containing material comprises about 1% v/v methyl methacrylate.

In some embodiments, the monomer-containing material comprises about 100% v/v ethyl methacrylate. In some embodiments, the monomer-containing material comprises about 99% v/v ethyl methacrylate. In some embodiments, the monomer-containing material comprises about 95% v/v ethyl methacrylate. In some embodiments, the monomer-containing material comprises about 90% v/v ethyl methacrylate. In some embodiments, the monomer-containing material comprises about 80% v/v ethyl methacrylate. In some embodiments, the monomer-containing material comprises about 75% v/v ethyl methacrylate. In some embodiments, the monomer-containing material comprises about 70% v/v ethyl methacrylate. In some embodiments, the monomer-containing material comprises about 60% v/v ethyl methacrylate. In some embodiments, the monomer-containing material comprises about 50% v/v ethyl methacrylate. In some embodiments, the monomer-containing material comprises about 40% v/v ethyl methacrylate. In some embodiments, the monomer-containing material comprises about 30% v/v ethyl methacrylate. In some embodiments, the monomer-containing material comprises about 25% v/v ethyl methacrylate. In some embodiments, the monomer-containing material comprises about 20% v/v ethyl methacrylate. In some embodiments, the monomer-containing material comprises about 10% v/v ethyl methacrylate. In some embodiments, the monomer-containing material comprises about 5% v/v ethyl methacrylate. In some embodiments, the monomer-containing material comprises about 1% v/v ethyl methacrylate.

In some embodiments, the monomer-containing material comprises about 100% v/v propyl methacrylate. In some embodiments, the monomer-containing material comprises about 99% v/v propyl methacrylate. In some embodiments, the monomer-containing material comprises about 95% v/v propyl methacrylate. In some embodiments, the monomer-containing material comprises about 90% v/v propyl methacrylate. In some embodiments, the monomer-containing material comprises about 80% v/v propyl methacrylate. In some embodiments, the monomer-containing material comprises about 75% v/v propyl methacrylate. In some embodiments, the monomer-containing material comprises about 70% v/v propyl methacrylate. In some embodiments, the monomer-containing material comprises about 60% v/v propyl methacrylate. In some embodiments, the monomer-containing material comprises about 50% v/v propyl methacrylate. In some embodiments, the monomer-containing material comprises about 40% v/v propyl methacrylate. In some embodiments, the monomer-containing material comprises about 30% v/v propyl methacrylate. In some embodiments, the monomer-containing material comprises about 25% v/v propyl methacrylate. In some embodiments, the monomer-containing material comprises about 20% v/v propyl methacrylate. In some embodiments, the monomer-containing material comprises about 10% v/v propyl methacrylate. In some embodiments, the monomer-containing material comprises about 5% v/v propyl methacrylate. In some embodiments, the monomer-containing material comprises about 1% v/v propyl methacrylate.

In some embodiments, the monomer-containing material comprises about 100% v/v n-butyl methacrylate. In some embodiments, the monomer-containing material comprises about 99% v/v n-butyl methacrylate. In some embodiments, the monomer-containing material comprises about 95% v/v n-butyl methacrylate. In some embodiments, the monomer-containing material comprises about 90% v/v n-butyl methacrylate. In some embodiments, the monomer-containing material comprises about 80% v/v n-butyl methacrylate. In some embodiments, the monomer-containing material comprises about 70% v/v n-butyl methacrylate. In some embodiments, the monomer-containing material comprises about 75% v/v n-butyl methacrylate. In some embodiments, the monomer-containing material comprises about 60% v/v n-butyl methacrylate. In some embodiments, the monomer-containing material comprises about 50% v/v n-butyl methacrylate. In some embodiments, the monomer-containing material comprises about 40% v/v n-butyl methacrylate. In some embodiments, the monomer-containing material comprises about 30% v/v n-butyl methacrylate. In some embodiments, the monomer-containing material comprises about 25% v/v n-butyl methacrylate. In some embodiments, the monomer-containing material comprises about 20% v/v n-butyl methacrylate. In some embodiments, the monomer-containing material comprises about 10% v/v n-butyl methacrylate. In some embodiments, the monomer-containing material comprises about 5% v/v n-butyl methacrylate. In some embodiments, the monomer-containing material comprises about 1% v/v n-butyl methacrylate.

In some embodiments, the monomer-containing material comprises about 100% v/v pentyl methacrylate. In some embodiments, the monomer-containing material comprises about 99% v/v pentyl methacrylate. In some embodiments, the monomer-containing material comprises about 95% v/v pentyl methacrylate. In some embodiments, the monomer-containing material comprises about 90% v/v pentyl methacrylate. In some embodiments, the monomer-containing material comprises about 80% v/v pentyl methacrylate. In some embodiments, the monomer-containing material comprises about 75% v/v pentyl methacrylate. In some embodiments, the monomer-containing material comprises about 70% v/v pentyl methacrylate. In some embodiments, the monomer-containing material comprises about 60% v/v pentyl methacrylate. In some embodiments, the monomer-containing material comprises about 50% v/v pentyl methacrylate. In some embodiments, the monomer-containing material comprises about 40% v/v pentyl methacrylate. In some embodiments, the monomer-containing material comprises about 30% v/v pentyl methacrylate. In some embodiments, the monomer-containing material comprises about 25% v/v pentyl methacrylate. In some embodiments, the monomer-containing material comprises about 20% v/v pentyl methacrylate. In some embodiments, the monomer-containing material comprises about 10% v/v pentyl methacrylate. In some embodiments, the monomer-containing material comprises about 5% v/v pentyl methacrylate. In some embodiments, the monomer-containing material comprises about 1% v/v pentyl methacrylate.

In some embodiments, the monomer-containing material comprises about 100% v/v hexyl methacrylate. In some embodiments, the monomer-containing material comprises about 99% v/v hexyl methacrylate. In some embodiments, the monomer-containing material comprises about 95% v/v hexyl methacrylate. In some embodiments, the monomer-containing material comprises about 90% v/v hexyl methacrylate. In some embodiments, the monomer-containing material comprises about 80% v/v hexyl methacrylate. In some embodiments, the monomer-containing material comprises about 75% v/v hexyl methacrylate. In some embodiments, the monomer-containing material comprises about 70% v/v hexyl methacrylate. In some embodiments, the monomer-containing material comprises about 60% v/v hexyl methacrylate. In some embodiments, the monomer-containing material comprises about 50% v/v hexyl methacrylate. In some embodiments, the monomer-containing material comprises about 40% v/v hexyl methacrylate. In some embodiments, the monomer-containing material comprises about 30% v/v hexyl methacrylate. In some embodiments, the monomer-containing material comprises about 25% v/v hexyl methacrylate. In some embodiments, the monomer-containing material comprises about 20% v/v hexyl methacrylate. In some embodiments, the monomer-containing material comprises about 10% v/v hexyl methacrylate. In some embodiments, the monomer-containing material comprises about 5% v/v hexyl methacrylate. In some embodiments, the monomer-containing material comprises about 1% v/v hexyl methacrylate.

In some embodiments, the monomer-containing material comprises about 100% v/v ethylene glycol dimethacrylate. In some embodiments, the monomer-containing material comprises about 99% v/v ethylene glycol dimethacrylate. In some embodiments, the monomer-containing material comprises about 95% v/v ethylene glycol dimethacrylate. In some embodiments, the monomer-containing material comprises about 90% v/v ethylene glycol dimethacrylate. In some embodiments, the monomer-containing material comprises about 80% v/v ethylene glycol dimethacrylate. In some embodiments, the monomer-containing material comprises about 75% v/v ethylene glycol dimethacrylate. In some embodiments, the monomer-containing material comprises about 70% v/v ethylene glycol dimethacrylate. In some embodiments, the monomer-containing material comprises about 60% v/v ethylene glycol dimethacrylate. In some embodiments, the monomer-containing material comprises about 50% v/v ethylene glycol dimethacrylate. In some embodiments, the monomer-containing material comprises about 40% v/v ethylene glycol dimethacrylate. In some embodiments, the monomer-containing material comprises about 30% v/v ethylene glycol dimethacrylate. In some embodiments, the monomer-containing material comprises about 25% v/v ethylene glycol dimethacrylate. In some embodiments, the monomer-containing material comprises about 20% v/v ethylene glycol dimethacrylate. In some embodiments, the monomer-containing material comprises about 10% v/v ethylene glycol dimethacrylate. In some embodiments, the monomer-containing material comprises about 5% v/v ethylene glycol dimethacrylate. In some embodiments, the monomer-containing material comprises about 1% v/v ethylene glycol dimethacrylate.

In some embodiments, the monomer-containing material comprises about 100% v/v trimethylolpropane trimethacrylate. In some embodiments, the monomer-containing material comprises about 99% v/v trimethylolpropane trimethacrylate. In some embodiments, the monomer-containing material comprises about 95% v/v trimethylolpropane trimethacrylate. In some embodiments, the monomer-containing material comprises about 90% v/v trimethylolpropane trimethacrylate. In some embodiments, the monomer-containing material comprises about 80% v/v trimethylolpropane trimethacrylate. In some embodiments, the monomer-containing material comprises about 75% v/v trimethylolpropane trimethacrylate. In some embodiments, the monomer-containing material comprises about 70% v/v trimethylolpropane trimethacrylate. In some embodiments, the monomer-containing material comprises about 60% v/v trimethylolpropane trimethacrylate. In some embodiments, the monomer-containing material comprises about 50% v/v trimethylolpropane trimethacrylate. In some embodiments, the monomer-containing material comprises about 40% v/v trimethylolpropane trimethacrylate. In some embodiments, the monomer-containing material comprises about 30% v/v trimethylolpropane trimethacrylate. In some embodiments, the monomer-containing material comprises about 25% v/v trimethylolpropane trimethacrylate. In some embodiments, the monomer-containing material comprises about 20% v/v trimethylolpropane trimethacrylate. In some embodiments, the monomer-containing material comprises about 10% v/v trimethylolpropane trimethacrylate. In some embodiments, the monomer-containing material comprises about 5% v/v trimethylolpropane trimethacrylate. In some embodiments, the monomer-containing material comprises about 1% v/v trimethylolpropane trimethacrylate.

In some embodiments, the monomer-containing material comprises about 100% w/w diallyl phthalate. In some embodiments, the monomer-containing material comprises about 99% w/w diallyl phthalate. In some embodiments, the monomer-containing material comprises about 95% w/w diallyl phthalate. In some embodiments, the monomer-containing material comprises about 90% w/w diallyl phthalate. In some embodiments, the monomer-containing material comprises about 80% w/w diallyl phthalate. In some embodiments, the monomer-containing material comprises about 70% w/w diallyl phthalate. In some embodiments, the monomer-containing material comprises about 75% w/w diallyl phthalate. In some embodiments, the monomer-containing material comprises about 60% w/w diallyl phthalate. In some embodiments, the monomer-containing material comprises about 50% w/w diallyl phthalate. In some embodiments, the monomer-containing material comprises about 40% w/w diallyl phthalate. In some embodiments, the monomer-containing material comprises about 30% w/w diallyl phthalate. In some embodiments, the monomer-containing material comprises about 25% w/w diallyl phthalate. In some embodiments, the monomer-containing material comprises about 20% w/w diallyl phthalate. In some embodiments, the monomer-containing material comprises about 10% w/w diallyl phthalate. In some embodiments, the monomer-containing material comprises about 5% w/w diallyl phthalate. In some embodiments, the monomer-containing material comprises about 1% w/w diallyl phthalate.

In some embodiments, the monomer-containing material comprises about 100% w/w methyl methacrylate. In some embodiments, the monomer-containing material comprises about 99% w/w methyl methacrylate. In some embodiments, the monomer-containing material comprises about 95% w/w methyl methacrylate. In some embodiments, the monomer-containing material comprises about 90% w/w methyl methacrylate. In some embodiments, the monomer-containing material comprises about 80% w/w methyl methacrylate. In some embodiments, the monomer-containing material comprises about 75% w/w methyl methacrylate. In some embodiments, the monomer-containing material comprises about 70% w/w methyl methacrylate. In some embodiments, the monomer-containing material comprises about 60% w/w methyl methacrylate. In some embodiments, the monomer-containing material comprises about 50% w/w methyl methacrylate. In some embodiments, the monomer-containing material comprises about 40% w/w methyl methacrylate. In some embodiments, the monomer-containing material comprises about 30% w/w methyl methacrylate. In some embodiments, the monomer-containing material comprises about 25% w/w methyl methacrylate. In some embodiments, the monomer-containing material comprises about 20% w/w methyl methacrylate. In some embodiments, the monomer-containing material comprises about 10% w/w methyl methacrylate. In some embodiments, the monomer-containing material comprises about 5% w/w methyl methacrylate. In some embodiments, the monomer-containing material comprises about 1% w/w methyl methacrylate.

In some embodiments, the monomer-containing material comprises about 100% w/w ethyl methacrylate. In some embodiments, the monomer-containing material comprises about 99% w/w ethyl methacrylate. In some embodiments, the monomer-containing material comprises about 95% w/w ethyl methacrylate. In some embodiments, the monomer-containing material comprises about 90% w/w ethyl methacrylate. In some embodiments, the monomer-containing material comprises about 80% w/w ethyl methacrylate. In some embodiments, the monomer-containing material comprises about 75% w/w ethyl methacrylate. In some embodiments, the monomer-containing material comprises about 70% w/w ethyl methacrylate. In some embodiments, the monomer-containing material comprises about 60% w/w ethyl methacrylate. In some embodiments, the monomer-containing material comprises about 50% w/w ethyl methacrylate. In some embodiments, the monomer-containing material comprises about 40% w/w ethyl methacrylate. In some embodiments, the monomer-containing material comprises about 30% w/w ethyl methacrylate. In some embodiments, the monomer-containing material comprises about 25% w/w ethyl methacrylate. In some embodiments, the monomer-containing material comprises about 20% w/w ethyl methacrylate. In some embodiments, the monomer-containing material comprises about 10% w/w ethyl methacrylate. In some embodiments, the monomer-containing material comprises about 5% w/w ethyl methacrylate. In some embodiments, the monomer-containing material comprises about 1% w/w ethyl methacrylate.

In some embodiments, the monomer-containing material comprises about 100% w/w propyl methacrylate. In some embodiments, the monomer-containing material comprises about 99% w/w propyl methacrylate. In some embodiments, the monomer-containing material comprises about 95% w/w propyl methacrylate. In some embodiments, the monomer-containing material comprises about 90% w/w propyl methacrylate. In some embodiments, the monomer-containing material comprises about 80% w/w propyl methacrylate. In some embodiments, the monomer-containing material comprises about 75% w/w propyl methacrylate. In some embodiments, the monomer-containing material comprises about 70% w/w propyl methacrylate. In some embodiments, the monomer-containing material comprises about 60% w/w propyl methacrylate. In some embodiments, the monomer-containing material comprises about 50% w/w propyl methacrylate. In some embodiments, the monomer-containing material comprises about 40% w/w propyl methacrylate. In some embodiments, the monomer-containing material comprises about 30% w/w propyl methacrylate. In some embodiments, the monomer-containing material comprises about 25% w/w propyl methacrylate. In some embodiments, the monomer-containing material comprises about 20% w/w propyl methacrylate. In some embodiments, the monomer-containing material comprises about 10% w/w propyl methacrylate. In some embodiments, the monomer-containing material comprises about 5% w/w propyl methacrylate. In some embodiments, the monomer-containing material comprises about 1% w/w propyl methacrylate.

In some embodiments, the monomer-containing material comprises about 100% w/w n-butyl methacrylate. In some embodiments, the monomer-containing material comprises about 99% w/w n-butyl methacrylate. In some embodiments, the monomer-containing material comprises about 95% w/w n-butyl methacrylate. In some embodiments, the monomer-containing material comprises about 90% w/w n-butyl methacrylate. In some embodiments, the monomer-containing material comprises about 80% w/w n-butyl methacrylate. In some embodiments, the monomer-containing material comprises about 70% w/w n-butyl methacrylate. In some embodiments, the monomer-containing material comprises about 75% w/w n-butyl methacrylate. In some embodiments, the monomer-containing material comprises about 60% w/w n-butyl methacrylate. In some embodiments, the monomer-containing material comprises about 50% w/w n-butyl methacrylate. In some embodiments, the monomer-containing material comprises about 40% w/w n-butyl methacrylate. In some embodiments, the monomer-containing material comprises about 30% w/w n-butyl methacrylate. In some embodiments, the monomer-containing material comprises about 25% w/w n-butyl methacrylate. In some embodiments, the monomer-containing material comprises about 20% w/w n-butyl methacrylate. In some embodiments, the monomer-containing material comprises about 10% w/w n-butyl methacrylate. In some embodiments, the monomer-containing material comprises about 5% w/w n-butyl methacrylate. In some embodiments, the monomer-containing material comprises about 1% w/w n-butyl methacrylate.

In some embodiments, the monomer-containing material comprises about 100% w/w pentyl methacrylate. In some embodiments, the monomer-containing material comprises about 99% w/w pentyl methacrylate. In some embodiments, the monomer-containing material comprises about 95% w/w pentyl methacrylate. In some embodiments, the monomer-containing material comprises about 90% w/w pentyl methacrylate. In some embodiments, the monomer-containing material comprises about 80% w/w pentyl methacrylate. In some embodiments, the monomer-containing material comprises about 75% w/w pentyl methacrylate. In some embodiments, the monomer-containing material comprises about 70% w/w pentyl methacrylate. In some embodiments, the monomer-containing material comprises about 60% w/w pentyl methacrylate. In some embodiments, the monomer-containing material comprises about 50% w/w pentyl methacrylate. In some embodiments, the monomer-containing material comprises about 40% w/w pentyl methacrylate. In some embodiments, the monomer-containing material comprises about 30% w/w pentyl methacrylate. In some embodiments, the monomer-containing material comprises about 25% w/w pentyl methacrylate. In some embodiments, the monomer-containing material comprises about 20% w/w pentyl methacrylate. In some embodiments, the monomer-containing material comprises about 10% w/w pentyl methacrylate. In some embodiments, the monomer-containing material comprises about 5% w/w pentyl methacrylate. In some embodiments, the monomer-containing material comprises about 1% w/w pentyl methacrylate.

In some embodiments, the monomer-containing material comprises about 100% w/w hexyl methacrylate. In some embodiments, the monomer-containing material comprises about 99% w/w hexyl methacrylate. In some embodiments, the monomer-containing material comprises about 95% w/w hexyl methacrylate. In some embodiments, the monomer-containing material comprises about 90% w/w hexyl methacrylate. In some embodiments, the monomer-containing material comprises about 80% w/w hexyl methacrylate. In some embodiments, the monomer-containing material comprises about 75% w/w hexyl methacrylate. In some embodiments, the monomer-containing material comprises about 70% w/w hexyl methacrylate. In some embodiments, the monomer-containing material comprises about 60% w/w hexyl methacrylate. In some embodiments, the monomer-containing material comprises about 50% w/w hexyl methacrylate. In some embodiments, the monomer-containing material comprises about 40% w/w hexyl methacrylate. In some embodiments, the monomer-containing material comprises about 30% w/w hexyl methacrylate. In some embodiments, the monomer-containing material comprises about 25% w/w hexyl methacrylate. In some embodiments, the monomer-containing material comprises about 20% w/w hexyl methacrylate. In some embodiments, the monomer-containing material comprises about 10% w/w hexyl methacrylate. In some embodiments, the monomer-containing material comprises about 5% w/w hexyl methacrylate. In some embodiments, the monomer-containing material comprises about 1% w/w hexyl methacrylate.

In some embodiments, the monomer-containing material comprises about 100% w/w ethylene glycol dimethacrylate. In some embodiments, the monomer-containing material comprises about 99% w/w ethylene glycol dimethacrylate. In some embodiments, the monomer-containing material comprises about 95% w/w ethylene glycol dimethacrylate. In some embodiments, the monomer-containing material comprises about 90% w/w ethylene glycol dimethacrylate. In some embodiments, the monomer-containing material comprises about 80% w/w ethylene glycol dimethacrylate. In some embodiments, the monomer-containing material comprises about 75% w/w ethylene glycol dimethacrylate. In some embodiments, the monomer-containing material comprises about 70% w/w ethylene glycol dimethacrylate. In some embodiments, the monomer-containing material comprises about 60% w/w ethylene glycol dimethacrylate. In some embodiments, the monomer-containing material comprises about 50% w/w ethylene glycol dimethacrylate. In some embodiments, the monomer-containing material comprises about 40% w/w ethylene glycol dimethacrylate. In some embodiments, the monomer-containing material comprises about 30% w/w ethylene glycol dimethacrylate. In some embodiments, the monomer-containing material comprises about 25% w/w ethylene glycol dimethacrylate. In some embodiments, the monomer-containing material comprises about 20% w/w ethylene glycol dimethacrylate. In some embodiments, the monomer-containing material comprises about 10% w/w ethylene glycol dimethacrylate. In some embodiments, the monomer-containing material comprises about 5% w/w ethylene glycol dimethacrylate. In some embodiments, the monomer-containing material comprises about 1% w/w ethylene glycol dimethacrylate.

In some embodiments, the monomer-containing material comprises about 100% w/w trimethylolpropane trimethacrylate. In some embodiments, the monomer-containing material comprises about 99% w/w trimethylolpropane trimethacrylate. In some embodiments, the monomer-containing material comprises about 95% w/w trimethylolpropane trimethacrylate. In some embodiments, the monomer-containing material comprises about 90% w/w trimethylolpropane trimethacrylate. In some embodiments, the monomer-containing material comprises about 80% w/w trimethylolpropane trimethacrylate. In some embodiments, the monomer-containing material comprises about 75% w/w trimethylolpropane trimethacrylate. In some embodiments, the monomer-containing material comprises about 70% w/w trimethylolpropane trimethacrylate. In some embodiments, the monomer-containing material comprises about 60% w/w trimethylolpropane trimethacrylate. In some embodiments, the monomer-containing material comprises about 50% w/w trimethylolpropane trimethacrylate. In some embodiments, the monomer-containing material comprises about 40% w/w trimethylolpropane trimethacrylate. In some embodiments, the monomer-containing material comprises about 30% w/w trimethylolpropane trimethacrylate. In some embodiments, the monomer-containing material comprises about 25% w/w trimethylolpropane trimethacrylate. In some embodiments, the monomer-containing material comprises about 20% w/w trimethylolpropane trimethacrylate. In some embodiments, the monomer-containing material comprises about 10% w/w trimethylolpropane trimethacrylate. In some embodiments, the monomer-containing material comprises about 5% w/w trimethylolpropane trimethacrylate. In some embodiments, the monomer-containing material comprises about 1% w/w trimethylolpropane trimethacrylate.

In some embodiments, the monomer-containing material comprises about 90% w/w methyl methacrylate and about 10% w/w n-butyl methacrylate. In some embodiments, the monomer-containing material comprises about 80% w/w methyl methacrylate and about 20% w/w n-butyl methacrylate. In some embodiments, the monomer-containing material comprises about 70% w/w methyl methacrylate and about 30% w/w n-butyl methacrylate. In some embodiments, the monomer-containing material comprises about 60% w/w methyl methacrylate and about 40% w/w n-butyl methacrylate. In some embodiments, the monomer-containing material comprises about 50% w/w methyl methacrylate and about 50% w/w n-butyl methacrylate. In some embodiments, the monomer-containing material comprises about 40% w/w methyl methacrylate and about 60% w/w n-butyl methacrylate. In some embodiments, the monomer-containing material comprises about 30% w/w methyl methacrylate and about 70% w/w n-butyl methacrylate. In some embodiments, the monomer-containing material comprises about 20% w/w methyl methacrylate and about 80% w/w n-butyl methacrylate. In some embodiments, the monomer-containing material comprises about 10% w/w methyl methacrylate and about 90% w/w n-butyl methacrylate.

In some embodiments, the monomer-containing material comprises about 90% w/w methyl methacrylate and about 10% w/w ethylene glycol dimethacrylate. In some embodiments, the monomer-containing material comprises about 80% w/w methyl methacrylate and about 20% w/w ethylene glycol dimethacrylate. In some embodiments, the monomer-containing material comprises about 70% w/w methyl methacrylate and about 30% w/w ethylene glycol dimethacrylate. In some embodiments, the monomer-containing material comprises about 60% w/w methyl methacrylate and about 40% w/w ethylene glycol dimethacrylate. In some embodiments, the monomer-containing material comprises about 50% w/w methyl methacrylate and about 50% w/w ethylene glycol dimethacrylate. In some embodiments, the monomer-containing material comprises about 40% w/w methyl methacrylate and about 60% w/w ethylene glycol dimethacrylate. In some embodiments, the monomer-containing material comprises about 30% w/w methyl methacrylate and about 70% w/w ethylene glycol dimethacrylate. In some embodiments, the monomer-containing material comprises about 20% w/w methyl methacrylate and about 80% w/w ethylene glycol dimethacrylate. In some embodiments, the monomer-containing material comprises about 10% w/w methyl methacrylate and about 90% w/w ethylene glycol dimethacrylate.

In some embodiments, the monomer-containing material comprises about 90% w/w ethyl methacrylate and about 10% w/w ethylene glycol dimethacrylate. In some embodiments, the monomer-containing material comprises about 80% w/w ethyl methacrylate and about 20% w/w ethylene glycol dimethacrylate. In some embodiments, the monomer-containing material comprises about 70% w/w ethyl methacrylate and about 30% w/w ethylene glycol dimethacrylate. In some embodiments, the monomer-containing material comprises about 60% w/w ethyl methacrylate and about 40% w/w ethylene glycol dimethacrylate. In some embodiments, the monomer-containing material comprises about 50% w/w ethyl methacrylate and about 50% w/w ethylene glycol dimethacrylate. In some embodiments, the monomer-containing material comprises about 40% w/w ethyl methacrylate and about 60% w/w ethylene glycol dimethacrylate. In some embodiments, the monomer-containing material comprises about 30% w/w ethyl methacrylate and about 70% w/w ethylene glycol dimethacrylate. In some embodiments, the monomer-containing material comprises about 20% w/w ethyl methacrylate and about 80% w/w ethylene glycol dimethacrylate. In some embodiments, the monomer-containing material comprises about 10% w/w ethyl methacrylate and about 90% w/w ethylene glycol dimethacrylate.

In some embodiments, the monomer-containing material comprises about 20% w/w methyl methacrylate, about 20% w/w ethyl methacrylate, about 20% w/w n-butyl methacrylate, about 20% w/w ethylene glycol dimethacrylate, and 20% w/w trimethylolpropane trimethacrylate. In some embodiments, the monomer-containing material comprises about 10% w/w methyl methacrylate, about 30% w/w ethyl methacrylate, about 20% w/w n-butyl methacrylate, about 20% w/w ethylene glycol dimethacrylate, and 20% w/w trimethylolpropane trimethacrylate. In some embodiments, the monomer-containing material comprises about 10% w/w methyl methacrylate, about 20% w/w ethyl methacrylate, about 30% w/w n-butyl methacrylate, about 20% w/w ethylene glycol dimethacrylate, and 20% w/w trimethylolpropane trimethacrylate. In some embodiments, the monomer-containing material comprises about 10% w/w methyl methacrylate, about 20% w/w ethyl methacrylate, about 20% w/w n-butyl methacrylate, about 30% w/w ethylene glycol dimethacrylate, and 20% w/w trimethylolpropane trimethacrylate. In some embodiments, the monomer-containing material comprises about 10% w/w methyl methacrylate, about 20% w/w ethyl methacrylate, about 20% w/w n-butyl methacrylate, about 20% w/w ethylene glycol dimethacrylate, and 30% w/w trimethylolpropane trimethacrylate. In some embodiments, the monomer-containing material comprises about 30% w/w methyl methacrylate, about 10% w/w ethyl methacrylate, about 20% w/w n-butyl methacrylate, about 20% w/w ethylene glycol dimethacrylate, and 20% w/w trimethylolpropane trimethacrylate. In some embodiments, the monomer-containing material comprises about 20% w/w methyl methacrylate, about 10% w/w ethyl methacrylate, about 30% w/w n-butyl methacrylate, about 20% w/w ethylene glycol dimethacrylate, and 20% w/w trimethylolpropane trimethacrylate. In some embodiments, the monomer-containing material comprises about 20% w/w methyl methacrylate, about 10% w/w ethyl methacrylate, about 20% w/w n-butyl methacrylate, about 30% w/w ethylene glycol dimethacrylate, and 20% w/w trimethylolpropane trimethacrylate. In some embodiments, the monomer-containing material comprises about 20% w/w methyl methacrylate, about 10% w/w ethyl methacrylate, about 20% w/w n-butyl methacrylate, about 20% w/w ethylene glycol dimethacrylate, and 30% w/w trimethylolpropane trimethacrylate. In some embodiments, the monomer-containing material comprises about 30% w/w methyl methacrylate, about 20% w/w ethyl methacrylate, about 10% w/w n-butyl methacrylate, about 20% w/w ethylene glycol dimethacrylate, and 20% w/w trimethylolpropane trimethacrylate. In some embodiments, the monomer-containing material comprises about 20% w/w methyl methacrylate, about 30% w/w ethyl methacrylate, about 10% w/w n-butyl methacrylate, about 20% w/w ethylene glycol dimethacrylate, and 20% w/w trimethylolpropane trimethacrylate. In some embodiments, the monomer-containing material comprises about 20% w/w methyl methacrylate, about 20% w/w ethyl methacrylate, about 10% w/w n-butyl methacrylate, about 30% w/w ethylene glycol dimethacrylate, and 20% w/w trimethylolpropane trimethacrylate. In some embodiments, the monomer-containing material comprises about 20% w/w methyl methacrylate, about 20% w/w ethyl methacrylate, about 10% w/w n-butyl methacrylate, about 20% w/w ethylene glycol dimethacrylate, and 30% w/w trimethylolpropane trimethacrylate. In some embodiments, the monomer-containing material comprises about 30% w/w methyl methacrylate, about 20% w/w ethyl methacrylate, about 20% w/w n-butyl methacrylate, about 10% w/w ethylene glycol dimethacrylate, and 20% w/w trimethylolpropane trimethacrylate. In some embodiments, the monomer-containing material comprises about 20% w/w methyl methacrylate, about 30% w/w ethyl methacrylate, about 20% w/w n-butyl methacrylate, about 10% w/w ethylene glycol dimethacrylate, and 20% w/w trimethylolpropane trimethacrylate. In some embodiments, the monomer-containing material comprises about 20% w/w methyl methacrylate, about 20% w/w ethyl methacrylate, about 30% w/w n-butyl methacrylate, about 10% w/w ethylene glycol dimethacrylate, and 20% w/w trimethylolpropane trimethacrylate. In some embodiments, the monomer-containing material comprises about 20% w/w methyl methacrylate, about 20% w/w ethyl methacrylate, about 20% w/w n-butyl methacrylate, about 10% w/w ethylene glycol dimethacrylate, and 30% w/w trimethylolpropane trimethacrylate. In some embodiments, the monomer-containing material comprises about 30% w/w methyl methacrylate, about 20% w/w ethyl methacrylate, about 20% w/w n-butyl methacrylate, about 20% w/w ethylene glycol dimethacrylate, and 10% w/w trimethylolpropane trimethacrylate. In some embodiments, the monomer-containing material comprises about 20% w/w methyl methacrylate, about 30% w/w ethyl methacrylate, about 20% w/w n-butyl methacrylate, about 20% w/w ethylene glycol dimethacrylate, and 10% w/w trimethylolpropane trimethacrylate. In some embodiments, the monomer-containing material comprises about 20% w/w methyl methacrylate, about 20% w/w ethyl methacrylate, about 30% w/w n-butyl methacrylate, about 20% w/w ethylene glycol dimethacrylate, and 10% w/w trimethylolpropane trimethacrylate. In some embodiments, the monomer-containing material comprises about 20% w/w methyl methacrylate, about 20% w/w ethyl methacrylate, about 20% w/w n-butyl methacrylate, about 30% w/w ethylene glycol dimethacrylate, and 10% w/w trimethylolpropane trimethacrylate.

In some embodiments, the embodiments, the monomer-containing material comprises about 40% w/w methyl methacrylate, about 40% ethyl methacrylate, and about 20% w/w ethylene glycol dimethacrylate. In some embodiments, the embodiments, the monomer-containing material comprises about 30% w/w methyl methacrylate, about 50% ethyl methacrylate, and about 20% w/w ethylene glycol dimethacrylate. In some embodiments, the embodiments, the monomer-containing material comprises about 30% w/w methyl methacrylate, about 40% ethyl methacrylate, and about 30% w/w ethylene glycol dimethacrylate. In some embodiments, the embodiments, the monomer-containing material comprises about 20% w/w methyl methacrylate, about 60% ethyl methacrylate, and about 20% w/w ethylene glycol dimethacrylate. In some embodiments, the embodiments, the monomer-containing material comprises about 20% w/w methyl methacrylate, about 50% ethyl methacrylate, and about 30% w/w ethylene glycol dimethacrylate. In some embodiments, the embodiments, the monomer-containing material comprises about 20% w/w methyl methacrylate, about 40% ethyl methacrylate, and about 40% w/w ethylene glycol dimethacrylate. In some embodiments, the embodiments, the monomer-containing material comprises about 10% w/w methyl methacrylate, about 70% ethyl methacrylate, and about 20% w/w ethylene glycol dimethacrylate. In some embodiments, the embodiments, the monomer-containing material comprises about 10% w/w methyl methacrylate, about 60% ethyl methacrylate, and about 30% w/w ethylene glycol dimethacrylate. In some embodiments, the embodiments, the monomer-containing material comprises about 10% w/w methyl methacrylate, about 50% ethyl methacrylate, and about 40% w/w ethylene glycol dimethacrylate. In some embodiments, the embodiments, the monomer-containing material comprises about 10% w/w methyl methacrylate, about 40% ethyl methacrylate, and about 50% w/w ethylene glycol dimethacrylate. In some embodiments, the embodiments, the monomer-containing material comprises about 25% w/w methyl methacrylate, about 25% ethyl methacrylate, and about 50% w/w ethylene glycol dimethacrylate. In some embodiments, the embodiments, the monomer-containing material comprises about 50% w/w methyl methacrylate, about 30% ethyl methacrylate, and about 20% w/w ethylene glycol dimethacrylate. In some embodiments, the embodiments, the monomer-containing material comprises about 40% w/w methyl methacrylate, about 30% ethyl methacrylate, and about 30% w/w ethylene glycol dimethacrylate. In some embodiments, the embodiments, the monomer-containing material comprises about 60% w/w methyl methacrylate, about 20% ethyl methacrylate, and about 20% w/w ethylene glycol dimethacrylate. In some embodiments, the embodiments, the monomer-containing material comprises about 40% w/w methyl methacrylate, about 20% ethyl methacrylate, and about 40% w/w ethylene glycol dimethacrylate. In some embodiments, the embodiments, the monomer-containing material comprises about 50% w/w methyl methacrylate, about 20% ethyl methacrylate, and about 30% w/w ethylene glycol dimethacrylate. In some embodiments, the embodiments, the monomer-containing material comprises about 80% w/w methyl methacrylate, about 10% ethyl methacrylate, and about 10% w/w ethylene glycol dimethacrylate. In some embodiments, the embodiments, the monomer-containing material comprises about 70% w/w methyl methacrylate, about 10% ethyl methacrylate, and about 20% w/w ethylene glycol dimethacrylate. In some embodiments, the embodiments, the monomer-containing material comprises about 60% w/w methyl methacrylate, about 10% ethyl methacrylate, and about 30% w/w ethylene glycol dimethacrylate. In some embodiments, the embodiments, the monomer-containing material comprises about 50% w/w methyl methacrylate, about 10% ethyl methacrylate, and about 40% w/w ethylene glycol dimethacrylate. In some embodiments, the embodiments, the monomer-containing material comprises about 40% w/w methyl methacrylate, about 10% ethyl methacrylate, and about 50% w/w ethylene glycol dimethacrylate.

In some embodiments, the embodiments, the monomer-containing material comprises about 40% w/w methyl methacrylate, about 40% n-butyl methacrylate, and about 20% w/w ethylene glycol dimethacrylate. In some embodiments, the embodiments, the monomer-containing material comprises about 30% w/w methyl methacrylate, about 50% n-butyl methacrylate, and about 20% w/w ethylene glycol dimethacrylate. In some embodiments, the embodiments, the monomer-containing material comprises about 30% w/w methyl methacrylate, about 40% n-butyl methacrylate, and about 30% w/w ethylene glycol dimethacrylate. In some embodiments, the embodiments, the monomer-containing material comprises about 20% w/w methyl methacrylate, about 60% n-butyl methacrylate, and about 20% w/w ethylene glycol dimethacrylate. In some embodiments, the embodiments, the monomer-containing material comprises about 20% w/w methyl methacrylate, about 50% n-butyl methacrylate, and about 30% w/w ethylene glycol dimethacrylate. In some embodiments, the embodiments, the monomer-containing material comprises about 20% w/w methyl methacrylate, about 40% n-butyl methacrylate, and about 40% w/w ethylene glycol dimethacrylate. In some embodiments, the embodiments, the monomer-containing material comprises about 10% w/w methyl methacrylate, about 70% n-butyl methacrylate, and about 20% w/w ethylene glycol dimethacrylate. In some embodiments, the embodiments, the monomer-containing material comprises about 10% w/w methyl methacrylate, about 60% n-butyl methacrylate, and about 30% w/w ethylene glycol dimethacrylate. In some embodiments, the embodiments, the monomer-containing material comprises about 10% w/w methyl methacrylate, about 50% n-butyl methacrylate, and about 40% w/w ethylene glycol dimethacrylate. In some embodiments, the embodiments, the monomer-containing material comprises about 10% w/w methyl methacrylate, about 40% n-butyl methacrylate, and about 50% w/w ethylene glycol dimethacrylate. In some embodiments, the embodiments, the monomer-containing material comprises about 25% w/w methyl methacrylate, about 25% n-butyl methacrylate, and about 50% w/w ethylene glycol dimethacrylate. In some embodiments, the embodiments, the monomer-containing material comprises about 50% w/w methyl methacrylate, about 30% n-butyl methacrylate, and about 20% w/w ethylene glycol dimethacrylate. In some embodiments, the embodiments, the monomer-containing material comprises about 40% w/w methyl methacrylate, about 30% n-butyl methacrylate, and about 30% w/w ethylene glycol dimethacrylate. In some embodiments, the embodiments, the monomer-containing material comprises about 60% w/w methyl methacrylate, about 20% n-butyl methacrylate, and about 20% w/w ethylene glycol dimethacrylate. In some embodiments, the embodiments, the monomer-containing material comprises about 40% w/w methyl methacrylate, about 20% n-butyl methacrylate, and about 40% w/w ethylene glycol dimethacrylate. In some embodiments, the embodiments, the monomer-containing material comprises about 50% w/w methyl methacrylate, about 20% n-butyl methacrylate, and about 30% w/w ethylene glycol dimethacrylate. In some embodiments, the embodiments, the monomer-containing material comprises about 80% w/w methyl methacrylate, about 10% n-butyl methacrylate, and about 10% w/w ethylene glycol dimethacrylate. In some embodiments, the embodiments, the monomer-containing material comprises about 70% w/w methyl methacrylate, about 10% n-butyl methacrylate, and about 20% w/w ethylene glycol dimethacrylate. In some embodiments, the embodiments, the monomer-containing material comprises about 60% w/w methyl methacrylate, about 10% n-butyl methacrylate, and about 30% w/w ethylene glycol dimethacrylate. In some embodiments, the embodiments, the monomer-containing material comprises about 50% w/w methyl methacrylate, about 10% n-butyl methacrylate, and about 40% w/w ethylene glycol dimethacrylate. In some embodiments, the embodiments, the monomer-containing material comprises about 40% w/w methyl methacrylate, about 10% n-butyl methacrylate, and about 50% w/w ethylene glycol dimethacrylate.

In some embodiments, the embodiments, the monomer-containing material comprises about 40% w/w methyl methacrylate, about 40% n-butyl methacrylate, and about 20% w/w diallyl phthalate. In some embodiments, the embodiments, the monomer-containing material comprises about 30% w/w methyl methacrylate, about 50% n-butyl methacrylate, and about 20% w/w diallyl phthalate. In some embodiments, the embodiments, the monomer-containing material comprises about 30% w/w methyl methacrylate, about 40% n-butyl methacrylate, and about 30% w/w diallyl phthalate. In some embodiments, the embodiments, the monomer-containing material comprises about 20% w/w methyl methacrylate, about 60% n-butyl methacrylate, and about 20% w/w diallyl phthalate. In some embodiments, the embodiments, the monomer-containing material comprises about 20% w/w methyl methacrylate, about 50% n-butyl methacrylate, and about 30% w/w diallyl phthalate. In some embodiments, the embodiments, the monomer-containing material comprises about 20% w/w methyl methacrylate, about 40% n-butyl methacrylate, and about 40% w/w diallyl phthalate. In some embodiments, the embodiments, the monomer-containing material comprises about 10% w/w methyl methacrylate, about 70% n-butyl methacrylate, and about 20% w/w diallyl phthalate. In some embodiments, the embodiments, the monomer-containing material comprises about 10% w/w methyl methacrylate, about 60% n-butyl methacrylate, and about 30% w/w diallyl phthalate. In some embodiments, the embodiments, the monomer-containing material comprises about 10% w/w methyl methacrylate, about 50% n-butyl methacrylate, and about 40% w/w diallyl phthalate. In some embodiments, the embodiments, the monomer-containing material comprises about 10% w/w methyl methacrylate, about 40% n-butyl methacrylate, and about 50% w/w diallyl phthalate. In some embodiments, the embodiments, the monomer-containing material comprises about 25% w/w methyl methacrylate, about 25% n-butyl methacrylate, and about 50% w/w diallyl phthalate. In some embodiments, the embodiments, the monomer-containing material comprises about 50% w/w methyl methacrylate, about 30% n-butyl methacrylate, and about 20% w/w diallyl phthalate. In some embodiments, the embodiments, the monomer-containing material comprises about 40% w/w methyl methacrylate, about 30% n-butyl methacrylate, and about 30% w/w diallyl phthalate. In some embodiments, the embodiments, the monomer-containing material comprises about 60% w/w methyl methacrylate, about 20% n-butyl methacrylate, and about 20% w/w diallyl phthalate. In some embodiments, the embodiments, the monomer-containing material comprises about 40% w/w methyl methacrylate, about 20% n-butyl methacrylate, and about 40% w/w diallyl phthalate. In some embodiments, the embodiments, the monomer-containing material comprises about 50% w/w methyl methacrylate, about 20% n-butyl methacrylate, and about 30% w/w diallyl phthalate. In some embodiments, the embodiments, the monomer-containing material comprises about 80% w/w methyl methacrylate, about 10% n-butyl methacrylate, and about 10% w/w diallyl phthalate. In some embodiments, the embodiments, the monomer-containing material comprises about 70% w/w methyl methacrylate, about 10% n-butyl methacrylate, and about 20% w/w diallyl phthalate. In some embodiments, the embodiments, the monomer-containing material comprises about 60% w/w methyl methacrylate, about 10% n-butyl methacrylate, and about 30% w/w diallyl phthalate. In some embodiments, the embodiments, the monomer-containing material comprises about 50% w/w methyl methacrylate, about 10% n-butyl methacrylate, and about 40% w/w diallyl phthalate. In some embodiments, the embodiments, the monomer-containing material comprises about 40% w/w methyl methacrylate, about 10% n-butyl methacrylate, and about 50% w/w diallyl phthalate.

In some embodiments, the embodiments, the monomer-containing material comprises about 40% w/w methyl methacrylate, about 40% n-butyl methacrylate, and about 20% w/w trimethylolpropane trimethacrylate. In some embodiments, the embodiments, the monomer-containing material comprises about 30% w/w methyl methacrylate, about 50% n-butyl methacrylate, and about 20% w/w trimethylolpropane trimethacrylate. In some embodiments, the embodiments, the monomer-containing material comprises about 30% w/w methyl methacrylate, about 40% n-butyl methacrylate, and about 30% w/w trimethylolpropane trimethacrylate. In some embodiments, the embodiments, the monomer-containing material comprises about 20% w/w methyl methacrylate, about 60% n-butyl methacrylate, and about 20% w/w trimethylolpropane trimethacrylate. In some embodiments, the embodiments, the monomer-containing material comprises about 20% w/w methyl methacrylate, about 50% n-butyl methacrylate, and about 30% w/w trimethylolpropane trimethacrylate. In some embodiments, the embodiments, the monomer-containing material comprises about 20% w/w methyl methacrylate, about 40% n-butyl methacrylate, and about 40% w/w trimethylolpropane trimethacrylate. In some embodiments, the embodiments, the monomer-containing material comprises about 10% w/w methyl methacrylate, about 70% n-butyl methacrylate, and about 20% w/w trimethylolpropane trimethacrylate. In some embodiments, the embodiments, the monomer-containing material comprises about 10% w/w methyl methacrylate, about 60% n-butyl methacrylate, and about 30% w/w trimethylolpropane trimethacrylate. In some embodiments, the embodiments, the monomer-containing material comprises about 10% w/w methyl methacrylate, about 50% n-butyl methacrylate, and about 40% w/w trimethylolpropane trimethacrylate. In some embodiments, the embodiments, the monomer-containing material comprises about 10% w/w methyl methacrylate, about 40% n-butyl methacrylate, and about 50% w/w trimethylolpropane trimethacrylate. In some embodiments, the embodiments, the monomer-containing material comprises about 25% w/w methyl methacrylate, about 25% n-butyl methacrylate, and about 50% w/w trimethylolpropane trimethacrylate. In some embodiments, the embodiments, the monomer-containing material comprises about 50% w/w methyl methacrylate, about 30% n-butyl methacrylate, and about 20% w/w trimethylolpropane trimethacrylate. In some embodiments, the embodiments, the monomer-containing material comprises about 40% w/w methyl methacrylate, about 30% n-butyl methacrylate, and about 30% w/w trimethylolpropane trimethacrylate. In some embodiments, the embodiments, the monomer-containing material comprises about 60% w/w methyl methacrylate, about 20% n-butyl methacrylate, and about 20% w/w trimethylolpropane trimethacrylate. In some embodiments, the embodiments, the monomer-containing material comprises about 40% w/w methyl methacrylate, about 20% n-butyl methacrylate, and about 40% w/w trimethylolpropane trimethacrylate. In some embodiments, the embodiments, the monomer-containing material comprises about 50% w/w methyl methacrylate, about 20% n-butyl methacrylate, and about 30% w/w trimethylolpropane trimethacrylate. In some embodiments, the embodiments, the monomer-containing material comprises about 80% w/w methyl methacrylate, about 10% n-butyl methacrylate, and about 10% w/w trimethylolpropane trimethacrylate. In some embodiments, the embodiments, the monomer-containing material comprises about 70% w/w methyl methacrylate, about 10% n-butyl methacrylate, and about 20% w/w trimethylolpropane trimethacrylate. In some embodiments, the embodiments, the monomer-containing material comprises about 60% w/w methyl methacrylate, about 10% n-butyl methacrylate, and about 30% w/w trimethylolpropane trimethacrylate. In some embodiments, the embodiments, the monomer-containing material comprises about 50% w/w methyl methacrylate, about 10% n-butyl methacrylate, and about 40% w/w trimethylolpropane trimethacrylate. In some embodiments, the embodiments, the monomer-containing material comprises about 40% w/w methyl methacrylate, about 10% n-butyl methacrylate, and about 50% w/w trimethylolpropane trimethacrylate.

In some embodiments, the embodiments, the monomer-containing material comprises about 40% w/w methyl methacrylate, about 40% n-butyl methacrylate, and about 20% w/w ethylene glycol dimethacrylate. In some embodiments, the embodiments, the monomer-containing material comprises about 30% w/w methyl methacrylate, about 50% n-butyl methacrylate, and about 20% w/w ethylene glycol dimethacrylate. In some embodiments, the embodiments, the monomer-containing material comprises about 30% w/w methyl methacrylate, about 40% n-butyl methacrylate, and about 30% w/w ethylene glycol dimethacrylate. In some embodiments, the embodiments, the monomer-containing material comprises about 20% w/w methyl methacrylate, about 60% n-butyl methacrylate, and about 20% w/w ethylene glycol dimethacrylate. In some embodiments, the embodiments, the monomer-containing material comprises about 20% w/w methyl methacrylate, about 50% n-butyl methacrylate, and about 30% w/w ethylene glycol dimethacrylate. In some embodiments, the embodiments, the monomer-containing material comprises about 20% w/w methyl methacrylate, about 40% n-butyl methacrylate, and about 40% w/w ethylene glycol dimethacrylate. In some embodiments, the embodiments, the monomer-containing material comprises about 10% w/w methyl methacrylate, about 70% n-butyl methacrylate, and about 20% w/w ethylene glycol dimethacrylate. In some embodiments, the embodiments, the monomer-containing material comprises about 10% w/w methyl methacrylate, about 60% n-butyl methacrylate, and about 30% w/w ethylene glycol dimethacrylate. In some embodiments, the embodiments, the monomer-containing material comprises about 10% w/w methyl methacrylate, about 50% n-butyl methacrylate, and about 40% w/w ethylene glycol dimethacrylate. In some embodiments, the embodiments, the monomer-containing material comprises about 10% w/w methyl methacrylate, about 40% n-butyl methacrylate, and about 50% w/w ethylene glycol dimethacrylate. In some embodiments, the embodiments, the monomer-containing material comprises about 50% w/w methyl methacrylate, about 30% n-butyl methacrylate, and about 20% w/w ethylene glycol dimethacrylate. In some embodiments, the embodiments, the monomer-containing material comprises about 40% w/w methyl methacrylate, about 30% n-butyl methacrylate, and about 30% w/w ethylene glycol dimethacrylate. In some embodiments, the embodiments, the monomer-containing material comprises about 60% w/w methyl methacrylate, about 20% n-butyl methacrylate, and about 20% w/w ethylene glycol dimethacrylate. In some embodiments, the embodiments, the monomer-containing material comprises about 40% w/w methyl methacrylate, about 20% n-butyl methacrylate, and about 40% w/w ethylene glycol dimethacrylate. In some embodiments, the embodiments, the monomer-containing material comprises about 50% w/w methyl methacrylate, about 20% n-butyl methacrylate, and about 30% w/w ethylene glycol dimethacrylate. In some embodiments, the embodiments, the monomer-containing material comprises about 70% w/w methyl methacrylate, about 10% n-butyl methacrylate, and about 20% w/w ethylene glycol dimethacrylate. In some embodiments, the embodiments, the monomer-containing material comprises about 60% w/w methyl methacrylate, about 10% n-butyl methacrylate, and about 30% w/w ethylene glycol dimethacrylate. In some embodiments, the embodiments, the monomer-containing material comprises about 50% w/w methyl methacrylate, about 10% n-butyl methacrylate, and about 40% w/w ethylene glycol dimethacrylate. In some embodiments, the embodiments, the monomer-containing material comprises about 40% w/w methyl methacrylate, about 10% n-butyl methacrylate, and about 50% w/w ethylene glycol dimethacrylate.

In some embodiments, the embodiments, the monomer-containing material comprises about 40% w/w methyl methacrylate, about 40% ethyl methacrylate, and about 20% w/w trimethylolpropane trimethacrylate. In some embodiments, the embodiments, the monomer-containing material comprises about 30% w/w methyl methacrylate, about 50% ethyl methacrylate, and about 20% w/w trimethylolpropane trimethacrylate. In some embodiments, the embodiments, the monomer-containing material comprises about 30% w/w methyl methacrylate, about 40% ethyl methacrylate, and about 30% w/w trimethylolpropane trimethacrylate. In some embodiments, the embodiments, the monomer-containing material comprises about 20% w/w methyl methacrylate, about 60% ethyl methacrylate, and about 20% w/w trimethylolpropane trimethacrylate. In some embodiments, the embodiments, the monomer-containing material comprises about 20% w/w methyl methacrylate, about 50% ethyl methacrylate, and about 30% w/w trimethylolpropane trimethacrylate. In some embodiments, the embodiments, the monomer-containing material comprises about 20% w/w methyl methacrylate, about 40% ethyl methacrylate, and about 40% w/w trimethylolpropane trimethacrylate. In some embodiments, the embodiments, the monomer-containing material comprises about 10% w/w methyl methacrylate, about 70% ethyl methacrylate, and about 20% w/w trimethylolpropane trimethacrylate. In some embodiments, the embodiments, the monomer-containing material comprises about 10% w/w methyl methacrylate, about 60% ethyl methacrylate, and about 30% w/w trimethylolpropane trimethacrylate. In some embodiments, the embodiments, the monomer-containing material comprises about 10% w/w methyl methacrylate, about 50% ethyl methacrylate, and about 40% w/w trimethylolpropane trimethacrylate. In some embodiments, the embodiments, the monomer-containing material comprises about 10% w/w methyl methacrylate, about 40% ethyl methacrylate, and about 50% w/w trimethylolpropane trimethacrylate. In some embodiments, the embodiments, the monomer-containing material comprises about 50% w/w methyl methacrylate, about 30% ethyl methacrylate, and about 20% w/w trimethylolpropane trimethacrylate. In some embodiments, the embodiments, the monomer-containing material comprises about 40% w/w methyl methacrylate, about 30% ethyl methacrylate, and about 30% w/w trimethylolpropane trimethacrylate. In some embodiments, the embodiments, the monomer-containing material comprises about 60% w/w methyl methacrylate, about 20% ethyl methacrylate, and about 20% w/w trimethylolpropane trimethacrylate. In some embodiments, the embodiments, the monomer-containing material comprises about 40% w/w methyl methacrylate, about 20% ethyl methacrylate, and about 40% w/w trimethylolpropane trimethacrylate. In some embodiments, the embodiments, the monomer-containing material comprises about 50% w/w methyl methacrylate, about 20% ethyl methacrylate, and about 30% w/w trimethylolpropane trimethacrylate. In some embodiments, the embodiments, the monomer-containing material comprises about 70% w/w methyl methacrylate, about 10% ethyl methacrylate, and about 20% w/w trimethylolpropane trimethacrylate. In some embodiments, the embodiments, the monomer-containing material comprises about 60% w/w methyl methacrylate, about 10% ethyl methacrylate, and about 30% w/w trimethylolpropane trimethacrylate. In some embodiments, the embodiments, the monomer-containing material comprises about 50% w/w methyl methacrylate, about 10% ethyl methacrylate, and about 40% w/w trimethylolpropane trimethacrylate. In some embodiments, the embodiments, the monomer-containing material comprises about 40% w/w methyl methacrylate, about 10% ethyl methacrylate, and about 50% w/w trimethylolpropane trimethacrylate.

In some embodiments, the monomer-containing material can further comprise a polymerization catalyst. In some embodiments, the polymerization catalyst can comprise a UV polymerization catalyst. In some embodiments, the polymerization catalyst can comprise benzoin methyl ether. In some embodiments, the polymerization catalyst can comprise about 0.1% w/w, about 0.2% w/w, about 0.25% w/w, about 0.3%, about 0.4% w/w, about 0.5% w/w, about 0.6% w/w, about 0.7% w/w, about 0.75% w/w, about 0.8% w/w, about 0.9% w/w, about 1.0% w/w, about 1.25% w/w, about 1.5% w/w, about 2.0% w/w, about 2.5% w/w, about 3% w/w, about 3.5% w/w, about 4% w/w, about 4.5% w/w, about 5.0% w/w, or about 10% w/w benzoin methyl ether. In some embodiments, the polymerization catalyst can comprises about 0.5% w/w benzoin methyl ether. In some embodiments, the polymerization catalyst can comprise about 2.0% w/w benzoin methyl ether. In some embodiments, the monomer-containing material can further comprise a chain-reaction polymerization catalyst. In some embodiments, the monomer-containing material can further comprise a condensation polymerization catalyst. In some embodiments, the monomer-containing material can further comprise a free radical polymerization catalyst. In some embodiments, the monomer-containing material can further comprise a reversible addition fragmentation chain-transfer polymerization catalyst.

### Polymerization

In some embodiments, methods and compositions disclosed herein can be used to prepare a sample for nanohistology. In some embodiments, methods and compositions disclosed herein can be used to prepare a sample for nanohistology, wherein the sample comprises a combination of a fixed and dehydrated sample and a monomer-containing material. In some embodiments, methods and compositions disclosed herein can be used to prepare a sample for nanohistology, wherein the sample comprises a combination of a deparaffinized histology sample and a monomer-containing material. In some embodiments, disclosed herein are methods and compositions for treating the combination of a fixed and dehydrated sample and a monomer-containing material with an agent for polymerization. In some embodiments, disclosed herein are methods and compositions for treating a combination of a fixed and dehydrated sample and a monomer-containing material with an agent for polymerization, wherein the treating results in polymerization of the monomers in the monomer-containing material. In some embodiments, disclosed herein are methods and compositions for treating the combination of a fixed and dehydrated sample and a monomer-containing material with an agent for polymerization, wherein the treating results in polymerization of the monomers in the monomer-containing material, wherein the treating does not result in the cross-linking of biological molecules in the sample. In some embodiments, disclosed herein are methods and compositions for treating the combination of a fixed and dehydrated sample and a monomer-containing material with an agent for polymerization, wherein the treating results in polymerization of the monomers in the monomer-containing material, wherein the treating does not result in the cross-linking of biological molecules in the sample with monomers of the monomer-containing material. In some embodiments, disclosed herein are methods and compositions for treating the combination of a deparaffinized histology sample and a monomer-containing material with an agent for polymerization. In some embodiments, disclosed herein are methods and compositions for treating the combination of a deparaffinized histology sample and a monomer-containing material with an agent for polymerization, wherein the treating results in polymerization of the monomers in the monomer-containing material. In some embodiments, disclosed herein are methods and compositions for treating the combination of a deparaffinized histology sample and a monomer-containing material with an agent for polymerization, wherein the treating results in polymerization of the monomers in the monomer-containing material, wherein the treating does not result in cross-linking of biological molecules in the sample. In some embodiments, disclosed herein are methods and compositions for treating the combination of a deparaffinized histology sample and a monomer-containing material with an agent for polymerization, wherein the treating results in polymerization of the monomers in the monomer-containing material, wherein the treating does not result in cross-linking of biological molecules in the sample with monomers of the monomer-containing material. In some embodiments, the agent for polymerization is agent that polymerizes monomers of the monomer-containing material.

In some embodiments, methods and compositions disclosed herein can be used to prepare a sample for nanohistology. In some embodiments, disclosed herein are methods and compositions for treating the combination of a fixed and dehydrated sample with a monomer-containing material with an agent for polymerization. In some embodiments, disclosed herein are methods and composition for treating the combination of a deparaffinized histology sample and a monomer-containing material with an agent for polymerization. In some embodiments, the agent for polymerization comprises ultraviolet (UV) radiation. In some embodiments, the agent for polymerization comprises UV radiation comprising a wavelength of about 280 nm to about 400 nm. In some embodiments, the agent for polymerization comprises UV radiation comprising a wavelength of about 280 nm, about 285 nm, about 290 nm, about 295 nm, about 300 nm, about 305 nm, about 310 nm, about 315 nm, about 320 nm, about 325 nm, about 330 nm, about 335 nm, about 340 nm, about 345 nm, about 350 nm, about 355 nm, about 360 nm, about 365 nm, about 370 nm, about 375 nm, about 380 nm, about 385 nm, about 390 nm, about 395 nm, or about 400 nm. In some embodiments, the agent for polymerization comprises UV radiation comprising an irradiance of about 1 milliwatt per square centimeter (mW/cm²) to about 50 mW/cm², about 1 mW/cm² to about 100 mW/cm², about 1 mW/cm² to about 200 mW/cm², about 1 mW/cm² to about 300 mW/cm², about 1 mW/cm² to about 400 mW/cm², about 1 mW/cm² to about 500 mW/cm², about 1 mW/cm² to about 600 mW/cm², about 1 mW/cm² to about 700 mW/cm², about 1 mW/cm² to about 800 mW/cm², about 1 mW/cm² to about 900 mW/cm², or about 1 mW/cm² to about 1000 mW/cm².

In some embodiments, methods and compositions disclosed herein can be used to prepare a sample for nanohistology. In some embodiments, disclosed herein are methods and compositions for treating the combination of a fixed and dehydrated sample with a monomer-containing material with an agent for polymerization. In some embodiments, disclosed herein are methods and composition for treating the combination of a deparaffinized histology sample and a monomer-containing material with an agent for polymerization. In some embodiments, the treating comprises treating the combination with UV radiation for about 30 minutes, about 60 minutes, about 90 minutes, about 2 hours, about 3 hours, about 4 hours, about 5 hours, about 6 hours, about 7 hours, about 8 hours, about 9 hours, about 10 hours, about 11 hours, about 12 hours, about 13 hours, about 14 hours, about 15 hours, about 16 hours, about 17 hours, about 18 hours, about 19 hours, about 20 hours, about 21 hours, about 22 hours, about 23 hours, about 24 hours, about 36 hours, about 48 hours, or about 72 hours. In some embodiments, the treating comprises treating the combination with UV radiation for 24 hours. In some embodiments, the treating comprises treating the combination with UV radiation at a temperature of about −50° C., about −45° C., about −40° C., about −35° C., about −30° C., about −25° C., about −20° C., about −15° C., about −10° C., about −5° C., about 0° C., about 5° C., about 10° C., about 15° C., about 20° C., about 25° C., or about 30° C. In some embodiments, the treating comprises treating the combination with UV radiation at ambient pressure. In some embodiments, the treating comprises treating the combination with UV radiation at ambient pressure in a gaseous environment devoid of oxygen. In some embodiments, the gaseous environment devoid of oxygen comprises nitrogen. In some embodiments, the gaseous environment devoid of oxygen comprises carbon dioxide. In some embodiments, the gaseous environment devoid of oxygen comprises inert gases. In some embodiments, the gaseous environment devoid of oxygen comprises argon. In some embodiments, the gaseous environment devoid of oxygen comprises helium.

In some embodiments, treating the combination with an agent for polymerization results in the polymerization of monomers in the monomer-containing material. In some embodiments, the polymerization of the monomer in the monomer-containing material results in cross-linking of the monomers. In some embodiments, the polymerization of the monomers in the monomer-containing material results in selective cross-linking of the monomers. In some embodiments, the polymerization of the monomers in the monomer-containing material results in selective cross-linking of the monomers, wherein the monomers of monomer-containing material minimally cross-link with biological molecules of the sample. In some embodiments, the polymerization of the monomers in the monomer-containing material results in selective cross-linking of the monomers, wherein the monomers of the monomer-containing material do not cross-link with biological molecules of the sample. In some embodiments, the polymerization of the monomers in the monomer-containing material results in the formation of a cross-linked polymer with defined properties. In some embodiments, the polymerization of the monomers in the monomer-containing material results in the formation of a cross-linked polymer with defined hardness. In some embodiments, the polymerization of the monomers in the monomer-containing material results in the formation of a cross-linked polymer with high hardness. In some embodiments, the polymerization of the monomers in the monomer-containing material results in the formation of a cross-linked polymer with high hardness, wherein the hardness of the polymer is as defined by the Young's Modulus. In some embodiments, the polymerization of the monomers in the monomer-containing material results in the formation of a cross-linked polymer with high hardness, wherein the Young's modulus is as measured by a force-distance curve in atomic force microscopy. In some embodiments, the polymerization of the monomers in the monomer-containing material results in the formation of a cross-linked polymer with high hardness, wherein the Young's modulus of the polymer is at least about 1 gigapascal (GPa), at least about 1.5 GPa, at least about 2.0 GPa, at least about 2.5 GPa, at least about 3.0 GPa, at least about 4 GPa, at least about 5 GPa, at least about 10 GPa, at least about 15 GPa, or at least about 20 GPa. In some embodiments, the polymerization of the monomers in the monomer-containing material results in the formation of a cross-linked polymer with high hardness, wherein the hardness of the polymer is as measured by the Rockwell hardness test. In some embodiments, the polymerization of the monomers in the monomer-containing material results in the formation of a cross-linked polymer with high hardness, wherein the hardness of the polymer is as measured by Shore Durometer hardness testing. In some embodiments, the polymerization of the monomers in the monomer-containing material results in the formation of a cross-linked polymer with high hardness, wherein the hardness is sufficient for flat polishing of the polymer surface. In some embodiments, the polymerization of the monomers in the monomer-containing material results in the formation of a cross-linked polymer with high hardness sufficient for flat polishing of the polymer surface, wherein the polishing of the polymer surface results in low nanoscale topography of the polymer surface as measured in atomic force microscopy. In some embodiments, the polymerization of the monomers in the monomer-containing material results in the formation of a cross-linked polymer with high hardness sufficient for flat polishing of the polymer surface, wherein the polishing of the polymer surface results in low root mean square roughness of the polymer surface as measured by atomic force microscopy. In some embodiments, the root mean square roughness of the polymer surface as measured by atomic force microscopy is less than about 10 nm, less than about 9 nm, less than about 8 nm, less than about 7 nm, less than about 6 nm, less than about 5 nm, less than about 4 nm, less than about 3 nm, less than about 2 nm, or less than about 1 nm. In some embodiments, the root mean square roughness of the polymer surface as measured by atomic force microscopy is less than about 10 nm. In some embodiments, the root mean square roughness of the polymer surface as measured by atomic force microscopy is less than about 9 nm. In some embodiments, the root mean square roughness of the polymer surface as measured by atomic force microscopy is less than about 8 nm. In some embodiments, the root mean square roughness of the polymer surface as measured by atomic force microscopy is less than about 7 nm. In some embodiments, the root mean square roughness of the polymer surface as measured by atomic force microscopy is less than about 6 nm. In some embodiments, the root mean square roughness of the polymer surface as measured by atomic force microscopy is less than about 5 nm. In some embodiments, the root mean square roughness of the polymer surface as measured by atomic force microscopy is less than about 4 nm. In some embodiments, the root mean square roughness of the polymer surface as measured by atomic force microscopy is less than about 3 nm. In some embodiments, the root mean square roughness of the polymer surface as measured by atomic force microscopy is less than about 2 nm. In some embodiments, the root mean square roughness of the polymer surface as measured by atomic force microscopy is less than about 1 nm.

In some embodiments, methods and compositions disclosed herein can be used to prepare a sample for nanohistology. In some embodiments, disclosed herein are methods and compositions for treating the combination of a fixed and dehydrated sample with a monomer-containing material with an agent for polymerization, resulting in a polymerized combination. In some embodiments, disclosed herein are methods and compositions for treating the combination of a fixed and dehydrated sample with a monomer-containing material with an agent for polymerization, resulting in a polymerized combination, the combination comprising a polymer-embedded sample. In some embodiments, disclosed herein are methods and composition for treating the combination of a deparaffinized histology sample and a monomer-containing material with an agent for polymerization, resulting in a polymerized combination. In some embodiments, disclosed herein are methods and composition for treating the combination of a deparaffinized histology sample and a monomer-containing material with an agent for polymerization, resulting in a polymerized combination, the combination comprising a polymer-embedded sample.

Combining with Contacting Agents and Removal of Polymer Layer

In some embodiments, methods and compositions disclosed herein can be used to prepare a sample for nanohistology. In some embodiments, methods and compositions disclosed herein can be used to prepare a sample for nanohistology, wherein the sample comprises a polymer-embedded sample. In some embodiments, methods and compositions disclosed herein can be used to prepare a sample for nanohistology, wherein the sample comprises a polymer-embedded fixed and dehydrated sample. In some embodiments, methods and compositions disclosed herein can be used to prepare a sample for nanohistology, wherein the sample comprises a polymer-embedded deparaffinized histology sample. In some embodiments, disclosed herein are methods and compositions for contacting a polymer-embedded sample with a contacting agent. In some embodiments, disclosed herein are methods and compositions for contacting a polymer-embedded sample with a contacting agent with agitation.

In some embodiments, methods and compositions disclosed herein can be used to prepare a sample for nanohistology. In some embodiments, disclosed herein are methods and composition for contacting a polymer-embedded sample with a contacting agent with agitation. In some embodiments, the contacting agent comprises one or more abrasive materials. In some embodiments, the contacting agent comprises a suspension of one or more abrasive materials. In some embodiments, the contacting agent comprises a homogeneous suspension of one or more abrasive materials. In some embodiments, the one or more abrasive materials comprise alumina particles. In some embodiments, the one or more abrasive materials comprise alumina particles, wherein upon the contacting with the polymer-embedded sample, the alumina particles provide strong abrasion. In some embodiments, the one or more abrasive materials comprise colloidal silica. In some embodiments, the one or more abrasive materials comprise colloidal silica with a 60 nm mean particle diameter. In some embodiments, the one or more abrasive materials comprise colloidal silica with a 20 nm mean particle diameter. In some embodiments, the contacting with the contacting agent with agitation can be implemented manually. In some embodiments, the contacting with the contacting agent with agitation can be implemented manually, wherein the manual implementation comprises pressing of the polymer-embedded sample on a rotating polishing pad. In some embodiments, the contacting with the contacting agent with agitation can be implemented manually, wherein the manual implementation comprises pressing of the polymer-embedded sample on a series of rotating polishing pads. In some embodiments, the contacting with the contacting agent with agitation can be implemented automatically. In some embodiments, the contacting with the contacting agent with agitation can be implemented automatically using an automated polishing system. In some embodiments, the contacting with the contacting agent with agitation can be implemented automatically using a commercially available polishing system. In some embodiments, the contacting comprises applying the contacting agent to the polymer-embedded sample with agitation for about 1 minute, about 2 minutes, about 3 minutes, about 4 minutes, about 5 minutes, about 6 minutes, about 7 minutes, about 8 minutes, about 9 minutes, about 10 minutes, about 15 minutes, about 20 minutes, about 25 minutes, or about 30 minutes. In some embodiments, the contacting comprises applying the contacting agent to the polymer-embedded sample with agitation for about 1 minute. In some embodiments, the contacting comprises applying the contacting agent to the polymer-embedded sample with agitation for about 2 minutes. In some embodiments, the contacting comprises applying the contacting agent to the polymer-embedded sample with agitation for about 3 minutes. In some embodiments, the contacting comprises applying the contacting agent to the polymer-embedded sample with agitation for about 4 minutes. In some embodiments, the contacting comprises applying the contacting agent to the polymer-embedded sample with agitation for about 5 minutes. In some embodiments, the contacting comprises applying the contacting agent to the polymer-embedded sample until the polymer-embedded sample displays low, even topography, as assessed by atomic force microscopy.

In some embodiments, the contacting with a contacting agent further comprises rinsing of the polymer-embedded sample. In some embodiments, the contacting with a contacting agent further comprises rinsing of the polymer-embedded sample with organic solvent. In some embodiments, the organic solvent comprises ethanol. In some embodiments, the contacting with a contacting agent further comprises rinsing of the polymer-embedded sample with aqueous solvent. In some embodiments, the aqueous solvent comprises distilled water. In some embodiments, the aqueous solvent comprises distilled water with a pH of about 1, about 2, about 3, about 4, about 5, about 6, about 7, about 8, about 9, about 10, about 11, about 12, about 13, or about 14. In some embodiments, the aqueous solvent comprises distilled water and a detergent. In some embodiments, the aqueous solvent comprises distilled water and a detergent, wherein the pH of the distilled water and detergent solution is about 1, about 2, about 3, about 4, about 5, about 6, about 7, about 8, about 9, about 10, about 11, about 12, about 13, or about 14. In some embodiments, the rinsing of the polymer-embedded sample results in removal of debris from the surface the polymer-embedded sample. In some embodiments, the rinsing of the polymer-embedded sample results in removal of debris from the surface of the polymer-embedded sample without disrupting the polymer or the sample. In some embodiments, the rinsing of the polymer-embedded sample results in removal of debris from the surface of the polymer-embedded sample without disrupting the polymer or the sample, wherein the disruption to the polymer or the sample is as assessed by atomic force microscopy. In some embodiments, the rinsing of the polymer-embedded sample results in removal of debris from the surface of the polymer-embedded sample with disrupting the polymer or the sample, wherein the debris comprises polymer fragments and remnants of the contacting agent following the contacting.

In some embodiments, methods and compositions disclosed herein can be used to prepare a sample for nanohistology. In some embodiments, disclosed herein are methods and composition for contacting a polymer-embedded sample with a contacting agent with agitation. In some embodiments, the contacting agent comprises gas plasma. In some embodiments, the contacting agent comprises gas plasma generated following application of a radiofrequency to a gas. In some embodiments, the gas comprises air. In some embodiments, the gas comprises argon. In some embodiments, the gas comprises a mixture of air and argon. In some embodiments, the gas comprises oxygen. In some embodiments, the gas comprises fluorine. In some embodiments, the gas comprises carbon tetrafluoride. In some embodiments, the gas comprises ammonia. In some embodiments, the gas comprises nitrogen. In some embodiments, the gas comprises chlorine. In some embodiments, the gas comprises boron trifluoride. In some embodiments, the gas comprises hydrogen bromide. In some embodiments, the gas comprises sulfur hexafluoride. In some embodiments, the gas comprises fluoroform. In some embodiments, the gas comprises octafluorocyclobutane. In some embodiments, contacting with the gas plasma comprises: i) placing of the polymer-embedded sample in a vacuum chamber; ii) establishing a vacuum pressure of about 300 torr in the chamber; iii) providing a gas; iv) applying a radiofrequency to the provided gas, thereby generating gas plasma; and v) applying the gas plasma to the sample. In some embodiments, application of the gas plasma to the sample results in removal of debris from the surface of the polymer-embedded sample. In some embodiments, application of the gas plasma to the sample results in removal of debris from the surface of the polymer-embedded sample, wherein the debris comprises contaminants and polymer fragments. In some embodiments, the contacting comprises applying the gas plasma to the sample for about 10 seconds, about 20 seconds, about 30 seconds, about 40 seconds, about 50 seconds, about 60 seconds, about 70 seconds, about 80 seconds, about 90 seconds, about 100 seconds, about 110 seconds, about 120 seconds, about 150 seconds, about 180 seconds, about 4 minutes, or about 5 minutes. In some embodiments, the contacting comprises applying the gas plasma to the sample for about 2 minutes.

In some embodiments, methods and compositions disclosed herein can be used to prepare a sample for nanohistology. In some embodiments, disclosed herein are methods and composition for contacting a polymer-embedded sample with a contacting agent with agitation. In some embodiments, disclosed herein are methods and compositions for contacting a polymer-embedded sample with a contacting agent with agitation, wherein the contacting results in a polymer-embedded sample comprising a flat surface. In some embodiments, disclosed herein are methods and compositions for contacting a polymer-embedded sample with a contacting agent with agitation, wherein the contacting results in a polymer-embedded sample comprising a flat surface, wherein the topography of the surface is assessed by atomic force microscopy. In some embodiments, the surface of the polymer-embedded sample comprises a topography no greater than about 500 nm, no greater than about 475 nm, no greater than about 450 nm, no greater than about 425 nm, no greater than about 400 nm, no greater than about 375 nm, no greater than about 350 nm, no greater than about 325 nm, no greater than about 300 nm, no greater than about 275 nm, no greater than about 250 nm, no greater than about 225 nm, no greater than about 200 nm, no greater than about 175 nm, no greater than about 150 nm, no greater than about 125 nm, no greater than about 100 nm, no greater than about 75 nm, no greater than about 50 nm, no greater than about 25 nm, or no greater than about 10 nm, wherein the topography of the surface is as measured by atomic force microscopy. In some embodiments, the surface of the polymer-embedded sample comprises a topography no greater than about 300 nm, wherein the topography of the surface is as measured by atomic force microscopy. In some embodiments, the surface of the polymer-embedded sample comprises a topography no greater than about 200 nm. In some embodiments, the surface of the polymer-embedded sample comprises a topography no greater than about 100 nm. In some embodiments, the surface of the polymer-embedded sample comprises a topography no greater than about 50 nm. In some embodiments, the surface of the polymer-embedded sample comprises a topography no greater than about 10 nm. In some embodiments, disclosed herein are methods and compositions for contacting a polymer-embedded sample with a contacting agent with agitation, wherein the contacting results in a polymer-embedded sample comprising a flat surface, wherein the topography of the sample is assessed by atomic force microscopy. In some embodiments, the sample comprises a topography of about 200 nm, about 195 nm, about 190 nm, about 185 nm, about 180 nm, about 175 nm, about 170 nm, about 165 nm, about 160 nm, about 155 nm, about 150 nm, about 145 nm, about 140 nm, about 135 nm, about 130 nm, about 125 nm, about 120 nm, about 115 nm about 110 nm, about 105 nm, or about 100 nm, wherein the topography of the sample is as measured by atomic force microscopy. In some embodiments, disclosed herein are methods and compositions for contacting a polymer-embedded sample with a contacting agent with agitation, wherein the contacting results in a polymer-embedded sample comprising a flat surface, wherein the topography of the polymer is assessed by atomic force microscopy. In some embodiments, the polymer comprises a topography of no greater than about 5 nm, no greater than about 4.5 nm, no greater than about 4.0 nm, no greater than about 3.5 nm, no greater than about 3.0 nm, no greater than about 2.5 nm, no greater than about 2.0 nm, no greater than about 1.5 nm, no greater than about 1.0 nm, no greater than about 0.5 nm, no greater than about 0.4 nm, no greater than about 0.3 nm, no greater than about 0.2 nm, no greater than about 0.1 nm, or no greater than about 0.05 nm, wherein the topography of the polymer is measured by atomic force microscopy. In some embodiments, the polymer comprises a topography of no greater than about 1 nm, wherein the topography of the polymer is measured by atomic force microscopy. In some embodiments, the polymer comprises a topography similar to the background noise of the sample. In some embodiments, the polymer comprises a topography that does not obscure biological molecules of the sample.

In some embodiments, methods and compositions disclosed herein can be used to prepare a sample for nanohistology. In some embodiments, disclosed herein are methods and compositions for contacting a polymer-embedded sample with a contacting agent with agitation. In some embodiments, disclosed herein are methods and composition for contacting a polymer-embedded sample with a contacting agent with agitation, wherein the contacting removes a layer of the embedding polymer. In some embodiments, disclosed herein are methods and composition for contacting a polymer-embedded sample with a contacting agent with agitation, wherein the contacting evenly removes a layer of the embedding polymer. In some embodiments, disclosed herein are methods and compositions for contacting a polymer-embedded sample with a contacting agent with agitation, wherein the contacting evenly removes a layer of the embedding polymer without damaging the underlying surface of the sample. In some embodiments, disclosed herein are methods and composition for contacting a polymer-embedded sample with a contacting agent with agitation, wherein the contacting evenly removes a layer of the embedding polymer without scratching the underlying surface and damaging the biological molecules of the sample. In some embodiments, the contacting removes a layer of the embedding comprising a thickness of nm, μm, or mm. In some embodiments, the amount of polymer removed can depend on the sample. In some embodiments, the amount of polymer removed can depend on the sample and the biological molecules in the sample.

In some embodiments, the contacting with a contacting agent with agitation results in reproducible fracturing of the polymer. In some embodiments, the contacting with a contacting agent with agitation results in reproducible fracturing of the polymer, wherein the contacting fractures and removes polymer from biological structures of the sample. In some embodiments, reproducible fracturing of the polymer occurs when polymer surface comprises a topography at or below about 300 nm, at or below about 275 nm, at or below about 250 nm, at or below about 225 nm, at or below about 200 nm, at or below about 175 nm, at or below about 150 nm, at or below about 125 nm, or at or below about 100 nm, wherein the topography of the surface is measured by atomic force microscopy. In some embodiments, reproducible fracturing of the polymer occurs when polymer surface comprises a topography at or below about 300 nm, wherein the topography of the surface is measured by atomic force microscopy. In some embodiments, the contacting with a contacting agent with agitation results in reproducible fracturing of the polymer, wherein the fracturing is as assessed by comparing the visibility of the structures under atomic force microscopy with transmission electron microscopy. In some embodiments, the contacting with a contacting agent with agitation results in removal of the polymer from the underlying biological sample. In some embodiments, the contacting with a contacting agent with agitation results in removal of the polymer from the underlying biological sample, wherein fragments of the polymer obscure visibility of the biological structures in atomic force microscopy. In some embodiments, the removal of polymer from the underlying biological sample can be measured by assessing the visibility of biological structures when imaged by atomic force microscopy. In some embodiments, the removal of polymer from the underlying biological sample can be measured by assessing the visibility of biological structures when imaged by atomic force microscopy, wherein the number of polymer fragments per square micron (fragments/μm²) is no greater than about 10 fragments/μm², no greater than about 9 fragments/μm², no greater than about 8 fragments/μm², no greater than about 7 fragments/μm², no greater than about 6 fragments/μm², no greater than about 5 fragments/μm², no greater than about 4 fragments/μm², no greater than about 3 fragments/μm², no greater than about 2 fragments/μm², or no greater than about 1 fragments/μm². In some embodiments, the removal of polymer from the underlying biological sample can be measured by assessing the visibility of biological structures when imaged by atomic force microscopy, wherein the number of polymer fragments per square micron is no greater than about 1 fragments/μm². In some embodiments, the removal of polymer and contacting agent from the underlying biological sample can be measured by assessing the visibility of biological structures when imaged by atomic force microscopy, wherein the number of polymer fragments and contacting agent particles per square micron (fragments/μm²) is no greater than about 10 fragments/μm², no greater than about 9 fragments/μm², no greater than about 8 fragments/μm², no greater than about 7 fragments/μm², no greater than about 6 fragments/μm², no greater than about 5 fragments/μm², no greater than about 4 fragments/μm², no greater than about 3 fragments/μm², no greater than about 2 fragments/μm², or no greater than about 1 fragments/μm². In some embodiments, the removal of polymer and contacting agent from the underlying biological sample can be measured by assessing the visibility of biological structures when imaged by atomic force microscopy, wherein the number of polymer fragments and contacting agents per square micron is no greater than about 1 fragments/μm².

In some embodiments, disclosed herein are methods and compositions for contacting a polymer-embedded sample with a contacting agent with agitation. In some embodiments, disclosed herein are methods and compositions for contacting a polymer-embedded sample with a contacting agent with agitation, wherein the contacting results in a polymerized, embedded sample with an exposed surface. In some embodiments, disclosed herein are methods and compositions for contacting a polymer-embedded sample with a contacting agent with agitation, wherein the contacting results in a polymerized, embedded sample with an exposed surface, wherein the polymerized sample retains the contour of the sample. In some embodiments, disclosed herein are methods and compositions for contacting a polymer-embedded sample with a contacting agent with agitation, wherein the contacting results in a polymerized, embedded sample with an exposed surface, wherein the polymerized sample retains the surface of the sample. In some embodiments, disclosed herein are methods and compositions for contacting a polymer-embedded sample with a contacting agent with agitation, wherein the contacting results in a polymerized, embedded sample with an exposed surface, wherein the polymerized sample retains the contour and surface of the sample.

### Imaging

In some embodiments, methods and compositions disclosed herein can be used to prepare a sample for nanohistology. In some embodiments, the methods further comprises imaging of the sample. In some embodiments, the methods further comprise imaging of the polymerized, embedded sample with an exposed surface. In some embodiments, the imaging modality comprises atomic force microscopy (AFM). In some embodiments, the imaging modality comprises AFM, the AFM procedure comprising: i) mounting the sample with the exposed surface up; ii) identifying the region of interest in the sample using video microscopy; iii) approaching the tip of the atomic force microscopy to the exposed surface of the sample; and iv) scanning of the identified area of interest in the sample. In some embodiments, the probe of the atomic force microscope comprises a tip with a 4-sided pyramidal shape. In some embodiments, the probe of the atomic force microscope comprises a tip with a 3-sided pyramidal shape. In some embodiments, the probe of the atomic force microscope comprises a tip with a plateau shape. In some embodiments, the probe of the atomic force microscope comprises a tip with a rounded shape. In some embodiments, the probe of the atomic force microscope comprises a tip with a spherical shape. In some embodiments, the probe of the atomic force microscope comprises a tip comprising silicon. In some embodiments, the probe of the atomic force microscope comprises a tip comprising silicon nitride. In some embodiments, the probe of the atomic force microscope comprises a tip comprising silicon oxide. In some embodiments, the probe of the atomic force microscope comprises a tip comprising high density carbon. In some embodiments, the probe of the atomic force microscope comprises a tip comprising quartz. In some embodiments, the probe of the atomic force microscope comprises a tip comprising a quartz-like material. In some embodiments, the probe of the atomic force microscope comprises an uncoated tip. In some embodiments, the probe of the atomic force microscope comprises a gold-coated tip. In some embodiments, the probe of the atomic force microscope comprises a platinum-coated tip. In some embodiments, the probe of the atomic force microscope comprises a platinum and iridium-coated tip. In some embodiments, the probe of the atomic force microscope comprises a diamond-like-carbon-coated tip. In some embodiments, the probe of the atomic force microscope comprises a diamond-coated tip. In some embodiments, the probe of the atomic force microscope comprises a conductive diamond-coated tip. In some embodiments, the probe of the atomic force microscope comprises a cobalt alloy-coated tip. In some embodiments, the probe of the atomic force microscope comprises a silicon nitride-coated tip. In some embodiments, the probe of the atomic force microscope comprises a silicide-coated tip. In some embodiments, the probe of the atomic force microscope comprises a tip with a dimeter of about 5 nm, about 6 nm, about 7 nm, about 8 nm, about 9 nm, about 10 nm, about 11 nm, about 12 nm, about 13 nm, about 14 nm, about 15 nm, about 16 nm, about 17 nm, about 18 nm, about 19 nm, or about 20 nm. In some embodiments, the probe of the atomic force microscope comprises a tip with a diameter of about 10 nm. In some embodiments, the probe of the atomic force microscope comprises a tip with a diameter of about 11 nm. In some embodiments, the probe of the atomic force microscope comprises a tip with a diameter of about 12 nm. In some embodiments, the probe of the atomic force microscope comprises a tip with a diameter of about 13 nm. In some embodiments, the probe of the atomic force microscope comprises a tip with a diameter of about 14 nm. In some embodiments, the probe of the atomic force microscope comprises a tip with a diameter of about 15 nm. In some embodiments, the probe of the atomic force microscope comprises a tip with a resolution of about 1 nm, about 2 nm, about 3 nm, about 4 nm, about 5 nm, about 6 nm, about 7 nm, about 8 nm, about 9 nm, or about 10 nm. In some embodiments, the probe of the atomic force microscope comprises a tip with a resolution of about 2 nm. In some embodiments, the probe of the atomic force microscope comprises a tip with a resolution of about 3 nm. In some embodiments, the probe of the atomic force microscope comprises a tip with a resolution of about 4 nm. In some embodiments, the probe of the atomic force microscope comprises a tip with a resolution of about 5 nm.

In some embodiments, the probe of the atomic force microscope comprises a single beam cantilever. In some embodiments, the probe of the atomic force microscope comprises a double beam cantilever. In some embodiments, the probe of the atomic force comprises a rectangular cantilever. In some embodiments, the probe of the atomic force microscope comprises a triangular cantilever. In some embodiments, the probe of the atomic force microscope comprises a cantilever with a rectangular cross section. In some embodiments, the probe of the atomic force microscope comprises a cantilever with a trapezoidal cross section. In some embodiments, the probe of the atomic force microscope comprises a cantilever with a trapezoidal cross section, wherein the tip is located on the narrow flank. In some embodiments, the probe of the atomic force microscope comprises a cantilever with a trapezoidal cross section, wherein the tip is located on the wide flank. In some embodiments, the probe of the atomic force microscope comprises a cantilever with a trapezoidal cross section with curved sides. In some embodiments, the probe of the atomic force microscope comprises one or more cantilevers. In some embodiments, the probe of the atomic force comprises 1 cantilever. In some embodiments, the probe of the atomic force comprises 2 cantilevers. In some embodiments, the probe of the atomic force comprises 2 cantilevers, wherein the cantilevers are located on one side of the probe. In some embodiments, the probe of the atomic force comprises 3 cantilevers. In some embodiments, the probe of the atomic force comprises 3 cantilevers, wherein the cantilevers are located on one side of the probe. In some embodiments, the probe of the atomic force comprises 4 cantilevers. In some embodiments, the probe of the atomic force comprises 4 cantilevers, wherein the cantilevers are located on one side of the probe. In some embodiments, the probe of the atomic force comprises 4 cantilevers, wherein 2 cantilevers are located on each side of the probe. In some embodiments, the probe of the atomic force microscope comprises 8 cantilevers. In some embodiments, the probe of the atomic force comprises 8 cantilevers, wherein the cantilevers are located on one side of the probe. In some embodiments, the cantilever of the atomic force microscope probe comprises silicon. In some embodiments, the cantilever of the atomic force microscope probe comprises silicon nitride. In some embodiments, the cantilever of the atomic force microscope probe comprises a quartz-like material. In some embodiments, the cantilever of the atomic force microscope comprises a coating. In some embodiments, the coating of the cantilever comprises aluminum. In some embodiments, the coating of the cantilever comprises aluminum, wherein the back side of the cantilever is coated. In some embodiments, the coating of the cantilever comprises gold. In some embodiments, the coating of the cantilever comprises gold, wherein the top side of the cantilever is coated. In some embodiments, the coating of the cantilever comprises gold, wherein the back side of the cantilever is coated. In some embodiments, the coating of the cantilever comprises platinum. In some embodiments, the coating of the cantilever comprises platinum and iridium. In some embodiments, the coating of the cantilever comprises conductive diamond. In some embodiments, the coating of the cantilever comprises silicide.

In some embodiments, the imaging modality comprises AFM. In some embodiments the imaging modality comprises AFM in static mode. In some embodiments, the imaging modality comprises AFM in tapping mode. In some embodiments, the imaging modality comprises AFM in non-contact mode. In some embodiments, the image acquisition time in AFM is dependent on the scan speed, and number of points per line in the scan. In some embodiments, the scan speed comprises about 1 Hz, about 2 Hz, about 3 Hz, about 4 Hz, about 5 Hz, about 6 Hz, about 7 Hz, about 8 Hz, about 9 Hz, or about 10 Hz. In some embodiments, the scan speed comprises 1 Hz. In some embodiments, the number of points per line comprises about 100 lines, about 200 lines, about 300 lines, about 400 lines, about 500 lines, about 600 lines, about 700 lines, about 800 lines, about 900 lines, about 1000 lines, about 1100 lines, about 1200 lines, about 1300 lines, about 1400 lines, about 1500 lines, about 2000 lines, about 5000 lines, or about 10000 lines. In some embodiments, the number of points per line comprises about 1000 lines. In some embodiments, the atomic force microscope scans in the x, y, and z directions. In some embodiments, the atomic force microscope scans in the x,y direction with a maximum scan size of 50×50 μm. In some embodiments, the atomic force microscope scans in the x,y direction with a maximum scan size of 100×100 μm. In some embodiments, the atomic force microscope scans in the x,y direction with a maximum scan size of 150×150 μm. In some embodiments, the atomic force microscope scans in the x,y direction with a scan size of 500×500 nm. In some embodiments, the atomic force microscope scans in the z direction with a maximum scan size of 10 μm. In some embodiments, the atomic force microscope scans in the z direction with a maximum scan size of 17 μm. In some embodiments, the atomic force microscope scans in the z direction with a maximum scan size of 40 μm. In some embodiments, the polymerized, embedded sample is imaged by AFM and the phase shift of the sample is recorded. In some embodiments, the polymerized, embedded sample is imaged by AFM and the phase shift of the sample is recorded, wherein the phase shift is correlated with the stiffness of the sample. In some embodiments, the polymerized, embedded sample is imaged by AFM and the topography of the sample is recorded. In some embodiments, the polymerized, embedded sample is imaged by AFM and the phase shift and topography of the sample is recorded.

In some embodiments, AFM can be implemented with an additional imaging modality. In some embodiments, AFM can be implemented with an additional imaging modality, wherein the additional imaging modality comprises brightfield microscopy. In some embodiments, AFM can be implemented with an additional imaging modality, wherein the additional imaging modality comprises inverted light microscopy. In some embodiments, AFM can be implemented with brightfield microscopy for targeted imaging of a sample, wherein the AFM probe and sample are imaged with a brightfield image, and the probe positioned over the region of interest prior to beginning scanning in AFM. In some embodiments, AFM can be implemented with an additional imaging modality, wherein the additional imaging modality comprises mass spectrometry. In some embodiments, AFM can be implemented with an additional imaging modality, wherein the additional imaging modality comprises MALDI time-of-flight mass spectrometry. In some embodiments, AFM can be implemented with an additional imaging modality, wherein the additional imaging modality comprises phase contrast microscopy. In some embodiments, AFM can be implemented with an imaging modality, wherein the additional imaging modality comprises phase contrast microscopy with histological dyes. In some embodiments, AFM can be implemented with an additional imaging modality, wherein the additional imaging modality comprises phase contrast microscopy with histological dyes, wherein the histological dyes can be introduced to the sample prior to the combining with the monomer-containing material. In some embodiments, AFM can be implemented with an additional imaging modality, wherein the additional imaging modality comprises fluorescence microscopy. In some embodiments, AFM can be implemented with an additional imaging modality, wherein the additional imaging modality comprises fluorescence microscopy with fluorescent dyes, wherein the fluorescent dyes can be introduced to the sample prior to the combining with the monomer-containing material. In some embodiments, AFM can be implemented with an additional imaging modality, wherein the additional imaging modality comprises fluorescence microscopy with fluorescent tags, wherein the fluorescent tags can be introduced to the sample prior to the combining with the monomer-containing material. In some embodiments, AFM can be implemented with an additional imaging modality, wherein the additional imaging modality comprises fluorescence microscopy with fluorescent antibodies, wherein the fluorescent antibodies are introduced to the sample after the combining with the contacting agent with agitation.

### Analysis and Applications

In some embodiments, methods and compositions disclosed herein to prepare a sample for nanohistology can be implemented in an automated workflow. In some embodiments, methods and compositions disclosed herein to prepare a sample for nanohistology can be implemented in an automated workflow in high-throughput. In some embodiments, methods and compositions disclosed herein to prepare multiple samples for nanohistology can be implemented in an automated workflow in high-throughput. In some embodiments, methods and compositions disclosed herein to prepare multiple samples for nanohistology can be implemented in an automated workflow in high-throughput, wherein the multiple samples are processed in parallel. In some embodiments, the fixing is automated. In some embodiments, the deparaffinizing of a histological sample is automated. In some embodiments, the dehydrating is automated. In some embodiments, the combining with an agent comprising a monomer-containing material is automated. In some embodiments, the treating with an agent for polymerization of the monomer-containing material is automated. In some embodiments, the contacting with a contacting agent with agitation is automated. In some embodiments, the removing of the polymerized monomer-containing material is automated. In some embodiments, the imaging of the sample is automated. In some embodiments, all steps of the sample preparation are automated.

In some embodiments, methods and compositions disclosed herein can be used to prepare a sample for nanohistology. In some embodiments, methods and compositions disclosed herein can be used for tissue biology applications. In some embodiments, methods and compositions disclosed herein can be used for tissue analysis. In some embodiments, methods and compositions disclosed herein can be used for cell biology applications. In some embodiments, methods and compositions disclosed herein can be used for cellular analysis. In some embodiments, methods and compositions disclosed herein can be used for microbiology applications. In some embodiments, methods and compositions disclosed herein can be used for virology applications. In some embodiments, methods and compositions disclosed herein can be used for diagnostics applications. In some embodiments, methods and compositions disclosed herein can be used for human diagnostics applications. In some embodiments, methods and compositions disclosed herein can be used for pathology applications. In some embodiments, methods and compositions disclosed herein can be used for histology applications. In some embodiments, methods and compositions disclosed herein can be used to analyze cellular morphology in a prepared sample. In some embodiments, methods and compositions disclosed herein can be used to analyze cellular structure in a prepared sample. In some embodiments, methods and compositions disclosed herein can be used to analyze tissue morphology in a prepared sample. In some embodiments, methods and compositions disclosed herein can be used to analyze tissue structure in a prepared sample. In some embodiments, methods and compositions disclosed herein can be used to analyze the structure of biological molecules in a prepared sample. In some embodiments, methods and compositions disclosed herein can be used to analyze the structure of biological molecules in a prepared sample, wherein the methods and compositions further comprise antibodies. In some embodiments, methods and compositions disclosed herein can be used to analyze the structure of biological molecules in a prepared sample, wherein the methods and compositions further comprise tags. In some embodiments, methods and compositions disclosed herein can be used to analyze the structure of biological molecules in a prepared sample, wherein the methods and compositions further comprise dyes.

In some embodiments, methods and compositions disclosed herein can be used for serial analysis of a sample. In some embodiments, methods and compositions disclosed herein can be used for serial imaging of a sample. In some embodiments, methods and compositions disclosed herein can be used for serial imaging of a sample, wherein the serial imaging comprises sequential imaging of the exposed surface of a sample. In some embodiments, methods and compositions disclosed herein can be used for serial imaging of a sample, wherein the serial imaging comprises sequential imaging of the exposed surface of a sample across the z plane of the sample. In some embodiments, methods and compositions disclosed herein can be used for serial imaging of a sample, wherein the serial imaging comprises sequential imaging of the exposed surface of a sample across the z plane of the sample with the x,y plane fixed. In some embodiments, serial imaging of a sample comprises: i) preparing the sample for nanohistology according to the methods and compositions disclosed herein; ii) imaging of the sample; iii) contacting the sample with a contacting agent with agitation; iv) removing polymerized monomer-containing material from the surface of the sample; and v) imaging of the sample; vi) optionally repeating the contacting, removing, and imaging steps across the z plane of the sample. In some embodiments, changes in the z plane of the sample can be measured following the contacting, removing, and imaging steps. In some embodiments, changes in the z plane of the sample can be measured by measuring the advance of a polishing head on an automated polishing system. In some embodiments, serial imaging of a sample generates a three-dimensional (3D) dataset of the sample. In some embodiments, serial imaging of a sample generates a 3D dataset of the sample, wherein cellular morphology of a sample can be assessed in 3D. In some embodiments, serial imaging of a sample generates a 3D-dataset of the sample, wherein cellular structure of a sample can be assessed in 3D. In some embodiments, serial imaging of a sample generates a 3D-dataset of the sample, wherein tissue morphology of a sample can be assessed in 3D. In some embodiments, serial imaging of a sample generates a 3D-dataset of the sample, wherein tissue structure of a sample can be assessed in 3D. In some embodiments, serial imaging of a sample generates a 3D-dataset of the sample, wherein the structure of a biological molecule in a sample can be assessed in 3D. In some embodiments, serial imaging of a sample generates a 3D-dataset of the sample, wherein the structures of biologicals molecule in a sample can be assessed in 3D.

In some embodiments, methods and compositions disclosed herein can be integrated with a machine learning algorithm. In some embodiments, methods and compositions disclosed herein can be integrated with an artificial intelligence (AI) model. In some embodiments, the integration can correlate brightfield and fluorescence microscopy images with AFM. In some embodiments, the integration can correlate brightfield and fluorescence microscopy images with AFM to automate imaging of a sample. For example, following identification of a region of interest in a brightfield or fluorescence microscopy image, machine learning algorithms or AI correlate the region of interest to a location in an overview AFM image and guides the AFM probe to the location. In some embodiments, the integration can be used to automate identification of ultrastructural features in a sample. In some embodiments, the integration can be used to automate identification of diagnostically relevant ultrastructural features in a sample. In some embodiments, machine learning and AI can be used to analyze an AFM imagine and predict a disease state based on structural and ultrastructural features in the sample. In some embodiments, machine learning and artificial intelligence can be used to acquire large datasets of AFM data. In some embodiments, machine learning and artificial intelligence can be used to analyze large datasets of AFM data. In some embodiments, the size of the AFM datasets can depend on the number of analyses run in parallel.

### EXAMPLES

### Example 1: Nanohistology Sample Preparation Procedure

A sample can be prepared for nanohistology application, the sample preparation comprising a series of steps resulting in a polymerized, embedded sample with exposed surface suitable for imaging with atomic force microscopy (AFM).

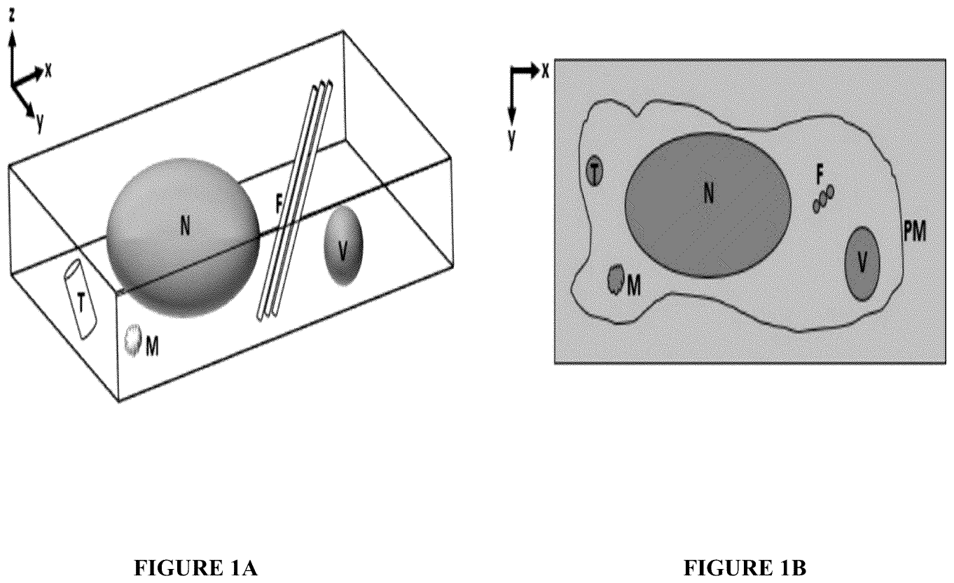

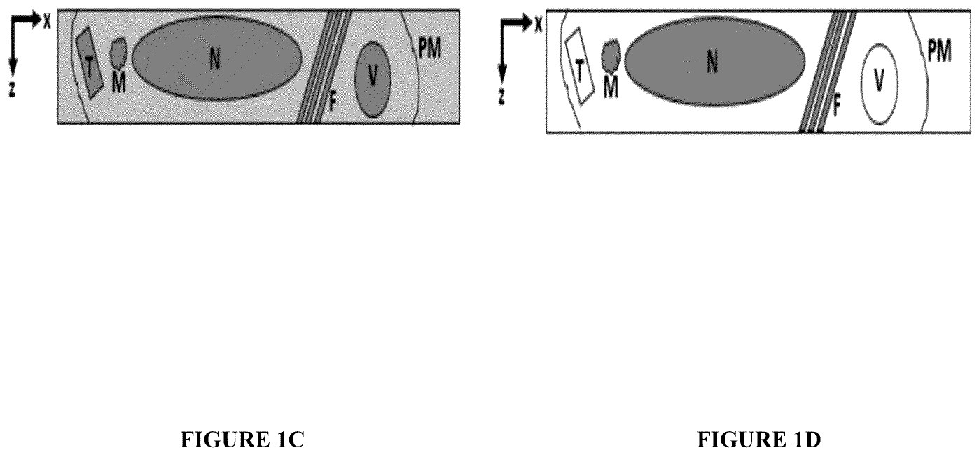

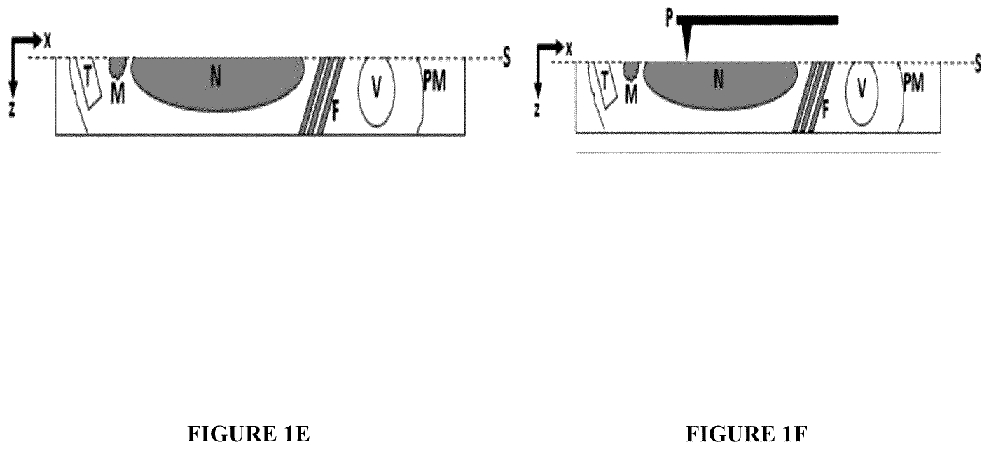

FIG. 1A shows a schematic of a cell as a representative biological specimen. The cell is shown in a three-dimensional view with internal nanoscale and microscale structures visible, including the cell nucleus (N), tubular structures (T), macronuclear structures (M), filamentous structures (F), and vesicular structures (V). FIG. 1B shows a top view (x,y) of the cell with the cellular structures surrounded by a plasma membrane. FIG. 1C shows a side view (x,z) of the cell. The sample is fixed, dehydrated, and combined with a monomer-containing material to obtain a sample embedded with the monomer-containing material. Following polymerization with UV radiation, the polymer embedded sample is then contacted with a contacting agent and the polymer removed from the surface of the sample, exposing the nanostructures and microstructures of the sample. FIG. 1D shows a side view of the cell embedded in a polymer block with the surface(S) exposed, visible are cross-sections of nanoscale and microscale structures exposed at the surface of the sample. The sample is then imaged with atomic force microscopy and the exposed surface scanned with the AFM probe. FIG. 1E shows the surface of the cell with the AFM probe (P) scanning the sample across the x,y plane with topography and phase shift of the sample measured. Following the imaging, the data is processed and analyzed to generate an AFM of the sample.

### Example 2: Monomer-Containing Material Compositions

Compositions of monomer-containing materials disclosed herein usable for embedding a sample, wherein upon polymerization, the monomer-containing material can form a polymer that reproducibly fractures, exposing the surface of biological molecules in the sample.

Monomer-containing material compositions comprising one or more thermosetting or thermoplastic monomers are prepared. TABLE 1 shows compositions of monomer-containing materials with different monomer compositions and amounts.

TABLE 1

| | | | | | Polymerization | Total |
|---|---|---|---|---|---|---|
| Monomer 1 | Monomer 2 | Monomer 3 | Monomer 4 | Monomer 5 | catalyst | mass |
| 10 g methyl | — | — | — | — | 50 mg benzoin | 10.05 g |
| methacrylate | | | | | methyl ether | |
| 5 g methyl | 5 g n-butyl | — | — | — | 50 mg benzoin | 10.05 g |
| methacrylate | methacrylate | | | | methyl ether | |
| 5 g methyl | 5 g n-butyl | — | — | — | 200 mg benzoin | 10.20 g |
| methacrylate | methacrylate | | | | methyl ether | |
| 8 g methyl | 1 g n-butyl | 1 g diallyl | — | — | 50 mg benzoin | 10.05 g |
| methacrylate | methacrylate | phthalate | | | methyl ether | |
| 8 g methyl | 1 g n-butyl | 1 g | — | — | 50 mg benzoin | 10.05 g |
| methacrylate | methacrylate | trimethylolpropane | | | methyl ether | |
| | | trimethacrylate | | | | |
| 10 g ethyl | — | — | — | — | 50 mg benzoin | 10.05 g |
| methacrylate | | | | | methyl ether | |
| 9 g methyl | 1 g ethylene | — | — | — | 50 mg benzoin | 10.05 g |
| methacrylate | glycol | | | | methyl ether | |
| | dimethacrylate | | | | | |
| 5 g ethyl | 5 g ethylene | — | — | — | 50 mg benzoin | 10.20 g |
| methacrylate | glycol | | | | methyl ether | |
| | dimethacrylate | | | | | |
| 5 g ethyl | 5 g ethylene | — | — | — | 200 mg benzoin | 10.20 g |
| methacrylate | glycol | | | | methyl ether | |
| | dimethacrylate | | | | | |
| 8 g ethyl | 2 g ethylene | — | — | — | 50 mg benzoin | 10.50 g |
| methacrylate | glycol | | | | methyl ether | |
| | dimethacrylate | | | | | |
| 8 g ethyl | 2 g ethylene | — | — | — | 200 mg benzoin | 10.20 g |
| methacrylate | glycol | | | | methyl ether | |
| | dimethacrylate | | | | | |
| 2.5 g methyl | 2.5 g ethyl | 5 g ethylene | — | — | 50 mg benzoin | 10.05 g |
| methacrylate | methacrylate | glycol | | | methyl ether | |
| | | dimethacrylate | | | | |
| 4 g ethyl | 4 g n-butyl | 2 g ethylene | — | — | 50 mg benzoin | 10.05 g |
| methacrylate | methacrylate | glycol | | | methyl ether | |
| | | dimethacrylate | | | | |
| 4 g methyl | 4 g ethyl | 2 g | — | — | 50 mg benzoin | 10.05 g |
| methacrylate | methacrylate | trimethylolpropane | | | methyl ether | |
| | | trimethyacrylate | | | | |
| 9 g ethyl | 1 g ethylene | — | — | — | 50 mg benzoin | 10.05 g |
| methacrylate | glycol | | | | methyl ether | |
| | dimethacrylate | | | | | |
| 2 g methyl | 2 g ethyl | 2 g | 2 g ethylene | 2 g n-butyl | 50 mg benzoin | 10.05 g |
| methacrylate | methacrylate | trimethylolpropane | glycol | methacrylate | methyl ether | |
| | | trimethacrylate | dimethacrylate | | | |
| 4 g methyl | 4 g ethyl | 2 g ethylene | — | — | 50 mg benzoin | 10.05 g |
| methacrylate | methacrylate | glycol | | | methyl ether | |
| | | dimethacrylate | | | | |

### Example 3: Nanohistology of Mouse Kidney with Monomer-Containing Material A

A mouse kidney tissue was obtained and the sample prepared and imaged for nanohistology.

Following the obtaining, the mouse kidney sample was first fixed in formaldehyde at room temperature for two hours and stored at 4° C. Following the fixation, the sample was rinsed, and cryoprotected in 2.3M of sucrose at 4° C. for 2 hours followed by freezing in liquid nitrogen for 5 seconds, until frozen. The mouse kidney sample was then dehydrated by freeze substitution in methanol containing 10% water, the freeze substitution protocol comprising a warming from −90° C. to −10° C. over 20 hours, washed with methanol containing 10% water. After dehydration, the sample was immersed in increasing concentrations of monomer-containing material comprising 9 g ethyl methacrylate, 1 g ethylene glycol dimethacrylate, and 50 mg benzoin methyl ether in methanol (25% v/v, 50% v/v, 75% v/v) at −10° C. for 2 hours each step. The sample was then immersed in three changes of pure monomer-containing material for 1.5 hours, 24 hours, and 8 hours at −10° C. The sample was then treated with UV radiation at −10° C. for 24 hours under inert nitrogen gas. Following treatment with UV radiation, the sample was contacted with a contacting agent comprising alumina with diameter of 50 nm for 3 minutes, colloidal silica with diameter of 60 nm for 5 minutes, colloidal silica with diameter of 20 nm for 5 minutes at room temperature, resulting in removal of the polymer from the surface of the sample. The sample was then rinsed in distilled water for 2 minutes and plasma cleaned for 2 minutes. The sample was then imaged with atomic force microscopy in tapping mode, with the AFM probe comprising a pyramidal tip silicon cantilever with a 6 nm radius of curvature, nominal spring constant of 58 N/m and nominal frequency of 190 kHz. The sample was imaged by AFM with a scan speed of 1 Hz and a total number of 512 lines for a total image acquisition time of approximately 8 minutes.

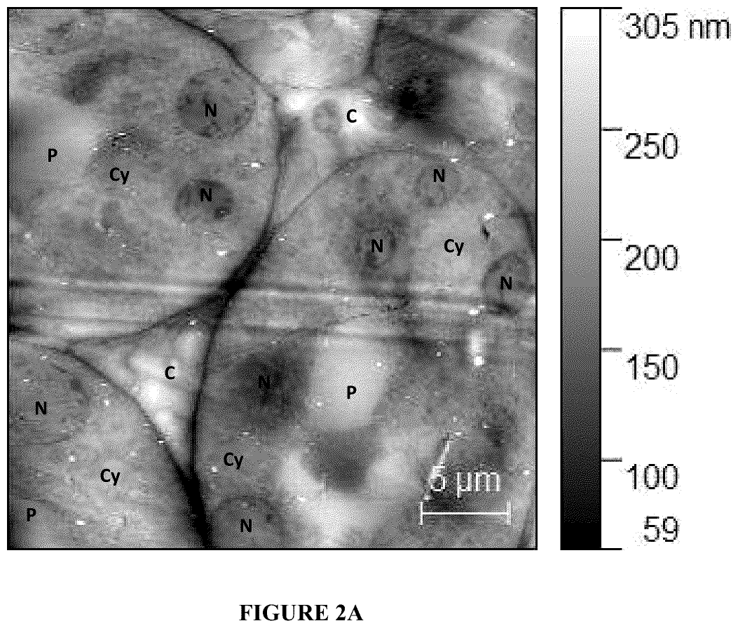

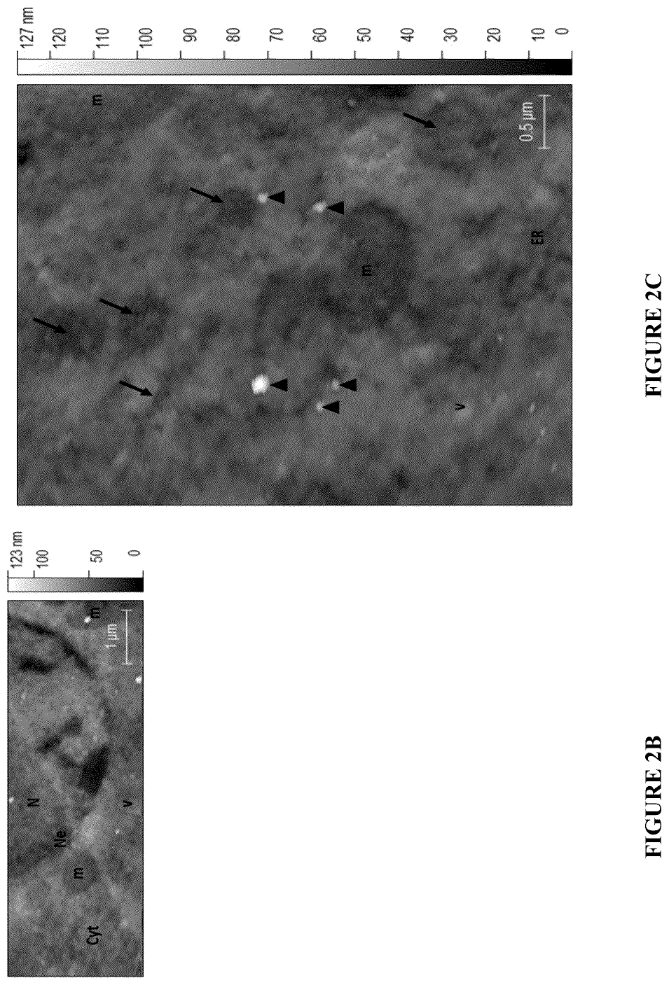

FIG. 2A shows an overview AFM image of papillary ducts in the mouse kidney medulla with a grayscale representation of topography. The papillary duct lumen (PL), capillaries (C), cell nuclei (N), and cytoplasm (Cyt) are visible in the image. FIG. 2B shows the mouse kidney medulla papillary duct in high magnification with a grayscale representation of topography. Chromatin structure and nuclear envelope (Ne), nucleus (N), cytoplasm (Cyt), mitochondria (m), and vesicular structures (v) are visible in the image. FIG. 2C shows a high magnification AFM image of a mouse kidney medulla papillary duct cell cytoplasm with grayscale representation of topography. Mitochondria (m), endoplasmic reticulum (ER), vesicular structures (v), other organelles (arrows), and uncleaned polymer fragments (arrowheads) are visible in the image. The qualitative visibility of fine structures in the AFM image and RMS roughness and maximum topography of the sample are provided in TABLE 2.

TABLE 2

| | | Qualitative | RMS roughness |
|---|---|---|---|
| Monomer- | | visibility of | and maximum |
| containing | Monomer-containing | fine structures | topography of |
| material | material Composition | in AFM | FIG. 2C |
| A | 9 g ethyl methacrylate | Good | 11.33 nm, 123.4 |
| | 1 g ethylene glycol | | nm |
| | dimethacrylate | | |
| | 50 mg benzoin methyl | | |
| | ether | | |

### Example 4 Nanohistology of Mouse Kidney with Monomer-Containing Material B

A mouse kidney tissue was obtained and the sample prepared and imaged for nanohistology.

Following the obtaining, the mouse kidney sample was first fixed in formaldehyde at room temperature for two hours and stored at 4° C. Following the fixation, the sample was rinsed and cryoprotected in 2.3M of sucrose at 25° C. for 1 hour followed by freezing in liquid nitrogen for 5 seconds until frozen. The mouse kidney sample was then dehydrated by freeze substitution in methanol containing 10% water, the freeze substitution protocol comprising a warming from −90° C. to −10° C. over 20 hours, washed with methanol containing 10% water. After dehydration, the sample was immersed in increasing concentrations of monomer-containing material comprising 2 g methyl methacrylate, 2 g ethyl methacrylate, 2 g n-butyl methacrylate, 2 g ethylene glycol dimethacrylate, 2 g trimethylolpropane trimethacrylate, and 50 mg benzoin methyl ether in methanol (25%, 50%, 75%) at −10° C. for 2 hours each step. The sample was then immersed in three changes of pure monomer-containing material for 2 hours each at −10° C. The sample was then treated with UV radiation at −10° C. for 12 hours under inert nitrogen gas. Following treatment with UV radiation, the sample was contacted with a contacting agent comprising colloidal silica with mean particle diameter of 60 nm for 5 minutes, colloidal silica with mean particle diameter of 20 nm for 5 minutes, and distilled water for 2 minutes at room temperature, resulting in removal of the polymer from the surface of the sample. The sample was then rinsed in distilled water for 2 minutes and plasma cleaned for 2 minutes. The sample was then imaged with atomic force microscopy in tapping mode, with the AFM probe comprising a pyramidal tip silicon cantilever with a 6 nm radius of curvature, nominal spring constant of 58 N/m and nominal frequency of 190 kHz. The sample was imaged by AFM with a scan speed of 1 Hz and a total number of 512 lines for a total image acquisition time of approximately 8 minutes.

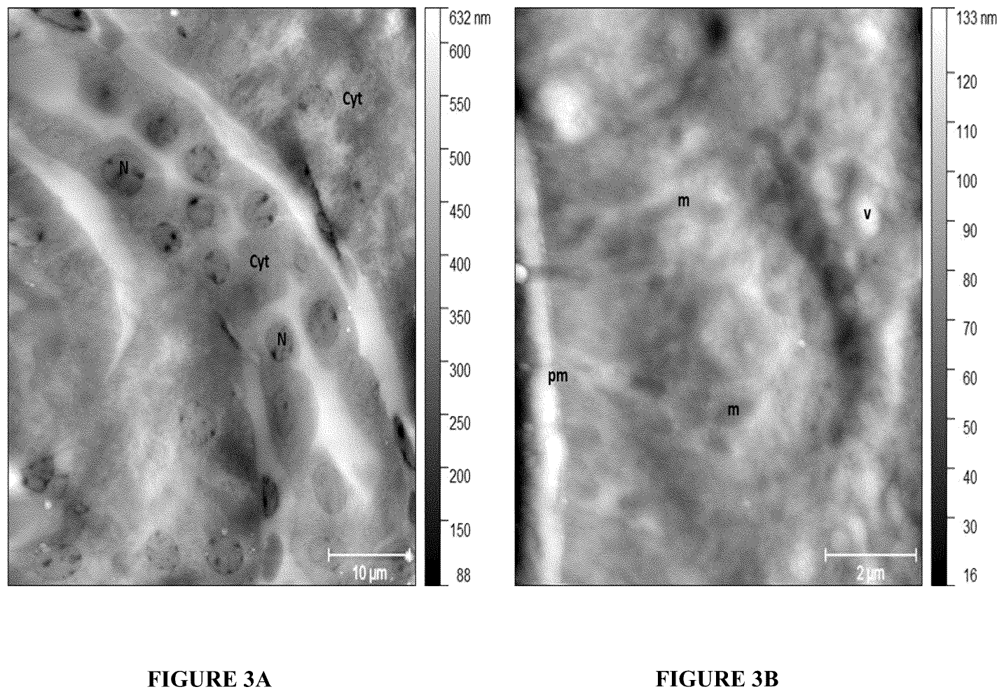

FIG. 3A shows an overview AFM image of the mouse kidney with grayscale representation of topography, showing cell nuclei (N) and distinct cytoplasm (Cyt). FIG. 3B shows a high magnification AFM image of the cytoplasm of a mouse kidney cell with grayscale representation of topography. The plasma membrane (pm), mitochondria (m) and vesicular structures are visible but appear slightly blurred. The qualitative visibility of fine structures in the AFM and RMS roughness and maximum topography of the high magnification image are provided in TABLE 3.

TABLE 3

| | | Qualitative | RMS roughness |
|---|---|---|---|
| Monomer- | | visibility of | and maximum |
| containing | Monomer-containing | fine structures | topography of |
| material | material Composition | in AFM | FIG. 2C |
| B | 2 g methyl methacrylate | Good | 16.93 nm, 137.5 |
| | 2 g ethyl methacrylate | | nm |
| | 2 g butyl methacrylate | | |
| | 2 g ethylene glycol | | |
| | dimethacrylate | | |
| | 2 g trimethylolpropane | | |
| | trimethacrylate | | |
| | 50 mg benzoin methyl | | |
| | ether | | |

### Example 5: Nanohistology of Mouse Kidney with Monomer-Containing Material C

A mouse kidney tissue was obtained and the sample prepared and imaged for nanohistology.

Following the obtaining, the mouse kidney sample was first fixed in formaldehyde at room temperature for two hours and stored at 4° C. Following the fixation, the sample was rinsed, and cryoprotected in 2.3M of sucrose at 25° C. for 1 hour followed by freezing in liquid nitrogen for 5 seconds, until frozen. The mouse kidney sample was then dehydrated by freeze substitution in methanol containing 10% water, the freeze substitution protocol comprising a warming from −90° C. to −10° C. over 20 hours, washed with methanol containing 10% water. After dehydration, the sample was immersed in increasing concentrations of monomer-containing material comprising 4 g methyl methacrylate, 4 g ethyl methacrylate, 2 g ethylene glycol dimethacrylate, and 50 mg benzoin methyl ether in methanol (25% v/v, 50% v/v, 75% v/v) at −10° C. for 2 hours each step. The sample was then immersed in three changes of pure monomer-containing material for 2 hours each at −10° C. The sample was then treated with UV radiation at −10° C. for 12 hours under inert nitrogen gas. Following treatment with UV radiation, the sample was contacted with a contacting agent comprising colloidal silica with mean particle diameter of 60 nm for 5 minutes, colloidal silica with mean particle diameter of 20 nm for 5 minutes, and distilled water for 2 minutes at room temperature, resulting in removal of the polymer from the surface of the sample. The sample was then rinsed in distilled water for 2 minutes and plasma cleaned for 2 minutes. The sample was then imaged with atomic force microscopy in tapping mode, with the AFM probe comprising a pyramidal tip silicon cantilever with a 6 nm radius of curvature, nominal spring constant of 58 N/m and nominal frequency of 190 kHz. The sample was imaged by AFM with a scan speed of 1 Hz and a total number of 512 lines for a total image acquisition time of approximately 8 minutes.

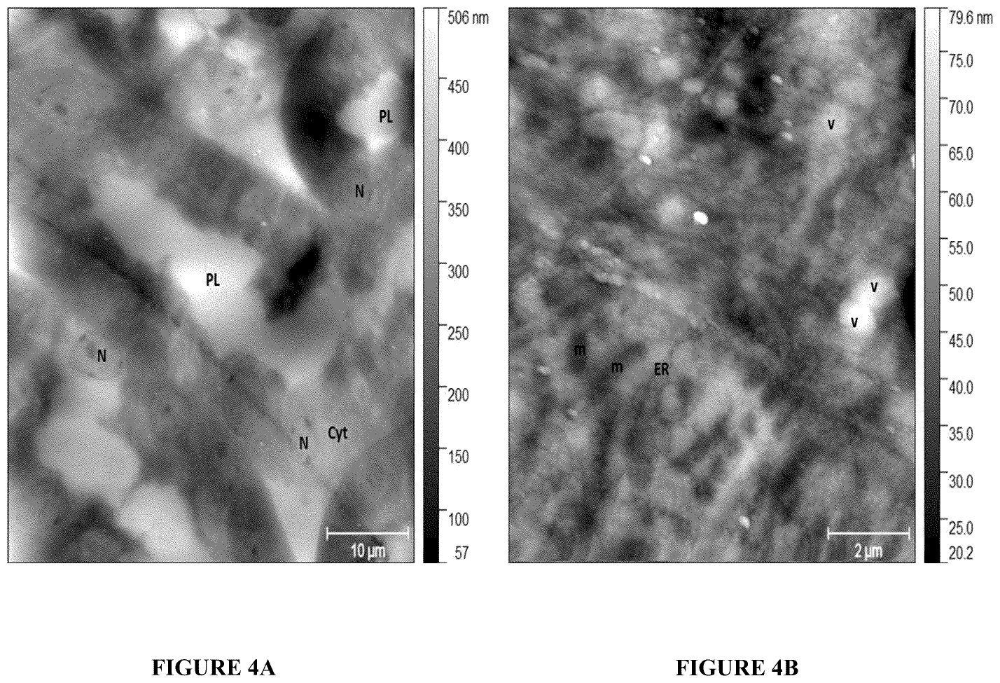

FIG. 4A shows an overview AFM image of the mouse kidney with grayscale representation of topography. Cell nuclei (N) and cytoplasm (Cyt) are clearly visible, and papillary duct lumen (PL) can be seen. FIG. 4B shows a high magnification AFM image of the cytoplasm of a mouse kidney cell with grayscale representation of topography. The cytoplasm shows many distinct structures, including mitochondria (m), endoplasmic reticulum (ER) and vesicular structures (v). The qualitative visibility of fine structures in the AFM and RMS roughness and maximum topography of the high magnification image are provided in TABLE 4. The improved fine structural visibility correlates with lower RMS roughness and total topography, indicating that macromolecular resolution is achievable by nanohistology.

TABLE 4

| | | Qualitative | RMS roughness |
|---|---|---|---|
| Monomer- | | visibility of | and maximum |
| containing | Monomer-containing | fine structures | topography of |
| material | material Composition | in AFM | FIG. 2C |
| C | 4 g methyl methacrylate | Better | 8.63 nm, 98.7 |
| | 4 g ethyl methacrylate | | nm |
| | 2 g ethylene glycol | | |
| | dimethacrylate | | |
| | 50 mg benzoin methyl | | |
| | ether | | |

### Example 6: Nanohistology of Mouse Kidney with Monomer-Containing Material D

A mouse kidney tissue was obtained and the sample prepared and imaged for nanohistology.

Following the obtaining, the mouse kidney sample was first fixed in formaldehyde at room temperature for two hours and stored at 4° C. Following the fixation, the sample was rinsed, and cryoprotected in 2.3M of sucrose at 4° C. for 2 hours followed by freezing in liquid nitrogen for 5 seconds, until frozen. The mouse kidney sample was then dehydrated by freeze substitution in methanol containing 10% water, the freeze substitution protocol comprising a warming from −90° C. to −10° C. over 20 hours, washed with methanol containing 10% water. After dehydration, the sample was immersed in increasing concentrations of monomer-containing material comprising 10 g methyl methacrylate, and 50 mg benzoin methyl ether in methanol (25, 50, 75%) at −10° C. for 2 hours each step. The sample was then immersed in three changes of pure monomer-containing material for 1.5 hours, 24 hours, and 8 hours at −10° C. The sample was then treated with UV radiation at −10° C. for 24 hours under inert nitrogen gas. Following treatment with UV radiation, the sample was contacted with a contacting agent comprising alumina with diameter of 50 nm for 3 minutes, colloidal silica with diameter of 60 nm for 5 minutes, colloidal silica with diameter of 20 nm for 5 minutes at room temperature, resulting in removal of the polymer from the surface of the sample. The sample was then rinsed in distilled water for 2 minutes and plasma cleaned for 2 minutes. The sample was then imaged with atomic force microscopy in tapping mode, with the AFM probe comprising a pyramidal tip silicon cantilever with a 6 nm radius of curvature, nominal spring constant of 58 N/m and nominal frequency of 190 kHz. The sample was imaged by AFM with a scan speed of 1 Hz and a total number of 256 lines for a total image acquisition time of approximately 4 minutes.

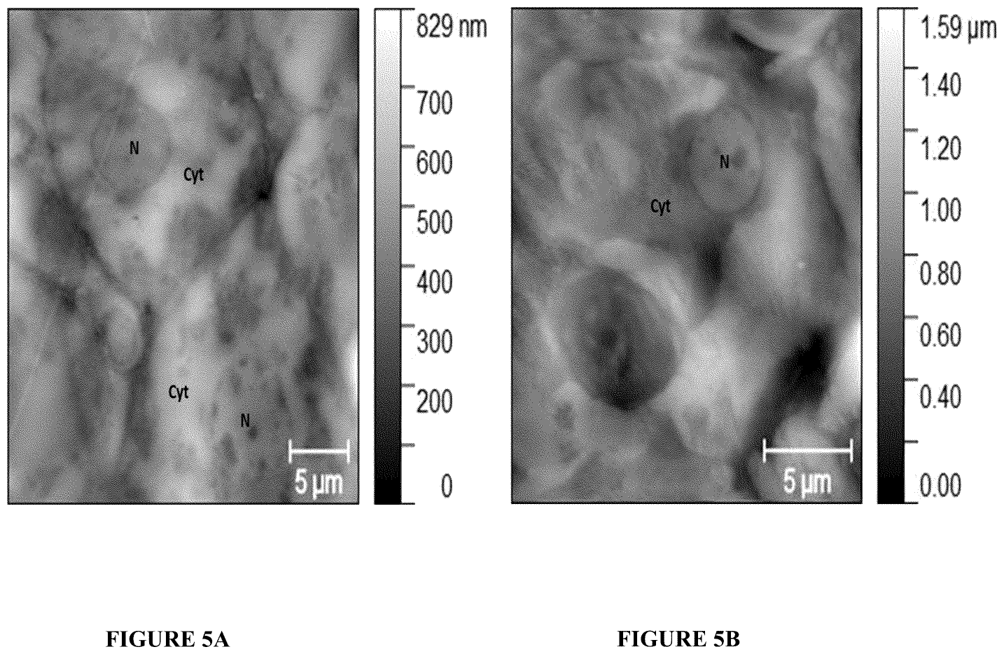

FIG. 5A shows an overview AFM image of the mouse kidney with grayscale representation of topography. Cell nuclei (N) and cytoplasm (Cyt) are partially visible, but a substantial amount of material has been extracted during sample preparation, leaving behind large areas of empty polymer. Accordingly, a monomer composed only of methyl methacrylate is insufficient for nanohistology, as further indicated by the large maximum topography of the sample. A methacrylate monomer capable of cross-linking is necessary to achieve the requisite RMS roughness and maximum topography. The qualitative visibility of fine structures in the AFM and RMS roughness and maximum topography of the high magnification image are provided in TABLE 5.

TABLE 5

| | | Qualitative | RMS roughness |
|---|---|---|---|
| Monomer- | | visibility of | and maximum |
| containing | Monomer-containing | fine structures | topography of |
| material D | material Composition | in AFM | FIG. 5A |
| D | 10 g methyl methacrylate | Poor | Not |
| | 50 mg benzoin methyl | | determined, >800 |
| | ether | | nm |

### Example 7: Nanohistology of Mouse Kidney with Monomer-Containing Material E

A mouse kidney tissue was obtained and the sample prepared and imaged for nanohistology.

Following the obtaining, the mouse kidney sample was first fixed in formaldehyde at room temperature for two hours and stored at 4° C. Following the fixation, the sample was rinsed, and cryoprotected in 2.3M of sucrose at 4° C. for 2 hours followed by freezing in liquid nitrogen for 5 seconds, until frozen. The mouse kidney sample was then dehydrated by freeze substitution in methanol containing 10% water, the freeze substitution protocol comprising a warming from −90° C. to −10° C. over 20 hours, washed with methanol containing 10% water. After dehydration, the sample was immersed in increasing concentrations of monomer-containing material comprising 10 g methyl methacrylate, and 50 mg benzoin methyl ether in methanol (25, 50, 75%) at −10° C. for 2 hours each step. The sample was then immersed in three changes of pure monomer-containing material for 1.5 hours, 24 hours, and 8 hours at −10° C. The sample was then treated with UV radiation at −10° C. for 24 hours under inert nitrogen gas. Following treatment with UV radiation, the sample was contacted with a contacting agent comprising alumina with diameter of 50 nm for 3 minutes, colloidal silica with diameter of 60 nm for 5 minutes, colloidal silica with diameter of 20 nm for 5 minutes at room temperature, resulting in removal of the polymer from the surface of the sample. The sample was then rinsed in distilled water for 2 minutes and plasma cleaned for 2 minutes. The sample was then imaged with atomic force microscopy in tapping mode, with the AFM probe comprising a pyramidal tip silicon cantilever with a 6 nm radius of curvature, nominal spring constant of 58 N/m and nominal frequency of 190 kHz. The sample was imaged by AFM with a scan speed of 1 Hz and a total number of 256 lines for a total image acquisition time of approximately 4 minutes.

FIG. 5B shows an overview AFM image of the mouse kidney with grayscale representation of topography. Cell nuclei (N) and cytoplasm (Cyt) are partially visible, but the fine structure is disrupted by large holes in the surface. Accordingly, a monomer composed only of ethyl methacrylate is insufficient for nanohistology, as further indicated by the large maximum topography of the sample. A methacrylate monomer capable of cross-linking is necessary to achieve the requisite RMS roughness and maximum topography. The qualitative visibility of fine structures in the AFM and RMS roughness and maximum topography of the high magnification image are provided in TABLE 6.

TABLE 6

| | | Qualitative | RMS roughness |
|---|---|---|---|
| Monomer- | | visibility of | and maximum |
| containing | Monomer-containing | fine structures | topography of |
| material E | material Composition | in AFM | FIG. 5B |
| E | 10 g ethyl methacrylate | Poor | Not |
| | 50 mg benzoin methyl | | determined, >1.5 |
| | ether | | μm |

### EMBODIMENTS

Embodiment 1. A method comprising: i) combining a biological material with a monomer-containing material, thereby obtaining a combination; ii) treating the combination with an agent that polymerizes monomers of the monomer-containing material to provide a polymeric material, thereby obtaining a polymerized combination; and iii) removing the polymeric material from a surface of the biological material, thereby obtaining a biological sample embedded in the polymeric material, wherein the biological sample has an exposed surface, wherein the exposed surface retains a shape and outline of the biological material.

Embodiment 2. The method of embodiment 1, wherein the treating the combination with the agent that polymerizes monomers of the monomer-containing material depletes the monomers.

Embodiment 3. The method of embodiment 1 or 2, further comprising chemically fixing the biological material with a fixative prior to the combining the biological material with the monomer-containing material.

Embodiment 4. The method of embodiment 3, wherein the fixative is a crosslinking agent.

Embodiment 5. The method of embodiment 3, wherein the fixative comprises a weak crosslinking agent.

Embodiment 6. The method of embodiment 3, wherein the fixative comprises formaldehyde.

Embodiment 7. The method of embodiment 3, wherein the fixative comprises a reversible crosslinking agent.

Embodiment 8. The method of embodiment 1 or 2, further comprising fixing the biological material by cryofixation to provide a cryofixed material prior to the combining the biological material with the monomer-containing material.

Embodiment 9. The method of embodiment 8, further comprising cryoprotecting the biological material prior to cryofixation.

Embodiment 10. The method of any one of embodiments 1-9, further comprising dehydrating the biological material prior to the combining the biological material with the monomer-containing material.

Embodiment 11. The method of embodiment 10, wherein the dehydrating comprises freeze substitution.

Embodiment 12. The method of embodiment 10, wherein the dehydrating comprises a progressive lowering of temperature.

Embodiment 13. The method of embodiment 10, wherein the dehydrating comprises a dehydration at room temperature.

Embodiment 14. The method of embodiment 10, wherein the dehydrating comprises freeze drying.

Embodiment 15. The method of embodiment 1 or 2, wherein the biological material comprises a deparaffinized histological sample.

Embodiment 16. The method of any one of embodiments 1-15, wherein the combining the biological material with the monomer-containing material comprises agitation.

Embodiment 17. The method of any one of embodiments 1-16, wherein the combining the biological material with the monomer-containing material occurs in a vacuum.

Embodiment 18. The method of any one of embodiments 1-17, wherein the monomer-containing material comprises thermosetting or thermoplastic monomers.

Embodiment 19. The method of embodiment 18, wherein the monomer-containing material comprises diallyl phthalate.

Embodiment 20. The method of embodiment 18, wherein the monomer-containing material comprises acrylic monomers.

Embodiment 21. The method of embodiment 18, wherein the monomer-containing material comprises methacrylate monomers.

Embodiment 22. The method of embodiment 21, wherein the monomer-containing material comprises a monomer with one methacrylate moiety.

Embodiment 23. The method of embodiment 22, wherein the monomer-containing material comprises methyl methacrylate.

Embodiment 24. The method of embodiment 23, wherein the monomer-containing material comprises about 100% w/w methyl methacrylate.

Embodiment 25. The method of embodiment 22, wherein the monomer-containing material comprises ethyl methacrylate.

Embodiment 26. The method of embodiment 25, wherein the monomer-containing material comprises about 100% w/w ethyl methacrylate.

Embodiment 27. The method of embodiment 22, wherein the monomer-containing material comprises n-butyl methacrylate.

Embodiment 28. The method of embodiment 21, wherein the monomer-containing material comprises a monomer with two methacrylate moieties.

Embodiment 29. The method of embodiment 28, wherein the monomer-containing material comprises ethylene glycol dimethacrylate.

Embodiment 30. The method of embodiment 21, wherein the monomer-containing material comprises monomers with three methacrylate moieties.

Embodiment 31. The method of embodiment 30, wherein the monomer-containing material comprises trimethylolpropane trimethacrylate.

Embodiment 32. The method of embodiment 21, wherein the monomer-containing material comprises a monomer with more than three methacrylate moieties.

Embodiment 33. The method of embodiment 21, wherein the monomer-containing material comprises methyl methacrylate and ethylene glycol dimethacrylate.

Embodiment 34. The method of embodiment 33, wherein the monomer-containing material comprises about 90% w/w methyl methacrylate and about 10% w/w ethylene glycol dimethacrylate.

Embodiment 35. The method of embodiment 21, wherein the monomer-containing material comprises ethyl methacrylate and ethylene glycol dimethacrylate.

Embodiment 36. The method of embodiment 35, wherein the monomer-containing material comprises about 90% w/w ethyl methacrylate and about 10% w/w ethylene glycol dimethacrylate.

Embodiment 37. The method of embodiment 35, wherein the monomer-containing material comprises about 80% w/w ethyl methacrylate and about 20% w/w ethylene glycol dimethacrylate.

Embodiment 38. The method of embodiment 35, wherein the monomer-containing material comprises about 50% w/w ethyl methacrylate and about 50% w/w ethylene glycol dimethacrylate.

Embodiment 39. The method of embodiment 21, wherein the monomer-containing material comprises methyl methacrylate and n-butyl methacrylate.

Embodiment 40. The method of embodiment 39, wherein the monomer-containing material comprises about 50% w/w methyl methacrylate and about 50% w/w n-butyl methacrylate.

Embodiment 41. The method of embodiment 21, wherein the monomer-containing material comprises methyl methacrylate, n-butyl methacrylate, and diallyl phthalate.

Embodiment 42. The method of embodiment 41, wherein the monomer-containing material comprises about 80% w/w methyl methacrylate, about 10% w/w n-butyl methacrylate, and about 10% w/w diallyl phthalate.

Embodiment 43. The method of embodiment 21, wherein the monomer-containing material comprises methyl methacrylate, n-butyl methacrylate, and trimethylolpropane trimethacrylate.

Embodiment 44. The method of embodiment 43, wherein the monomer-containing material comprises about 80% w/w methyl methacrylate, about 10% w/w n-butyl methacrylate, and about 10% w/w trimethylolpropane trimethacrylate.

Embodiment 45. The method of embodiment 21, wherein the monomer-containing material comprises methyl methacrylate, ethyl methacrylate, n-butyl methacrylate, ethylene glycol dimethacrylate, and trimethylolpropane trimethacrylate.

Embodiment 46. The method of embodiment 45, wherein the monomer-containing material comprises about 20% w/w methyl methacrylate, about 20% w/w ethyl methacrylate, about 20% w/w n-butyl methacrylate, about 20% w/w ethylene glycol dimethacrylate, and about 20% w/w trimethylolpropane trimethacrylate.

Embodiment 47. The method of embodiment 21, wherein the monomer-containing material comprises methyl methacrylate, ethyl methacrylate, and ethylene glycol dimethacrylate.

Embodiment 48. The method of embodiment 47, wherein the monomer-containing material comprises about 40% w/w methyl methacrylate, about 40% w/w ethyl methacrylate, and about 20% w/w ethylene glycol dimethacrylate.

Embodiment 49. The method of embodiment 47, wherein the monomer-containing material comprises about 25% w/w methyl methacrylate, about 25% w/w ethyl methacrylate, and about 50% w/w ethylene glycol dimethacrylate.

Embodiment 50. The method of embodiment 21, wherein the monomer-containing material comprises methyl methacrylate, ethyl methacrylate, and trimethylolpropane trimethacrylate.

Embodiment 51. The method of embodiment 50, wherein the monomer-containing material comprises about 40% w/w methyl methacrylate, about 40% w/w ethyl methacrylate, and about 20% w/w trimethylolpropane trimethacrylate.

Embodiment 52. The method of any one of embodiments 18-51, wherein the monomer-containing material further comprises a polymerization catalyst.

Embodiment 53. The method of embodiment 52, wherein the polymerization catalyst comprises a UV polymerization catalyst.

Embodiment 54. The method of embodiment 52, wherein the polymerization catalyst comprises benzoin methyl ether.

Embodiment 55. The method of embodiment 54, wherein the polymerization catalyst comprises about 0.5% w/w benzoin methyl ether.

Embodiment 56. The method of embodiment 54, wherein the polymerization catalyst comprises about 2.0% w/w benzoin methyl ether.

Embodiment 57. The method of any one of embodiments 1-56, wherein the agent that polymerizes monomers of the monomer-containing material comprises UV radiation.

Embodiment 58. The method of embodiment 1-57, wherein the removing of the polymeric material comprises contacting the polymerized combination with a contacting agent with agitation.

Embodiment 59. The method of embodiment 58, wherein the contacting agent comprises a homogenous suspension of an abrasive agent.

Embodiment 60. The method of embodiment 59, wherein the abrasive agent comprises alumina particles.

Embodiment 61. The method of embodiment 59, wherein the abrasive agent comprises colloidal silica.

Embodiment 62. The method of embodiment 59, wherein the abrasive agent comprises colloidal silica particles having a mean particle diameter of about 60 nm.

Embodiment 63. The method of embodiment 59, wherein the abrasive agent comprises colloidal silica particles having a mean particle diameter of about 20 nm.

Embodiment 64. The method of embodiment 58, wherein the contacting agent comprises gas plasma.

Embodiment 65. The method of any one of embodiments 1-64, wherein the contacting further comprises rinsing the polymerized combination with an organic solvent.

Embodiment 66. The method of embodiment 65, wherein the organic solvent comprises ethanol.

Embodiment 67. The method of any one of embodiments 1-64, wherein the contacting further comprises rinsing the polymerized combination with an aqueous solvent.

Embodiment 68. The method of embodiment 67, wherein the aqueous solvent comprises distilled water.

Embodiment 69. The method of embodiment 67, wherein the aqueous solvent comprises distilled water and a detergent.

Embodiment 70. The method of any one of embodiments 1-69, wherein the removing the polymeric material comprises removing of polymerized material from biological structures of the biological material.

Embodiment 71. The method of any one of embodiments 1-70, wherein following the removing the polymeric material, a surface topography of the biological sample embedded in the polymeric material does not exceed 300 nm, wherein the surface topography is as measured by atomic force microscopy.

Embodiment 72. The method of any one of embodiments 1-71, further comprising imaging of the biological sample embedded in the polymeric material.

Embodiment 73. The method of embodiment 72, wherein the imaging is by atomic force microscopy.

Embodiment 74. The method of embodiment 73, wherein the imaging is by atomic force microscopy in contact mode.

Embodiment 75. The method of embodiment 73, wherein the imaging is by atomic force microscopy in tapping mode.

Embodiment 76. The method of embodiment 73, wherein the imaging is by atomic force microscopy in non-contact mode.

Embodiment 77. The method of any one of embodiments 73-76, wherein the atomic force microscopy records the surface topography of the biological sample embedded in the polymeric material.

Embodiment 78. The method of any one of embodiments 73-76, wherein the atomic force microscopy records a phase shift of the biological sample embedded in the polymeric material.

Embodiment 79. The method of any one of embodiments 73-76, wherein the atomic force microscopy records the surface topography and a phase shift of the biological sample embedded in the polymeric material.

Embodiment 80. The method of any one of embodiments 72-79, wherein the imaging is by atomic force microscopy integrated with an additional imaging modality.

Embodiment 81. The method of embodiment 80, wherein the additional imaging modality comprises inverted light microscopy.

Embodiment 82. The method of embodiment 80, wherein the additional imaging modality comprises bright field microscopy.

Embodiment 83. The method of embodiment 80, wherein the additional imaging modality comprises phase contrast microscopy.

Embodiment 84. The method of embodiment 80, wherein the additional imaging modality comprises fluorescence microscopy.

Embodiment 85. The method of any one of embodiments 81-83, further comprising contacting the biological material with histological dye prior to the combining with a monomer-containing material.

Embodiment 86. The method of embodiment 84, further comprising contacting the biological sample with a fluorescent labeling molecule prior to the combining with a monomer-containing material.

Embodiment 87. The method of any one of the preceding embodiments, wherein the method is automated.

Embodiment 88. The method of any of the preceding embodiments, wherein the method is automated in a high throughput format.

Embodiment 89. A method comprising: i) fixing a biological material, thereby obtaining a fixed sample; ii) dehydrating the fixed sample, thereby obtaining a fixed and dehydrated sample; iii) contacting the fixed and dehydrated sample with a monomer-containing material, thereby obtaining a combination; iv) treating the combination with an agent that polymerizes monomers of the monomer-containing material to provide a polymeric material, thereby obtaining a polymerized combination; and v) contacting the polymerized combination with a contacting agent with agitation to remove polymeric material from a surface of the biological material, thereby obtaining a biological sample embedded in the polymeric material, wherein the biological sample has an exposed surface, wherein the exposed surface retains a shape and outline of the biological material.

Embodiment 90. The method of embodiment 89, wherein the fixing comprises chemically fixing the biological material with a fixative.

Embodiment 91. The method of embodiment 90, wherein the fixative comprises a crosslinking agent.

Embodiment 92. The method of embodiment 90, wherein the fixative comprises a weak crosslinking agent.

Embodiment 93. The method of embodiment 90, wherein the fixative comprises formaldehyde.

Embodiment 94. The method of embodiment 90, wherein the fixative comprises a reversible crosslinking agent.

Embodiment 95. The method of embodiment 89, wherein the fixing comprises fixing the biological material by cryofixation.

Embodiment 96. The method of embodiment 95, further comprising cryoprotecting the biological material prior to cryofixation.

Embodiment 97. The method of any one of embodiments 89-96, wherein the dehydrating comprises freeze substitution.

Embodiment 98. The method of any one of embodiments 89-96, wherein the dehydrating comprises progressive lowering of temperature.

Embodiment 99. The method of any one of embodiments 89-96, wherein the dehydrating comprises a dehydration at room temperature.

Embodiment 100. The method of any one of embodiments 89-96, wherein the dehydrating method comprises freeze drying.

Embodiment 101. The method of any one of embodiments 89-100, wherein the combining the biological material with the monomer-containing material comprises agitation.

Embodiment 102. The method of any one of embodiments 89-101, wherein the combining the biological material with the monomer-containing material occurs in a vacuum.

Embodiment 103. The method of any one of embodiments 89-102, wherein the monomer-containing material comprises thermosetting or thermoplastic monomers.

Embodiment 104. The method of embodiment 103, wherein the monomer-containing material comprises diallyl phthalate.

Embodiment 105. The method of embodiment 103, wherein the monomer-containing material comprises acrylic monomers.

Embodiment 106. The method of embodiment 103, wherein the monomer-containing material comprises methacrylate monomers.

Embodiment 107. The method of embodiment 106, wherein the monomer-containing material comprises a monomer with one methacrylate moiety.

Embodiment 108. The method of embodiment 107, wherein the monomer-containing material comprises methyl methacrylate.

Embodiment 109. The method of embodiment 108, wherein the monomer-containing material comprises about 100% w/w methyl methacrylate.

Embodiment 110. The method of embodiment 107, wherein the monomer-containing material comprises ethyl methacrylate.

Embodiment 111. The method of embodiment 108, wherein the monomer-containing material comprises about 100% w/w ethyl methacrylate.

Embodiment 112. The method of embodiment 107, wherein the monomer-containing material comprises n-butyl methacrylate.

Embodiment 113. The method of embodiment 106, wherein the monomer-containing material comprises a monomer with two methacrylate moieties.

Embodiment 114. The method of embodiment 113, wherein the monomer-containing material comprises ethylene glycol dimethacrylate.

Embodiment 115. The method of embodiment 106, wherein the monomer-containing material comprises a monomer with three methacrylate moieties.

Embodiment 116. The method of embodiment 115, wherein the monomer-containing material comprises trimethylolpropane trimethacrylate.

Embodiment 117. The method of embodiment 106, wherein the monomer-containing material comprises monomers with more than three methacrylate moieties.

Embodiment 118. The method of embodiment 106, wherein the monomer-containing material comprises methyl methacrylate and ethylene glycol dimethacrylate.

Embodiment 119. The method of embodiment 118, wherein the monomer-containing material comprises about 90% w/w methyl methacrylate and about 10% w/w ethylene glycol dimethacrylate.

Embodiment 120. The method of embodiment 106, wherein the monomer-containing material comprises ethyl methacrylate and ethylene glycol dimethacrylate.

Embodiment 121. The method of embodiment 120, wherein the monomer-containing material comprises about 90% w/w ethyl methacrylate and about 10% w/w ethylene glycol dimethacrylate.

Embodiment 122. The method of embodiment 120, wherein the monomer-containing material comprises about 80% w/w ethyl methacrylate and about 20% w/w ethylene glycol dimethacrylate.

Embodiment 123. The method of embodiment 120, wherein the monomer-containing material comprises about 50% w/w ethyl methacrylate and about 50% w/w ethylene glycol dimethacrylate.

Embodiment 124. The method of embodiment 106, wherein the monomer-containing material comprises methyl methacrylate and n-butyl methacrylate.

Embodiment 125. The method of embodiment 124, wherein the monomer-containing material comprises about 50% w/w methyl methacrylate and about 50% w/w n-butyl methacrylate.

Embodiment 126. The method of embodiment 106, wherein the monomer-containing material comprises methyl methacrylate, n-butyl methacrylate, and diallyl phthalate.

Embodiment 127. The method of embodiment 126, wherein the monomer-containing material comprises about 80% w/w methyl methacrylate, about 10% w/w n-butyl methacrylate, and about 10% w/w diallyl phthalate

Embodiment 128. The method of embodiment 106, wherein the monomer-containing material comprises methyl methacrylate, n-butyl methacrylate, and trimethylolpropane trimethacrylate.

Embodiment 129. The method of embodiment 128, wherein the monomer-containing material comprises about 80% w/w methyl methacrylate, about 10% w/w n-butyl methacrylate, and about 10% w/w trimethylolpropane trimethacrylate.

Embodiment 130. The method of embodiment 106, wherein the monomer-containing material comprises methyl methacrylate, ethyl methacrylate, n-butyl methacrylate, ethylene glycol dimethacrylate, and trimethylolpropane trimethacrylate.

Embodiment 131. The method of embodiment 130, wherein the monomer-containing material comprises 20% w/w methyl methacrylate, 20% w/w ethyl methacrylate, 20% w/w n-butyl methacrylate, 20% w/w ethylene glycol dimethacrylate, and 20% w/w trimethylolpropane trimethacrylate.

Embodiment 132. The method of embodiment 106, wherein the monomer-containing material comprises methyl methacrylate, ethyl methacrylate, and ethylene glycol dimethacrylate.

Embodiment 133. The method of embodiment 132, wherein the monomer-containing material comprises about 40% w/w methyl methacrylate, about 40% w/w ethyl methacrylate, and about 20% w/w ethylene glycol dimethacrylate.

Embodiment 134. The method of embodiment 132, wherein the monomer-containing material comprises about 25% w/w methyl methacrylate, about 25% w/w ethyl methacrylate, and about 50% w/w ethylene glycol dimethacrylate.

Embodiment 135. The method of embodiment 106, wherein the monomer-containing material comprises methyl methacrylate, ethyl methacrylate, and trimethylolpropane trimethacrylate.

Embodiment 136. The method of embodiment 135, wherein the monomer-containing material comprises about 40% w/w methyl methacrylate, about 40% w/w ethyl methacrylate, and about 20% w/w trimethylolpropane trimethacrylate.

Embodiment 137. The method of any one of embodiments 103-136, wherein the monomer-containing material further comprises a polymerization catalyst.

Embodiment 138. The method of embodiment 137, wherein the polymerization catalyst comprises a UV polymerization catalyst.

Embodiment 139. The method of embodiment 137, wherein the polymerization catalyst comprises benzoin methyl ether.

Embodiment 140. The method of embodiment 139, wherein the polymerization catalyst comprises about 0.5% w/w benzoin methyl ether.

Embodiment 141. The method of embodiment 139, wherein the polymerization catalyst comprises about 2.0% w/w benzoin methyl ether.

Embodiment 142. The method of any one of embodiments 89-141, wherein the agent that polymerizes monomers of the monomer-containing material comprises UV radiation.

Embodiment 143. The method of any one of embodiments 89-142, wherein the contacting agent comprises a homogenous suspension of an abrasive agent.

Embodiment 144. The method of embodiment 143, wherein the abrasive agent comprises alumina particles.

Embodiment 145. The method of embodiment 143, wherein the abrasive agent comprises colloidal silica.

Embodiment 146. The method of embodiment 143, wherein the abrasive agent comprises colloidal silica particles having a mean particle diameter of about 60 nm.

Embodiment 147. The method of embodiment 143, wherein the abrasive agent comprises colloidal silica particles having a mean particle diameter of about 20 nm.

Embodiment 148. The method of any one of embodiments 89-142, wherein the contacting agent comprises gas plasma.

Embodiment 149. The method of any one of embodiments 89-148, wherein the contacting further comprises rinsing the polymerized combination with an organic solvent.

Embodiment 150. The method of embodiment 149, wherein the organic solvent comprises ethanol.

Embodiment 151. The method of any one of embodiments 89-148, wherein the contacting further comprises rinsing the polymerized combination with an aqueous solvent.

Embodiment 152. The method of embodiment 151, wherein the aqueous solvent comprises distilled water.

Embodiment 153. The method of embodiment 151, wherein the aqueous solvent comprises distilled water and a detergent.

Embodiment 154. The method of any one of embodiments 89-153, wherein the removing of polymerized monomer-containing material comprises removing of polymerized material from biological structures of the biological material.

Embodiment 155. The method of any one of embodiments 89-154, wherein following the removal of polymerized material, a surface topography of the biological sample embedded in the polymeric material does not exceed 300 nm, wherein the surface topography is as measured by atomic force microscopy.

Embodiment 156. The method of any one of embodiments 89-155, further comprising imaging of the biological sample embedded in the polymeric material.

Embodiment 157. The method of embodiment 156, wherein the imaging is by atomic force microscopy.

Embodiment 158. The method of embodiment 157, wherein the atomic force microscopy records the surface topography of the biological sample embedded in the polymeric material.

Embodiment 159. The method of embodiment 157, wherein the atomic force microscopy records a phase shift of the biological sample embedded in the polymeric material.

Embodiment 160. The method of embodiment 157, wherein the atomic force microscopy records the surface topography and a phase shift of the biological sample embedded in the polymeric material.

Embodiment 161. A method comprising: i) deparaffinizing a paraffin-embedded histological sample, thereby obtaining a deparaffinized sample; ii) contacting the deparaffinized sample with a monomer-containing material, thereby obtaining a combination; iii) treating the combination with an agent that polymerizes monomers of the monomer-containing material to provide a polymeric material, thereby obtaining a polymerized combination; and iv) contacting the polymerized sample with a contacting agent with agitation to remove polymeric material from a surface of the biological material, thereby obtaining a biological sample embedded in the polymer material, wherein the biological sample has an exposed surface, wherein the exposed surface retains a shape and outline of the biological material.

Embodiment 162. The method of embodiment 161, wherein the monomer-containing material comprises thermosetting or thermoplastic monomers.

Embodiment 163. The method of embodiment 162, wherein the monomer-containing material comprises diallyl phthalate.

Embodiment 164. The method of embodiment 162, wherein the monomer-containing material comprises acrylic monomers.

Embodiment 165. The method of embodiment 162, wherein the monomer-containing material comprises methacrylate monomers.

Embodiment 166. The method of embodiment 165, wherein the monomer-containing material comprises a monomer with one methacrylate moiety.

Embodiment 167. The method of embodiment 166, wherein the monomer-containing material comprises methyl methacrylate.

Embodiment 168. The method of embodiment 167, wherein the monomer-containing material comprises about 100% w/w methyl methacrylate.

Embodiment 169. The method of embodiment 166, wherein the monomer-containing material comprises ethyl methacrylate.

Embodiment 170. The method of embodiment 169, wherein the monomer-containing material comprises about 100% w/w ethyl methacrylate.

Embodiment 171. The method of embodiment 166, wherein the monomer-containing material comprises n-butyl methacrylate.

Embodiment 172. The method of embodiment 165, wherein the monomer-containing material comprises a monomer with two methacrylate moieties.

Embodiment 173. The method of embodiment 172, wherein the monomer-containing material comprises ethylene glycol dimethacrylate.

Embodiment 174. The method of embodiment 165, wherein the monomer-containing material comprises a monomer with three methacrylate moieties.

Embodiment 175. The method of embodiment 174, wherein the monomer-containing material comprises trimethylolpropane trimethacrylate.

Embodiment 176. The method of embodiment 165, wherein the monomer-containing material comprises a monomer with more than three methacrylate moieties.

Embodiment 177. The method of embodiment 165, wherein the monomer-containing material comprises methyl methacrylate and ethylene glycol dimethacrylate.

Embodiment 178. The method of embodiment 177, wherein the monomer-containing material comprises about 90% w/w methyl methacrylate and about 10% w/w ethylene glycol dimethacrylate.

Embodiment 179. The method of embodiment 165, wherein the monomer-containing material comprises ethyl methacrylate and ethylene glycol dimethacrylate.

Embodiment 180. The method of embodiment 179, wherein the monomer-containing material comprises about 90% w/w ethyl methacrylate and about 10% w/w ethylene glycol dimethacrylate.

Embodiment 181. The method of embodiment 179, wherein the monomer-containing material comprises about 80% w/w ethyl methacrylate and about 20% w/w ethylene glycol dimethacrylate.

Embodiment 182. The method of embodiment 179, wherein the monomer-containing material comprises about 50% w/w ethyl methacrylate and about 50% w/w ethylene glycol dimethacrylate.

Embodiment 183. The method of embodiment 165, wherein the monomer-containing material comprises methyl methacrylate and n-butyl methacrylate.

Embodiment 184. The method of embodiment 183, wherein the monomer-containing material comprises about 50% w/w methyl methacrylate and about 50% w/w n-butyl methacrylate.

Embodiment 185. The method of embodiment 165, wherein the monomer-containing material comprises methyl methacrylate, n-butyl methacrylate, and diallyl phthalate.

Embodiment 186. The method of embodiment 185, wherein the monomer-containing material comprises about 80% w/w methyl methacrylate, about 10% w/w n-butyl methacrylate, and about 10% w/w diallyl phthalate

Embodiment 187. The method of embodiment 165, wherein the monomer-containing material comprises methyl methacrylate, n-butyl methacrylate, and trimethylolpropane trimethacrylate.

Embodiment 188. The method of embodiment 187, wherein the monomer-containing material comprises about 80% w/w methyl methacrylate, about 10% w/w n-butyl methacrylate, and about 10% w/w trimethylolpropane trimethacrylate.

Embodiment 189. The method of embodiment 165, wherein the monomer-containing material comprises methyl methacrylate, ethyl methacrylate, n-butyl methacrylate, ethylene glycol dimethacrylate, and trimethylolpropane trimethacrylate.

Embodiment 190. The method of embodiment 189, wherein the monomer-containing material comprises 20% w/w methyl methacrylate, 20% w/w ethyl methacrylate, 20% w/w n-butyl methacrylate, 20% w/w ethylene glycol dimethacrylate, and 20% w/w trimethylolpropane trimethacrylate.

Embodiment 191. The method of embodiment 165, wherein the monomer-containing material comprises methyl methacrylate, ethyl methacrylate, and ethylene glycol dimethacrylate.

Embodiment 192. The method of embodiment 191, wherein the monomer-containing material comprises about 40% w/w methyl methacrylate, about 40% w/w ethyl methacrylate, and about 20% w/w ethylene glycol dimethacrylate.

Embodiment 193. The method of embodiment 191, wherein the monomer-containing material comprises about 25% w/w methyl methacrylate, about 25% w/w ethyl methacrylate, and about 50% w/w ethylene glycol dimethacrylate.

Embodiment 194. The method of embodiment 165, wherein the monomer-containing material comprises methyl methacrylate, ethyl methacrylate, and trimethylolpropane trimethacrylate.

Embodiment 195. The method of embodiment 194, wherein the monomer-containing material comprises about 40% w/w methyl methacrylate, about 40% w/w ethyl methacrylate, and about 20% w/w trimethylolpropane trimethacrylate.

Embodiment 196. The method of any one of embodiments 162-195, wherein the monomer-containing material further comprises a polymerization catalyst.

Embodiment 197. The method of embodiment 196, wherein the polymerization catalyst comprises a UV polymerization catalyst.

Embodiment 198. The method of embodiment 196, wherein the polymerization catalyst comprises benzoin methyl ether.

Embodiment 199. The method of embodiment 198, wherein the polymerization catalyst comprises about 0.5% w/w benzoin methyl ether.

Embodiment 200. The method of embodiment 198, wherein the polymerization catalyst comprises about 2.0% w/w benzoin methyl ether.

Embodiment 201. The method of any one of embodiments 161-200, wherein the agent that polymerizes monomers of the monomer-containing material comprises UV radiation.

Embodiment 202. The method of any one of embodiments 161-201, wherein the contacting agent comprises a homogenous suspension of an abrasive agent.

Embodiment 203. The method of embodiment 202, wherein the abrasive agent comprises alumina particles.

Embodiment 204. The method of embodiment 202, wherein the abrasive agent comprises colloidal silica.

Embodiment 205. The method of embodiment 202, wherein the abrasive agent comprises colloidal silica particles having a mean particle diameter of 60 nm.

Embodiment 206. The method of embodiment 202, wherein the abrasive agent comprises colloidal silica particles having a mean particle diameter of 20 nm.

Embodiment 207. The method of any one of embodiments 161-201, wherein the contacting agent comprises gas plasma.

Embodiment 208. The method of any one of embodiments 161-207, wherein the contacting further comprises rinsing the polymerized combination with an organic solvent.

Embodiment 209. The method of embodiment 208, wherein the organic solvent comprises ethanol.

Embodiment 210. The method of any one of embodiments 161-208, wherein the contacting further comprises rinsing the polymerized combination with an aqueous solvent.

Embodiment 211. The method of embodiment 210, wherein the aqueous solvent comprises distilled water.

Embodiment 212. The method of embodiment 210, wherein the aqueous solvent comprises distilled water and a detergent.

Embodiment 213. The method of any one of embodiments 161-212, wherein the removing of polymeric material comprises removing of polymerized material from biological structures of the biological material.

Embodiment 214. The method of any one of embodiments 161-213, wherein following the removal of polymeric material, a surface topography of the biological sample embedded in the polymeric material does not exceed 300 nm, wherein the surface topography is as measured by atomic force microscopy.

Embodiment 215. The method of any one of embodiments 161-214, further comprising imaging of the polymerized, embedded tissue sample.

Embodiment 216. The method of embodiment 215, wherein the imaging is by atomic force microscopy.

Embodiment 217. The method of embodiment 216, wherein the atomic force microscopy records the surface topography of the biological sample embedded in the polymeric material.

Embodiment 218. The method of embodiment 216, wherein the atomic force microscopy records a phase shift of the biological sample embedded in the polymeric material.

Embodiment 219. The method of embodiment 216, wherein the atomic force microscopy records the surface topography and a phase shift of the biological sample embedded in the polymeric material.

Embodiment 220. A sample of a mixture of monomers comprising about 90% w/w ethyl methacrylate and about 10% w/w ethylene glycol dimethacrylate.

Embodiment 221. The sample of embodiment 220 further comprising about 0.5% w/w benzoin methyl ether.

Embodiment 222. A sample of a mixture of monomers comprising about 20% w/w methyl methacrylate, about 20% w/w ethyl methacrylate, about 20% w/w butyl methacrylate, about 20% w/w ethylene glycol dimethacrylate, and about 20% w/w trimethylolpropane trimethyacrylate.

Embodiment 223. The sample of embodiment 222 further comprising about 0.5% w/w benzoin methyl ether.

Embodiment 224. A sample of a mixture of monomers comprising about 40% w/w methyl methacrylate, about 40% w/w ethyl methacrylate, and about 20% w/w ethylene glycol dimethacrylate.

Embodiment 225. The sample of embodiment 224 further comprising about 0.5% w/w benzoin methyl ether.

Embodiment 226. A sample of a mixture of monomers comprising about 100% w/w methyl methacrylate.

Embodiment 227. The sample of embodiment 226 further comprising about 0.5% w/w benzoin methyl ether.

Embodiment 228. A sample of a mixture of monomers comprising about 50% w/w methyl methacrylate and about 50% w/w n-butyl methacrylate.

Embodiment 229. The sample of embodiment 228 further comprising about 0.5% w/w benzoin methyl ether.

Embodiment 230. The sample of embodiment 228 further comprising about 2% w/w benzoin methyl ether.

Embodiment 231. A sample of a mixture of monomers comprising about 80% w/w methyl methacrylate, about 10% w/w n-butyl methacrylate, and about 10% w/w diallyl phathalate.

Embodiment 232. The sample of embodiment 231 further comprising about 0.5% w/w benzoin methyl ether.

Embodiment 233. A sample of a mixture of monomers comprising about 80% w/w methyl methacrylate, about 10% w/w n-butyl methacrylate, and about 10% w/w trimethylolpropane trimethacrylate.

Embodiment 234. The sample of embodiment 233 further comprising about 0.5% w/w benzoin methyl ether.

Embodiment 235. A sample of a mixture of monomers comprising about 100% w/w ethyl methacrylate.

Embodiment 236. The sample of embodiment 235 further comprising about 0.5% w/w benzoin methyl ether.

Embodiment 237. A sample of a mixture of monomers comprising about 90% w/w methyl methacrylate and about 10% w/w ethylene glycol dimethacrylate.

Embodiment 238. The sample of embodiment 237 further comprising about 0.5% w/w benzoin methyl ether.

Embodiment 239. A sample of a mixture of monomers comprising about 50% w/w methyl methacrylate and about 50% w/w ethylene glycol dimethacrylate.

Embodiment 240. The sample of embodiment 239 further comprising about 0.5% w/w benzoin methyl ether.

Embodiment 241. The sample of embodiment 239 further comprising about 2% w/w benzoin methyl ether.

Embodiment 242. A sample of a mixture of monomers comprising about 80% w/w methyl methacrylate and about 20% w/w ethylene glycol dimethacrylate.

Embodiment 243. The sample of embodiment 242 further comprising about 0.5% w/w benzoin methyl ether.

Embodiment 244. The sample of embodiment 242 further comprising about 2% w/w benzoin methyl ether.

Embodiment 245. A sample of a mixture of monomers comprising about 25% w/w methyl methacrylate, about 25% w/w ethyl methacrylate, and about 50% w/w ethylene glycol dimethacrylate.

Embodiment 246. The sample of embodiment 245 further comprising about 0.5% w/w benzoin methyl ether.

Embodiment 247. A sample of a mixture of monomers comprising about 40% w/w methyl methacrylate, about 40% w/w n-butyl methacrylate, and about 20% w/w ethylene glycol dimethacrylate.

Embodiment 248. The sample of embodiment 247 further comprising about 0.5% w/w benzoin methyl ether.

Embodiment 249. A sample of a mixture of monomers comprising about 40% w/w methyl methacrylate, about 40% w/w n-butyl methacrylate, and about 20% w/w trimethylolpropane trimethacrylate.

Embodiment 250. The sample of embodiment 249 further comprising about 0.5% w/w benzoin methyl ether.

Embodiment 251. An article of manufacture prepared by a process, wherein the process comprises: mixing a material comprising a plurality of monomers and a polymerization catalyst with a polymerization agent, wherein the plurality of monomers comprises about 90% w/w ethyl methacrylate and about 10% w/w ethylene glycol dimethacrylate, the polymerization catalyst comprises about 0.5% w/w benzoin methyl ether, and the agent for polymerization of monomers comprises ultraviolet radiation.

Embodiment 252. An article of manufacture prepared by a process, wherein the process comprises: mixing a material comprising a plurality of monomers and a polymerization catalyst with a polymerization agent, wherein the plurality of monomers comprises about 20% w/w methyl methacrylate, about 20% w/w ethyl methacrylate, about 20% w/w butyl methacrylate, about 20% w/w ethylene glycol dimethacrylate, and about 20% w/w trimethylolpropane trimethyacrylate; the polymerization catalyst comprises about 0.5% w/w benzoin methyl ether; and the agent for polymerization of monomers comprises ultraviolet radiation.

Embodiment 253. An article of manufacture prepared by a process, wherein the process comprises: mixing a material comprising a plurality of monomers and a polymerization catalyst with a polymerization agent, wherein the plurality of monomers comprises monomers about 40% w/w methyl methacrylate, about 40% w/w ethyl methacrylate, and about 20% w/w ethylene glycol dimethacrylate; the polymerization catalyst comprises about 0.5% w/w benzoin methyl ether; and the agent for polymerization of monomers comprises ultraviolet radiation.

Embodiment 254. An article of manufacture prepared by a process, wherein the process comprises: mixing a material comprising a plurality of monomers and a polymerization catalyst with a polymerization agent, wherein the plurality of monomers comprises monomers about 100% w/w methyl methacrylate, the polymerization catalyst comprises about 0.5% w/w benzoin methyl ether, and the agent for polymerization of monomers comprises ultraviolet radiation.

Embodiment 255. An article of manufacture prepared by a process, wherein the process comprises: mixing a material comprising a plurality of monomers and a polymerization catalyst with a polymerization agent, wherein the plurality of monomers comprises monomers about 50% w/w methyl methacrylate and about 50% n-butyl methacrylate, the polymerization catalyst comprises about 0.5% w/w benzoin methyl ether, and the agent for polymerization of monomers comprises ultraviolet radiation.

Embodiment 256. An article of manufacture prepared by a process, wherein the process comprises: mixing a material comprising a plurality of monomers and a polymerization catalyst with a polymerization agent, wherein the plurality of monomers comprises monomers about 50% w/w methyl methacrylate and about 50% w/w n-butyl methacrylate, the polymerization catalyst comprises about 2% w/w benzoin methyl ether, and the agent for polymerization of monomers comprises ultraviolet radiation.

Embodiment 257. An article of manufacture prepared by a process, wherein the process comprises: mixing a material comprising a plurality of monomers and a polymerization catalyst with a polymerization agent, wherein the plurality of monomers comprises monomers about 80% w/w methyl methacrylate, about 10% w/w n-butyl methacrylate and about 10% w/w diallyl phthalate; the polymerization catalyst comprises about 0.5% w/w benzoin methyl ether; and the agent for polymerization of monomers comprises ultraviolet radiation.

Embodiment 258. An article of manufacture prepared by a process, wherein the process comprises: mixing a material comprising a plurality of monomers and a polymerization catalyst with a polymerization agent, wherein the plurality of monomers comprises monomers about 80% w/w methyl methacrylate, about 10% w/w n-butyl methacrylate and about 10% w/w trimethylolpropane trimethacrylate; the polymerization catalyst comprises about 0.5% w/w benzoin methyl ether; and the agent for polymerization of monomers comprises ultraviolet radiation.

Embodiment 259. An article of manufacture prepared by a process, wherein the process comprises: mixing a material comprising a plurality of monomers and a polymerization catalyst with a polymerization agent, wherein the plurality of monomers comprises monomers about 100% w/w ethyl methacrylate, the polymerization catalyst comprises about 0.5% w/w benzoin methyl ether, and the agent for polymerization of monomers comprises ultraviolet radiation.

Embodiment 260. An article of manufacture prepared by a process, wherein the process comprises: mixing a material comprising a plurality of monomers and a polymerization catalyst with a polymerization agent, wherein the plurality of monomers comprises monomers about 90% w/w methyl methacrylate and about 10% ethylene glycol dimethacrylate, the polymerization catalyst comprises about 0.5% w/w benzoin methyl ether, and the agent for polymerization of monomers comprises ultraviolet radiation.

Embodiment 261. An article of manufacture prepared by a process, wherein the process comprises: mixing a material comprising a plurality of monomers and a polymerization catalyst with a polymerization agent, wherein the plurality of monomers comprises monomers about 50% w/w methyl methacrylate and about 50% ethylene glycol dimethacrylate, the polymerization catalyst comprises about 0.5% w/w benzoin methyl ether, and the agent for polymerization of monomers comprises ultraviolet radiation.

Embodiment 262. An article of manufacture prepared by a process, wherein the process comprises: mixing a material comprising a plurality of monomers and a polymerization catalyst with a polymerization agent, wherein the plurality of monomers comprises monomers about 50% w/w methyl methacrylate and about 50% ethylene glycol dimethacrylate, the polymerization catalyst comprises about 2% w/w benzoin methyl ether, and the agent for polymerization of monomers comprises ultraviolet radiation.

Embodiment 263. An article of manufacture prepared by a process, wherein the process comprises: mixing a material comprising a plurality of monomers and a polymerization catalyst with a polymerization agent, wherein the plurality of monomers comprises monomers about 80% w/w methyl methacrylate and about 20% ethylene glycol dimethacrylate, the polymerization catalyst comprises about 0.5% w/w benzoin methyl ether, and the agent for polymerization of monomers comprises ultraviolet radiation.

Embodiment 264. An article of manufacture prepared by a process, wherein the process comprises: mixing a material comprising a plurality of monomers and a polymerization catalyst with a polymerization agent, wherein the plurality of monomers comprises monomers about 80% w/w methyl methacrylate and about 20% ethylene glycol dimethacrylate, the polymerization catalyst comprises about 2% w/w benzoin methyl ether, and the agent for polymerization of monomers comprises ultraviolet radiation.

Embodiment 265. An article of manufacture prepared by a process, wherein the process comprises: mixing a material comprising a plurality of monomers and a polymerization catalyst with a polymerization agent, wherein the plurality of monomers comprises monomers about 25% w/w methyl methacrylate, about 25% w/w ethyl methacrylate, and about 50% w/w ethylene glycol dimethacrylate; the polymerization catalyst comprises about 0.5% w/w benzoin methyl ether; and the agent for polymerization of monomers comprises ultraviolet radiation.

Embodiment 266. An article of manufacture prepared by a process, wherein the process comprises: mixing a material comprising a plurality of monomers and a polymerization catalyst with a polymerization agent, wherein the plurality of monomers comprises monomers about 40% w/w methyl methacrylate, about 40% w/w n-butyl methacrylate, and about 20% w/w ethylene glycol dimethacrylate; the polymerization catalyst comprises about 0.5% w/w benzoin methyl ether; and the agent for polymerization of monomers comprises ultraviolet radiation.

Embodiment 267. An article of manufacture prepared by a process, wherein the process comprises: mixing a material comprising a plurality of monomers and a polymerization catalyst with a polymerization agent, wherein the plurality of monomers comprises monomers about 40% w/w methyl methacrylate, about 40% w/w ethyl methacrylate, and about 20% w/w trimethylolpropane trimethacrylate; the polymerization catalyst comprises about 0.5% w/w benzoin methyl ether; and the agent for polymerization of monomers comprises ultraviolet radiation.

1.-219. (canceled)

220. A method comprising:
i) combining a biological material with a monomer-containing material, thereby obtaining a combination;
ii) treating the combination with an agent that polymerizes monomers of the monomer-containing material to provide a polymeric material, thereby obtaining a polymerized combination; and
iii) removing the polymeric material from a surface of the biological material, thereby obtaining a biological sample embedded in the polymeric material, wherein the biological sample has an exposed surface, wherein the exposed surface retains a shape and outline of the biological material.

221. The method of claim 220, wherein the treating the combination with the agent that polymerizes monomers of the monomer-containing material depletes the monomers.

222. The method of claim 220, further comprising chemically fixing the biological material with a fixative prior to the combining the biological material with the monomer-containing material, or fixing the biological material by cryofixation to provide a cryofixed material prior to the combining the biological material with the monomer-containing material.

223. The method of claim 220, further comprising dehydrating the biological material prior to the combining the biological material with the monomer-containing material.

224. The method of claim 220, wherein the biological material comprises a deparaffinized histological sample.

225. The method of claim 220, wherein the monomer-containing material comprises thermosetting or thermoplastic monomers.

226. The method of claim 225, wherein the monomer-containing material comprises methacrylate monomers.

227. The method of claim 226, wherein the monomer-containing material comprises a monomer with at least one methacrylate moiety.

228. The method of claim 226, wherein the monomer-containing material comprises ethylene glycol dimethacrylate.

229. The method of claim 226, wherein the monomer-containing material comprises methyl methacrylate, ethyl methacrylate, and ethylene glycol dimethacrylate.

230. The method of claim 229, wherein the monomer-containing material comprises about 40% w/w methyl methacrylate, about 40% w/w ethyl methacrylate, and about 20% w/w ethylene glycol dimethacrylate.

231. The method of claim 220, wherein the monomer-containing material further comprises a polymerization catalyst.

232. The method of claim 231, wherein the polymerization catalyst comprises benzoin methyl ether.

233. The method of claim 232, wherein the polymerization catalyst comprises about 0.5% w/w benzoin methyl ether.

234. The method of claim 220, wherein the agent that polymerizes monomers of the monomer-containing material comprises UV radiation.

235. The method of claim 220, wherein the removing of the polymeric material comprises contacting the polymerized combination with a contacting agent with agitation.

236. The method of claim 235, wherein the contacting agent comprises a homogenous suspension of an abrasive agent.

237. The method of claim 220, further comprising imaging of the biological sample embedded in the polymeric material.

238. The method of claim 237, wherein the imaging is by atomic force microscopy.

239. The method of claim 220, further comprising contacting the biological material with histological dye prior to the combining with a monomer-containing material.
